(19) United States
(12) Patent Application Publication
(10) Pub. No.: US 2025/0184689 A1
(43) Pub. Date: Jun. 5, 2025

(54) CONFIGURATION AND MANAGMENT OF RANGING CONSTELLATIONS IN WIRELESS NETWORKS

(71) Applicant: KONINKLIJKE PHILIPS N.V., EINDHOVEN (NL)

(72) Inventors: Vignesh Raja Karuppiah Ramachandran, Mol (BE); Oscar Garcia Morchon, Eindhoven (NL)

(21) Appl. No.: 18/840,169

(22) PCT Filed: Feb. 22, 2023
(86) PCT No.: PCT/EP2023/054343

§ 371 Date: Aug. 21, 2024

(30) Foreign Application Priority Data
Feb. 23, 2022 (EP) 22158154.9
Aug. 7, 2022 (EP) 22189159.1
Aug. 10, 2022 (EP) 22189617.8
Aug. 22, 2022 (EP) 22191356.9
Sep. 30, 2022 (EP) 22199293.6

(51) Int. Cl. H04W 4/02; G01S 13/76; H04W 64/00

(52) U.S. Cl. CPC H04W 4/023; G01S 13/765; H04W 64/00

(57) ABSTRACT

The invention relates to a wireless system and methods for managing and/or configuring ranging capable devices to form a ranging constellation to support ranging-based positioning services. Multiple challenges in improving configuration and management of the ranging constellation are described.

### FIELD OF THE INVENTION

The invention relates to ranging and positioning services in wireless networks, such as—but not limited to—cellular networks, such as fifth generation (5G) or higher generation networks.

### BACKGROUND OF THE INVENTION

Ranging is a process by which distance and/or angle between two wireless devices is measured as a function of radio parameters (e.g., signal quality, channel condition, round trip time etc.). In wireless systems, accuracy of ranging measurements may have direct correlation with the link quality of a used radio channel, calibration of a used ranging procedure, or hardware capabilities of a used device in terms of antenna design, energy and compute resources. In addition, power consumption of the ranging procedure may have a direct correlation with frequency of operations, duty cycle, repetitions of messages from a device to a ranging service of another device. Due to this direct correlation with dynamic system parameters, accuracy and power consumption of ranging in wireless devices may become unpredictable and more often negatively impacted. Particularly in situations where ranging measurements are used to derive location coordinates (e.g., geographical coordinates) of a device, the accuracy of ranging service is vital in determining precise location coordinates.

Wireless standards offer standardized techniques to support peer-to-peer ranging, wherein requirements are set forth by multiple use cases, as described e.g. in 3GPP specification TR 22.855 “Study on Ranging-based Services”. There are however still open challenges in improving location services using specific ranging constellations. These include e.g. location accuracy in deep-indoor environments in the light of poor signal quality and cellular coverage, ranging accuracy in outdoor environments in the light of channel variability and reflective properties, calibration errors in the light of range bias and ranging errors, power consumption of ranging services in the light of multiple packet transmission/reception for a single distance/coordinate measurement, and power consumption of location services in the light of the technique used by network for location services.

As discussed in 3GPP document RWS-210491 (“Views on study of sidelink based positioning in Rel. 18”), use of sidelink radio resources to perform ranging and leveraging these measurements to improve accuracy positioning are discussed and desired.

However, when combining ranging and location services, configuration and management of involved devices that use sidelink radio resources needs to be considered with respect to the process of determining which devices to be used and configuring their behavior based on available information, the way of maintaining and managing integrity of the involved devices, when members of the involved devices are constantly changing, or the way of managing the involved devices when they are largely distributed across geographical areas.

### SUMMARY OF THE INVENTION

It is an object of the present invention to provide improved configuration and management of resources for ranging services.

This object is achieved by an apparatus as claimed in claim 1 and 8, by a network device as claimed in claim 13, by a system as claimed in claim 14, by method as claimed in claim 17 and 18, and by a computer program product as claimed in claim 19.

According to a first aspect, an apparatus is provided (e.g., at a mobile user device (e.g., UE) or an access device (e.g., gNB) or a managing entity or a core network device/function) for providing a location estimate of a target mobile device in a wireless network, wherein the apparatus is adapted to:
configure one or more ranging capable devices to form one or more anchor devices of a ranging constellation that acts as a proxy for a positioning service provided in a geographical area; and
use ranging measurements obtained from the ranging constellation with respect to the target mobile device to support the positioning service.

According to a second aspect, an apparatus is provided (e.g., at a mobile communication device) for providing a location estimate of a target mobile device in a wireless network, wherein the apparatus is adapted to determine whether or not a ranging constellation is established by monitoring an integrity of the ranging constellation to provide a desired operational area of the ranging constellation.

According to a third aspect, a network device comprising the apparatus of the first aspect or the apparatus of the second aspect is provided.

According to a fourth aspect, a system comprising at least one first network device comprising the apparatus of the first aspect and a plurality of second network devices comprising the apparatus of the second aspect is provided.

According to a fifth aspect, a method of obtaining a location estimate of a target mobile device in a wireless network is provided, wherein the method comprises:
configuring one or more ranging capable devices to form one or more anchor devices of a ranging constellation that acts as a proxy for a positioning service provided in a geographical area; and
using ranging measurements obtained from the ranging constellation with respect to the target mobile device to support the positioning service.

According to a sixth aspect, a method of obtaining a location estimate of a target mobile device in a wireless network is provided, wherein the method comprises determining whether or not a ranging constellation of anchor devices is established by monitoring an integrity of the ranging constellation to provide a desired operational area of the ranging constellation.

Finally, according to a seventh aspect, a computer program product is provided, which comprises code means for producing the steps of the above methods according to the fifth or sixth aspects when run on a computer device.

Accordingly, sidelink resources are grouped as a ranging constellation that is managed with respect to a process of determining an anchor node in the ranging constellation and configure it based on the available information to behave as an head anchor node, anchor node or other type of member in a ranging constellation, the way of maintaining and managing the integrity of the ranging constellation, when the members of the ranging constellation are constantly changing, or the way of managing the ranging constellation when it is largely distributed across geographical areas.

Devices constituting the ranging constellation may be selected based on a set of one or more criteria for the device, which may include its support for satellite-based positioning systems (e.g., GPS, GNSS etc.), whether or not its position is known, its particular ranging capabilities, its existing membership of other ranging constellation(s), distance to a particular reference point (e.g. a nearby access device), its velocity and/or determination of whether the device is stationary or mobile. The formation of a ranging constellation and selection of its members may be done by a managing entity.

The managing entity (e.g., user device or a wireless access device or base station or a network function in the core network) configures one or more network devices (e.g., UEs) as anchor devices to form a ranging constellation to support ranging services, location services and/or ranging-based positioning services (i.e., a combination of ranging and location service functionality). Whether or not the ranging constellation is sufficiently established to be able to support the above-mentioned services is determined by monitoring an integrity of the ranging constellation to provide a desired operational area of the ranging constellation at a sufficient accuracy. Thereby, configuration and management of the ranging constellation and/or its provided location accuracy can be improved with simple ranging measurements between the (anchor) devices, coordinated either locally or centrally. In addition to improving localization and ranging accuracy, the ranging constellation also helps to reduce power consumption of the involved (mobile) network devices by combining ranging and location services and by reducing the need for transmission of energy-consuming long-range positioning signals (e.g., to access devices). In particular, the moment at which the location information can be derived from ranging measurements and the methods used for ranging-based location estimation can be determined.

The ranging services, location services and/or ranging-based positioning services could be offered by a different network other than the wireless network which collects the ranging measurements. It could also be a third-party application which calculates the position based on these measurements. Furthermore, the geographical area of the positioning service may depend on the capability of the anchor device(s) and/or the characteristics of the environment in which the anchor device(s) is/are configured. It does not have to be known by the network in advance and could optionally by configurable.

According to a first option which may be combined with any of the above first to seventh aspects, a provisional ranging constellation of anchor devices may be created and maintained either directly or via a core network of the wireless network, and the provisional ranging constellation may be forwarded to a managing entity in order to support formation of the ranging constellation. Thereby, a suggestion for members of the ranging constellation can be prepared in advance and forwarded to the managing entity to reduce processing load and free resources at the managing entity.

According to a second option which may be combined with the first option or any of the above first to seventh aspects, an identified anchor device may be communicatively coupled to initiate a configuration of the identified anchor device to participate in the ranging constellation. Thereby, potential members of the ranging constellation can be identified in advance and individually configured via a direct communication link.

According to a third option which can be combined with the first or second option or any of the above first to seventh aspects, formation of the ranging constellation may be initiated by subscribing to a ranging or positioning service in the geographical area and requesting assistance in the formation of the ranging constellation or using position information obtained from the ranging or positioning service to form the ranging constellation. Thereby, additional information provided by the ranging or positioning service can be accessed for more effective formation of the ranging constellation.

According to a fourth option which can be combined with any of the first to third options or any of the above first to seventh aspects, an anchor device may be configured as a head anchor device to act as a calibration node that can communicatively couple with other network devices to perform a calibration procedure of the ranging constellation for a newly joining anchor device and/or a recalibration procedure of the ranging constellation when an anchor device leaves the ranging constellation, and/or to handle the constellation configuration in coordination with a managing entity, and/or to exchange ranging measurements with a core network of the wireless network In an example, an anchor device that is immobile and/or has a highest number of devices with a respective ranging measurement result (e.g., range, distance, signal quality etc.) within a threshold range and/or has the highest amount of remaining battery life may be selected as head anchor device. Thus, a central contact or managing node of the ranging constellation can be provided to improve effectiveness of management and (re-)formation of the ranging constellation.

According to a fifth option which can be combined with any of the first to fourth options or any of the above first to seventh aspects, the one or more ranging capable devices may be configured by assigning security keying materials and discovery information or information related to the used positioning signals. Thereby, enhanced security can be provided for the proposed configuration process.

According to a sixth option which can be combined with any of the first to fifth options or any of the above first to seventh aspects, centralized management of the ranging constellation may be performed by analyzing identities of ranging capable devices to retrieve location coordinates or initiating ranging measurements among anchor devices of the ranging constellation to identify a proximity among known devices of the ranging constellation, and by updating location information of the ranging constellation if there is a change in proximity and/or the ranging distance between the anchor devices of the ranging constellation. Thereby, (re-)formation and maintenance of the ranging constellation can be controlled in a centralized manner.

According to a seventh option which can be combined with any of the first to sixth options or any of the above first to seventh aspects, it may be determine whether or not a ranging constellation is established by monitoring an integrity of the ranging constellation to provide a desired range of the operational area of the ranging constellation. Thus, operability of the ranging constellation in the desired range can be maintained.

According to an eighth option which can be combined with any of the first to seventh options or any of the above first to seventh aspects, a list of the ranging capable devices in a target area to be configured as the ranging constellation may be identified and a request to form the ranging constellation is created, wherein the identification of the ranging capable devices may be based on an installation list provided by the wireless network or a role and identity of a network device predefined prior to deployment of the network device. Thus, (initial) formation of the ranging constellation can be achieved on the basis of installation information available from the wireless network.

According to a ninth option which can be combined with any of the first to eighth options or any of the above first to seventh aspects, mutual ranging measurements between anchor devices of the ranging constellation may be initiated in a target operational area at a configurable time interval. Thereby, measurement results are continuously available to allow continuous re-evaluation and adaptation of the ranging constellation and/or its members.

According to a tenth option which can be combined with any of the first to ninth options or any of the above first to seventh aspects, it may be determined if the ranging measurements are integral to the target operational area of the ranging constellation based on the ranging measurements between the anchor devices and/or changes in own location estimates of anchor devices obtained either from a ranging service or from a location service. Thus, operability of the ranging constellation in the desired target area can be evaluated.

According to an eleventh option which can be combined with any of the first to tenth options or any of the above first to seventh aspects, it may be determined that the ranging constellation is established and this information may be communicated to a ranging service at a base station device and/or a core network of the wireless network, if the ranging measurements within the target area are completed within the configured time interval, while within the configured time interval the integrity of the ranging measurements did not change beyond a configured threshold of the ranging constellation. Thereby, integrity of the ranging constellation can be continuously assessed to ensure proper operation.

According to a twelfth option which can be combined with any of the first to eleventh options or any of the above first to seventh aspects, how often the integrity of the ranging constellation is checked may be decided based on mobility and/or available resources of the anchor devices (i.e., second devices of the system of the fourth aspect) in the ranging constellation and/or configured by a user via a network exposure function. Thus, interference and/or power consumption caused by the checking/(re-)formation process can be controlled.

According to a thirteenth option which can be combined with any of the first to twelfth options or any of the above first to seventh aspects, the ranging constellation may be controlled to cease to exist if the total number of second devices in the ranging constellation falls below a minimum number (or if formation criteria of the ranging constellation are not met anymore (e.g., mutual anchor positions change, or mutual ranges changed, etc.). Thereby, reliability of operation of the ranging constellation can be ensured. Here, “cease to exist” may include stop advertising itself. If the ranging constellation stops advertising, it could later on start again and may thus keep existing.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1 and 8, the network device of claim 13, the system of claim 14, the methods of claim 17 and 18, and the computer program product of claim 19 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 schematically shows different concepts of providing ranging services to mobile devices with or without network coverage;

FIG. 2 schematically shows an illustration of different directions in a spherical coordinate system;

FIG. 3 schematically shows a timing diagram for data transmission between a transmitter and a receiver to explain a round-trip-time concept;

FIG. 4 schematically shows an illustration of an angle-of-arrival concept based on a phase difference consideration;

FIG. 5 schematically shows a block diagram of a wireless system for providing ranging and/or positioning services according to various embodiments;

FIG. 6 schematically shows a network architecture where a mobile terminal approaches a constellation of mobile terminals to get assisted by ranging services for location coordinates according to various embodiments;

FIG. 7 schematically shows a signaling and processing diagram for ranging-based positioning services according to various embodiments;

FIG. 8 schematically shows a signaling and processing diagram for a configuration process triggered by a managing entity according to an embodiment;

FIG. 9 schematically shows a signaling and processing diagram for a configuration process triggered by a user device according to an embodiment;

FIG. 10 schematically shows a flow diagram of a configuration monitoring process according to an embodiment; and

FIG. 11 schematically shows a signaling and processing diagram for a centralized configuration management process according to alternative embodiments.

FIG. 12 schematically shows an example conceptual architecture of anchor UEs supporting a subset of LMF functionality as a proxy.

FIG. 13 schematically shows a signaling and processing diagram for a configuration process of a managing entity (ME) according to an embodiment.

### DETAILED DESCRIPTION OF EMBODIMENTS

Embodiments of the present invention are now described based on ranging and/or positioning (sometimes also called “localization”) services for cellular networks, where e.g. 4G network elements may be incorporated in proposed 5G solutions. Furthermore, at least some of the below embodiments are described based on a 5G New Radio (5G NR) radio access technology.

Throughout the present disclosure, the term “wireless network” is intended to mean a whole network system (e.g., 4G or 5G system) including communication devices (e.g., UEs) radio access network (RAN) and core network (CN). Furthermore, the abbreviations “eNB” (4G terminology) and “gNB” (5G terminology) are intended to mean access device such as a cellular base station or a WiFi access point. The eNB/gNB is part of the RAN, which provides an interface to functions in the CN. The RAN is part of a wireless communication network. It implements a radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks. In the 3GPP specifications 23.303, 23.304, 24.334 and 24.554 for 4G and 5G networks, respectively, so-called proximity service (ProSe) functions are defined to enable—amongst others—connectivity for cellular communication devices (e.g., UEs) that are temporarily not in coverage of an access device (eNB). One particular function is called ProSe UE-to-network relay, or Relay UE. The Relay UE is a communication device that helps another out-of-coverage (OoC) UE to communicate to the eNB (i.e., access device) by relaying application and network data traffic in two directions between the OoC UE and the eNB. The local communication between the Relay UE and the OoC-UE is called D2D communication or Sidelink communication or PC5 communication. The abbreviation “PC5” designates an interface for sidelink communication as defined by ProSe. Furthermore, the abbreviation “UL” is used for the uplink direction from the communication device (e.g., UE) to the access device (e.g. eNB, gNB), the abbreviation “DL” for the downlink direction from the access device (e.g. eNB, gNB) to the communication device (e.g. UE), and the abbreviation “SL” for sidelink communication between two or more communication devices (e.g. UEs).

Once a relaying relation is established, the OoC-UE is connected via the Relay UE and acts in a role of “Remote UE”. This situation means the Remote UE has an indirect network connection to the CN as opposed to a direct network connection that is the normal case (cf. 3GPP specification TS 22.261 v16.10.0).

Furthermore, 3GPP specifications TR 23.733 v15.1.0 and TR 36.746 v15.1.1 provide studies on architectural enhancements e.g. to enable an IoT device (in a role of Remote UE) to operate on very low power by using a Relay UE to connect to the wider network. Because the Relay UE is physically very close, it can be reached using very low power transmissions. This work also includes security, speed and stability improvements to ProSe. These extensions of ProSe are called enhanced ProSe (“eProSe”).

ProSe can also be used for direct communication between two UEs. Additional radio level details on ProSe, V2X and sidelink communication can be found in 3GPP specifications TR 37.985, TS 38.300 and TR 38.836.

Ranging can be defined as a process which measures a distance and/or relative directional angle between two wireless devices in a 3-dimensional space. In the initially mentioned specification TR 22.855 “Study on Ranging-based Services”, ranging-based services are defined as applications utilizing the distance between two UEs and/or the direction of one UE from the other. These ranging-based services are envisioned to be supported with or without network coverage. Next to the measurement of the distance and directional angle, a relevant measurement is whether two wireless devices are in direct Line-of-Sight or not since this is relevant for many use cases in which UEs are supposed to interact with each other if they are in Line-of-Sight, e.g., in the same room.

The term “ranging reference signals” is used herein to denote signals used for determining the distance and/or angle between two devices that may be connected through a device-to-device connection (e.g., using sidelink and/or PC5) rather than an infrastructure connection (e.g. using Uu interface). The ranging reference signals may be position reference signals and/or sounding reference signals or other signals (e.g., signals used for round-trip time (RTT) measurements) that may be used for determining distance and/or angle between the devices, possibly using resources (that may be configured or granted by an access device) for device-to-device (e.g. sidelink) communication/discovery and/or resources specifically reserved for sending the reference signals or the other signals that may be used for determining distance and/or angle between the devices.

The terms “ranging capable device” and “ranging capable UE” are used herein to denote devices which have a minimum set of components, subsystems and/or functions to perform or support distance measurement and/or angle measurement between itself and another device (e.g. using Time Difference of Arrival, Round-Trip Time, Carrier-phase or other measurements/techniques). This set of components, subsystems and/or functions does not always need to be enabled and may be enabled/triggered on demand (e.g. by request from another device or network function). Also, the components, subsystems and/or functions may not always be authorized to be used for performing distance measurements. The terms “ranging capable device” and “ranging capable UE” can therefore also be interpreted as being able to perform distance measurement and/or angle measurement between itself and another device, and being authorized/enabled to do so. Also in sentences in which the word “capable” is used, it can also be interpreted/restricted as being enabled and/or authorized.

The ranging capabilities may differ per device. For example, not every device may be capable of calculating the angle, since it requires multiple antennas. The ranging capabilities of the device (which can be exchanged as part of the discovery process) can be used to determine what a device is capable of and which measurements can be made. Note that angle calculation may need to be an explicit capability rather than based solely on a capability declaring the number of antennas. The number of antennas alone being bigger than one does not automatically imply that the device is capable of calculating an angle. The calculation of the angle may further require a sensor (e.g. magnetometer, gyroscope, accelerometer) to derive an orientation and/or angle towards a reference point, such as the magnetic north, and an angle/orientation calibration mechanism. The angle may also indicate a difference in height, and may use a reference height (e.g. meters above sea level and/or barometric pressure, floor information, terrain height data for the device position), and a height calibration mechanism.

### Distance/Angle/Position Calculation Techniques

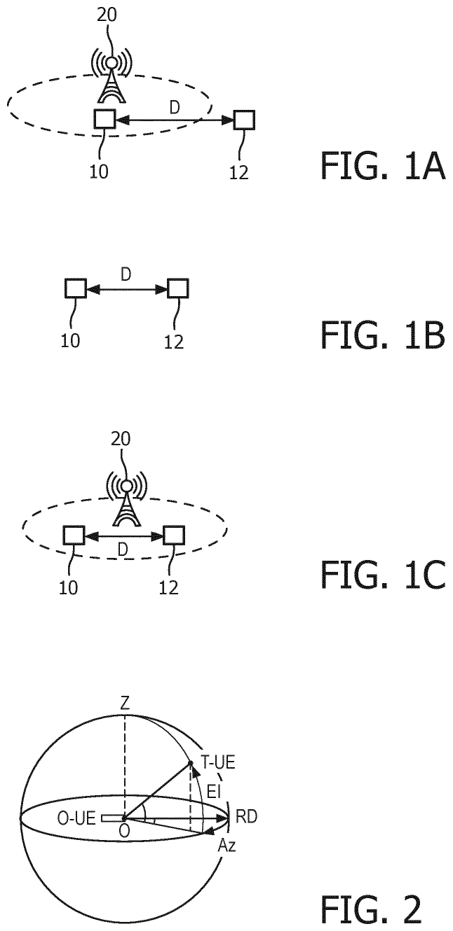

FIGS. 1A-C schematically shows different concepts of providing ranging services based on distance and/or direction (D) between two mobile devices 10, 12 with or without network coverage. The dotted elliptical line shows a perspective view of a circular coverage area around an access device (e.g., gNB) for accessing a 5G cellular network.

In FIG. 1A, a first UE 10 is located within the coverage area of the access device 20, while the second UE 12 is located outside of the coverage area and thus has no network coverage.

In FIG. 1B, both first and second UEs 10, 12 have no network coverage.

In FIG. 1C, both first and second UEs 10, 12 are located within the coverage area of the access device 20 and thus have network coverage.

FIG. 2 schematically shows an illustration of different directions in a spherical coordinate system.

The distance and angle between a set of UEs (e.g., an observer UE (O-UE) and a target UE (T-UE)) can be visualized in a 3-dimensional (3D) sphere in a 2-dimensional (2D) plane as shown in FIG. 2. The horizontal direction (i.e., the azimuth (Az)) of the target UE is the angle formed between a reference direction (RD) and a line from the observer UE to the target UE projected on the same plane as a target reference direction orthogonal to the direction of the zenith (Z). The elevation angle (i.e., the elevation (El)) of the target UE is an angle above the horizontal plane, i.e., formed between the horizontal target reference direction and the direction from the origin of the observer UE to the target UE.

A ranging measurement between two UEs as described e.g. in a ranging study by Mario H. Castañeda Garcia et al.: “A Tutorial on 5G NR V2X Communications” (DOI 10.1109/COMST.2021.3057017) may result in two parameters, which are the distance between the two UEs in meters and an angle in degrees at which the target UE is elevated in a 3D plane from the observer UE.

There are multiple use cases which require a distance accuracy within 10 cm (i.e. sub-nanosecond range of time measurement accuracy) in an effective ranging distance of 20 m and a tolerance of up to ±2° in horizontal and vertical planes in a coverage range of −45° to +45° angle of arrival (AoA) with respect to a reference direction of the ranging device. In some use cases a local coordinate system is proposed for ranging UEs, in which the distance and angles measured from the ranging services are translated to location coordinates. The UEs involved in ranging are expected to move at various speeds (e.g., from 1 m/s to 10 m/s) and multiple concurrent ranging operations between multiple UEs can be done in a given area and a UE can carry out multiple concurrent ranging operation with other UEs present in the area.

A so-called “peer-to-peer ranging” can be done in many ways including but not limited to:
i. Two-way ranging, which is a process where two devices A and B communicate a data packet and an acknowledgement packet back and forth with themselves. The time delay occurring due to natural radio signal propagation and due to processing delay on the device B (i.e., time taken by the device B to resend a packet to device A) is taken into consideration in this technique. The one-way time of flight is then calculated on device A as the half of the difference between a) the time spent by the device A between transmitting a packet and receiving the next packet from B and b) the time spent by the device B between receiving a packet from A and transmitting the response packet back to A. Device B may include information in its response packet such that A can calculate the time spent of B. Then at device A, the one-way time of flight may be used to calculate the distance between two devices A and B. Device B may perform the same procedure with device A such that B can also calculate this distance. The two devices' clocks need not be synchronized with each other in this technique since the processing delay is accounted for with two consecutive packet transmissions and distance may be calculated simultaneously in both devices.
ii. One way ranging, which is a process, where at least one packet is transmitted between the transmitting wireless device A and a receiving wireless device B. These devices are synchronized with each other by a common clock source. The time of flight is then measured as the difference between the time of reception at the device B and the time of transmission at the device A. Device A may include a timestamp of its time of transmission within the data packet, so that device B can calculate this time difference. The accuracy of ranging depends on the accuracy of clock synchronization achievable between the two devices.

The peer-to-peer ranging operation may depend on multiple parameters of wireless communication such as clock time synchronization between the devices, communication path (e.g., line of sight (LOS) or non-line of sight (NLOS)) over which the signal is transmitted, antenna properties, frequency of operation, transmission power and receiver sensitivity of the wireless radios. These parameters are also important for radio communication in general, resulting in multitude of standardized techniques to achieve highest communication performance for a given radio. For example, in 3GPP the sidelink radio resource protocol as described in specification 36.331 v16.4.1 ensures clock time synchronization with high accuracy between two sidelink UEs operating in multiple in-coverage and out-of-coverage scenarios.

Positioning can be defined as a process of determining, according to a location coordinate system, location coordinates of wireless devices such as but not limited to mobile phone, wearables, and IoT devices. Upon determining of the location coordinates of a device, it can be located on a map using a mapping function. Positioning is typically distinguished between absolute positioning (i.e., determine geographical coordinates (location coordinates) according to a standardized geographic coordinate system), or relative positioning (i.e., determine coordinates (e.g., using a local coordinate system) and/or angle plus distance relative to a reference point). Some examples of how absolute positions or relative positions can be expressed can be found in 3GPP specification TS 23.032. A classic example is a satellite-based location service (e.g., Global Positioning System (GPS) or Global Navigation Satellite System (GNSS)), where a device's location coordinates are calculated using at least three of the many satellites belonging to a constellation of medium earth orbit (MEO) satellites using well known processes such as triangulation and trilateration, where the satellites act as the clock synchronization source and communication delay of the transmitted packets are used to estimate the location coordinates. These coordinates can be used by any third-party mapping tool (e.g., OpenStreetMap) to pinpoint the location of a device in a geographical map of the area. Also, several indoor positioning techniques based on radio frequency technologies such as Bluetooth, UltraWideBand (UWB), or Wi-Fi are available, which can locate/determine the coordinates of a radio frequency (RF) emitting tag in an indoor environment. The position of these tags may then be mapped onto an indoor floor plan using the indoor coordinates estimated based on the RF propagation properties such as time delay, multipath reflections, received signal strength, etc., measured using RF communication between the tags and anchor nodes that are placed in pre-known locations of the building.

Positioning techniques used for obtaining a coordinate of a device's current location can be accomplished in several ways, but typically includes triangulation and/or trilateration based on a set of measured distances and/or angles between the device and a set of other devices or reference points. Distances and angles can be determined using various techniques which may include round trip time (RTT), time of flight (ToF), time difference of arrival (TDoA), angle of arrival/departure (AoA/AoD) and/or a combination thereof:

The round trip time (RTT) defines a duration from when a data packet transmitted by a transmitter (Tx, e.g., an access point/device) to when the same data packet is received and acknowledged by a receiver (Rx, e.g., a mobile phone/device) i.e. up to the moment the transmitter receives the acknowledgement. Since the data packet travels at the speed of light in air medium (approximately 3.3 ns/m), the time duration the data packet travels in air is proportional to the actual distance between the Tx and the Rx. In scenarios, where the internal clocks in the Tx and the Rx are not synchronized, a one-way time measurement cannot be based on differences between time stamps of transmission and reception, since it will also include the timing errors caused by, among others, internal clock drifts and indeterministic clock offsets between Tx and Rx. Since the internal clocks of Tx and Rx are not synchronized, the difference in time stamps when the signal travels in the reverse direction (i.e., Rx to Tx) is affected in the opposite way by the clock offset as in the forward direction (i.e., Tx to Rx).

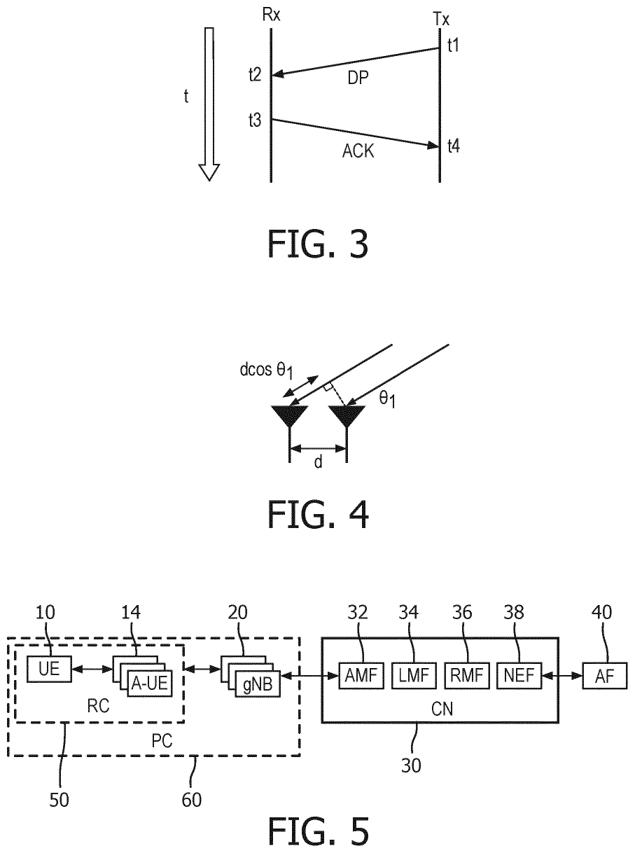

FIG. 3 schematically shows a timing diagram for data transmission between a transmitter and a receiver to explain the round-trip-time concept.

In the timing diagram of FIG. 3, the time passes from the upper side to the lower side while information flow between a transmitter (Tx) and a receiver (Rx) is indicated by respective arrows.

According to FIG. 3, a data packet (DP) is transmitted at time t1 from the Tx to the Rx and received at the Rx at time t2. An acknowledgement (ACK) is transmitted at time t3 from the Rx to the Tx and received at the Tx at time t4.

The round trip time (RTT) can be obtained without having to know any clock offsets by simple addition and subtraction of the four time stamps t1 to t4, as follows:

$$RTT = ( t 4 - t 1 + t 2 - t 3 )$$

where t1 is the time of transmission, t2 is the time of reception, t3 is the time of acknowledgement transmission and t4 is the time of acknowledgement reception.

The distance D between the Tx and the Rx can be estimated by using the following equation:

$$2 * D = ( ( t 4 - t 1 ) - ( t 3 - t 2 ) ) * c$$

where, c is the speed of light. Also note that in RTT measurements-based distance estimation there is no need of synchronization between the transmitter and receiver. The calculation of a single distance can be extended to two- and three-dimensional spaces for estimation of multiple distances, which can then be translated to estimates of location coordinates (both local and global) when the coordinates of each transmitter are known in advance. Some standardized mechanisms using an RTT based technique include Fine Timing Measurement (FTM) as defined in IEEE 802.11-2016, and Enhanced Cell-ID (E-CID) as defined in 3GPP TS 36.133.

The time of flight (ToF) corresponds to a duration from when a data packet transmitted by a transmitter (Tx, e.g., access point/device) to when the same data packet is received by a receiver (Rx, e.g., a mobile phone/device). Note that this method takes only the forward path (i.e., Tx to Rx) into account and does not account for the reverse path (i.e., Rx to Tx). In this case, internal clocks of the Tx and the Rx (or multiple Tx and Rx) need to be time-synchronized such that the time stamp of the received packet can be assumed to be correct and compensated for any timing error caused by among others internal clock drifts and indeterministic clock offsets between Tx and Rx. Assuming the Tx and the Rx of FIG. 3 are synchronized, the distance D between the Tx and the Rx can be calculated by the following equation:

$$D = ( t 2 - t 1 ) * c$$

where, t2 is the time stamp of the reception and t1 is the time stamp of the transmission, and c is the speed of light. The time of flight can be calculated by Rx knowing the time stamp t1 (which was e.g. included in the transmitted message or communicated later) and by its own measured time stamp t2. The time of flight can also be calculated by Tx knowing the time stamp t2 (which was e.g. communicated later by Rx to Tx) and its own measured time stamp t1. The calculation of a single distance can be extended to two- and three-dimensional spaces for estimation of multiple distances, which can then be translated to estimates of location coordinates (both local and global) when the coordinates of multiple reference devices (either acting as the transmitter or the receiver) are known in advance.

The time difference of arrival corresponds to a difference in time stamps at which a data packet is received by a number of clock-synchronized receivers (Rx, e.g., access points/devices which are synchronous location reference stations), whereby the data packet was transmitted by an asynchronous transmitter (Tx, e.g., a mobile phone/device, or asynchronous location tag for which the location coordinates are to be determined). Note that the roles can be the other way around, e.g., the mobile phone/device may be an asynchronous Rx and the access points/devices may be synchronized transmitters. Note that a single transmission of a data packet by the transmitter will be received concurrently by several synchronized receivers placed within a coverage area of the transmitter. It is important that the receivers are clock-synchronized and that the location coordinates of the receivers are known to a central location server, whereas the transmitter for which the location coordinates are to be determined may not be synchronized either with other transmitters or with the receivers. A central location server can receive the time of arrival of the data packet from each receiver i=0 . . . N and may compute the distance difference for any pair of receivers (i, j) for a specific transmitter based on the following equation:

$$Δ {d}_{ij} = ( {d}_{i} - {d}_{j} ) = Δ {t}_{ij} * c$$

where, c is the speed of light and Δtᵢⱼ is the difference in arrival times between receiver i and receiver j, di is the unknown Tx-to-Rx distance for a receiver i, Δdᵢⱼ is the difference in Tx-to-Rx distances between a receiver i and a receiver j. The calculation can be applied to two- and three-dimensional spaces for estimation of distance differences, which can be translated to location coordinates (both local and global) when the coordinates of the receivers are known in advance. Note that the transmitters are not able to calculate its own location locally on the device and only the location server can calculate the location of a transmitter using a localization infrastructure and a network of synchronized receiver nodes. Note that the location server may be located on one of the clock-synchronized receivers. The location of the transmitter can be communicated (e.g. to an application, to the transmitter, or to one or more receivers) via a separate communication channel or can be amended in one of the responses from the receivers to the transmitter in the same channel used for transmitting the data packet.

Alternatively or additionally, the receiver may send its measurements (e.g., time of arrival information) rather than a calculated distance and/or angle to the transmitter or a location server that will calculate the resulting distance and/or determine the resulting location coordinates. Some standardized mechanisms using a ToF difference based technique include Observed Time Difference of Arrival (OTDOA) as defined in 3GPP TS 25.305 and TS 36.133, and Uplink Time Difference of Arrival (UTDOA) as defined in 3GPP TS 25.305, typically based on a position reference signal (PRS) or sounding reference signal (SRS).

In addition to the time-based distance estimation, the angle of arrival is derived from phase information of an RF signal received at a receiver using an antenna array, which can be used to estimate the elevation angle or the azimuth angle at which the signal was received. This angle information can be used to determine the direction from which a signal was transmitted.

FIG. 4 schematically shows an illustration of an angle-of-arrival concept based on a phase difference consideration.

In the example of FIG. 4, the angle of arrival of the incoming RF signal (shown by two oblique arrows) can be calculated as follows. In principle, a receiver with at least two antennas with different phase of reception φ1, φ2, separated by a distance d, can determine the phase difference Δφ of the received signal at the receiver and then use it to estimate the angle of arrival based on the following equation:

$$Δφ = [ φ 1 - φ 2 ] = 2 π [ ( d cos {θ}_{1} ) / λ ] + 2 k π$$

where, θ₁ is the angle of arrival to be estimated, k is the wave number which can be calculated by k=2πλ, where λ is the wavelength of the RF signal calculated by λ=c/f, where c is the speed of light and f is the radio frequency of the signal.

The angle of arrival of the RF signal at the receiver can be estimated using a naïve approach based on the measured phase difference using the following equation:

$$cos {θ}_{1} = [ ( Δφ / 2 π ) - k ] * [ λ / d ]$$

Note that in addition to the approach described above, there are several well-known approaches available to calculate the angle of arrival of an RF signal including but not limited to Bartlett beamforming (cf. M. S. Bartlett: “Smoothing Periodograms from Time-Series with Continuous Spectra”), Multiple Signal Classification (MUSIC) (cf. https://en.wikipedia.org/wiki/MUSIC (algorithm)), distortion estimation (cf. J.Capon: “High-resolution frequency-wavenumber spectrum analysis”, Proceedings of IEEE, Vol. 57, issue 8), and signal and noise subspace estimation. Other complex estimation of AoA may use more than two antennas at the receiver, which enables only one receiver instead of three synchronous receivers to obtain both angle and distance measurements based on a RF signal transmitted by an asynchronous transmitter with a rather simple hardware and single antenna. Similarly, the angle of departure (of the signal at the transmitter) can be determined and used for ranging/position estimation in case the transmitter uses multiple antennas.

The process of obtaining location coordinates of a device and using a mapping function to locate the device on a map is also offered by location services (LCS) provided in 3GPP systems, where a base station may act as a synchronization source and location coordinates of the devices are obtained based on radio parameters and special messages using a variety of positioning methodologies as described e.g. in 3GPP specification TS 23.271 “Functional stage 2 description of Location Services (LCS)”, Rel-16, for 4G, and 3GPP specification TS 23.273 “5G System (5GS) Location Services (LCS); Stage 2”, Rel-17, for 5G.

A typical difference between the location service and ranging service offered by the 3GPP system is that the location service may measure geographical coordinates of a device within the coverage area of a cell (e.g., 1-5 km) and provides good accuracy in outdoor environments where line of sight (LOS) is possible with the base station and the communication path can be fairly modelled and accounted for using channel models of urban and rural environments, whereas the ranging service may measure a distance and/or angle between two devices within a short range (e.g., 20 m) and provides good accuracy in outdoor and especially indoor environments where two ranging devices can also be in line of sight (LOS) with each other.

The functionality of the location service and ranging service may be combined to offer e.g. a location service with improved accuracy and better indoor position estimation. A location service or ranging service or combination thereof may also be able to verify the integrity/measure the accuracy/determine errors of the measured distances, angles, location information (e.g. coordinates), etc., and possibly compensate for them, and/or provide distances, angles, location information to UEs, core network functions, application or other location/ranging service, and/or store distances, angles, location information into non-volatile storage, and/or combine distances, angles, location information with distance, angles, location information from other sources or resulting from various location/ranging mechanisms.

Note that a location service may also offer ranging services (and vice-versa), e.g. in case the location of two devices can be observed/determined for example through GNSS, the distance and/or angle between the two devices can be calculated and may be exposed as part of a ranging service that may allow a device to request its distance and/or angle between itself and another device. In such case, the two devices may still be requested to perform ranging measurements between each other to improve the accuracy of the distance and/or angle between the two devices or for determining deviations to the observed/determined location.

A translation of distance to coordinates can be achieved e.g. based on ranging measurements by which a first device A can obtain a distance (d) and the angle (tc) towards a second device B. If the coordinates of the device A are known, and its orientation with respect to the coordinate system is known, the distance and angle measurements between the device A and the device B can be used by the device A to obtain the coordinates of the device B.

For example, in case of geographical coordinates expressed in radians, the latitude (lat1) and longitude (lon1) of the device A are assumed to be known. Then, the geographical coordinates (lat2, lon2) of the device B can be calculated using the following equations when using a spherical-Earth approximation model:

$$lat 2 = a sin ( sin ( lat 1 ) * cos ( d ) + cos ( lat 1 ) * sin ( d ) * cos ( tc ) )$$

$$d lon = a tan 2 ( [ sin ( tc ) * sin ( d ) * cos ( lat 1 ) ] , [ cos ( d ) - sin ( lat 1 ) * sin ( lat 2 ) ] )$$

$$lon 2 = [ mod \{ lon 1 - d lon + π , 2 * π ) ] - π$$

Here the distance d is expressed as a relative distance equal to the distance measured between A and B divided by the average radius of Earth.

As another example, in case of a local 2D Cartesian coordinate system used for an area the X and Y coordinate of the device A (x1 and y1 respectively) may be assumed to be known. Then, the X/Y location coordinates of the device B (x2 and y2 respectively) can be calculated using the following equations:

$$x 2 = d * cos ( alpha ) + x 1$$

$$y 2 = d * sin ( alpha ) + y 1$$

where all coordinates and distance d are expressed in meters and the angle (alpha) towards device B was measured by A.

Alternatively, translation of distance to coordinates of a coordinate system may be done using other concepts, such as reverse Havershine formula, length of degree, Molodensky's method and block shift method, depending on the required accuracy and the type of coordinate systems used by the application.

Current techniques for ranging and position estimation can be improved in the following areas:
i. Location accuracy is highly dependent on signal path loss and degrades with loss of signal quality in indoor and deep indoor environments, where cellular coverage is very poor. Moreover, in remote outdoor environments, where the number of base stations is limited and results in a sparse to no signal coverage, the accuracy of location services becomes poor. In such areas, depending on the positioning methods used, trilateration or triangulation of a mobile device (e.g., UE) may require a longer initial latching time to be able to simultaneously receive at least three different signals from at least three different base stations. If the mobile device is moving in such poor coverage areas, continuity and reliability of location services offered by base stations may become severely disrupted, resulting in a service that becomes non-usable for real time location tracking.
ii. Ranging accuracy in outdoor environments depends largely on channel variability and reflective properties of objects surrounding the devices that carry out ranging operations. In indoor environments, a user of a mobile device (e.g., UE) can fairly control the environment with respect to objects and surrounding environment prior to ranging between two devices, whereas in outdoor environments it is uncertain to have control over the environment and more often it will negatively impact ranging accuracy. In addition, the movements of mobile devices in outdoor environments may also have a large impact on ranging accuracy due to the probable Doppler effect in the RF propagation channel. Ranging measurements between two devices in an outdoor environment may thus become non-usable due to largely deteriorating effects in the RF channel.

In the following, embodiments are described, in which ranging and/or positioning concepts are complemented by using ranging measurements (e.g., distance, angle and altitude) between transmitters and receivers to thereby improve accuracy of positioning and/or reduce power consumption pertaining to these concepts.

Some use cases may require translation of ranging measurements into location coordinates, which enables UEs that are not capable of using a positioning service or an additional positioning module to get a location coordinate derived from ranging information. In addition, devices with very poor positioning accuracy especially in indoor environments may benefit from ranging, such that the positioning accuracy is increased from hundreds of meters to sub-meter accuracy in indoor and/or out of coverage environments. Moreover, accurate positioning and continuous tracking of low power IoT devices is a requirement for yet another use case, which can enable adaptive delivery of quality of service (QoS), e.g., high bandwidth is offered at a location X, whereas only low bandwidth is offered in location Y, to a mobile UE depending on the location. Some of the identified suitable use cases may require formation of a cluster of UEs based on location information to deliver location based QoS to a group of UEs.

It is important to note that throughout this disclosure, at places where a ranging and/or positioning concept is mentioned, any of the above ranging and/or positioning methods or combinations thereof, or other ranging or positioning methods known to the skilled person can be used.

Ranging Constellation (Incl. Its Configuration)

FIG. 5 schematically shows a block diagram of a wireless system for providing ranging and/or positioning services according to various embodiments.

In an embodiment and as illustrated in FIG. 5, a ranging constellation (RC) 50 is provided, which is a group of one or more anchor UEs (A-UE) 14 adapted/prepared to let one or more device UEs 10 join that group. A device UE 10 may join the ranging constellation 50, e.g., for the purpose of initiating a ranging procedure or to participate in ranging of other UEs by acting as an additional anchor UE 14. In order to determine the (absolute or relative) location of a UE, a single distance and/or angle resulting from a ranging procedure may not be sufficient. In an example, the ranging constellation 50 may have at least two or more anchor UEs 14 in order to determine a location of the device UE 10 by determining a distance and/or angle between device UE 10 and the anchor UEs 14 of the ranging constellation, and use the determined distances and/or angles to calculate a location using trilateration and/or triangulation. If additional information is known or can be determined beforehand, such as certain coordinates, whether or not devices involved in ranging are at the same height (e.g. a certain number of meters above sea level, same floor) or in the same reference plane, the ranging between device UE 10 and a single anchor UE 10 in a constellation may be sufficient to determine its relative or absolute location.

The devices constituting the ranging constellation 50 may be selected based on a set of one or more selection criteria for a candidate device, such as its support for GPS/GNSS, whether or not its position is known, its particular ranging capabilities, its existing membership of other ranging constellation(s), its distance to a particular reference point (e.g., a nearby access device), its velocity and/or determination of whether the device is stationary or mobile, or whether or not such candidate device is within sidelink discovery range of another device (e.g., an anchor device). The formation of a ranging constellation and selection of its members is typically done by a managing entity but may also be self-configured based on the selection criteria.

A device UE 10 may be added to or removed from an existing ranging constellation. Similarly, an anchor UE 14 may be added to or removed from an existing ranging constellation. The ranging constellation 50 may be given an identity (e.g., by a managing entity), and this identity may be transmitted to each device joining/constituting the ranging constellation 50. The identity may also be used during discovery of ranging capable devices and/or during connection setup between ranging capable devices and/or exchanging messages to initiate a ranging session. Multiple identities may be assigned to the ranging constellation (e.g., both a unique constellation instance identifier and a constellation type identifier).

Note that adding, removing and joining of a device UE 10 to a ranging constellation does not imply that a device UE 10 needs to have information about all Anchor UEs of a ranging constellation or that a session needs to be established with all Anchor UEs of a ranging constellation. For example, the set of other UEs of a ranging constellation may only be known by the LMF or other managing entity. The UEs of a ranging constellation may form a trusted group/domain, whereby the UEs that are part of a ranging constellation may share same/similar group/domain credentials or authorization token(s), through which (if needed) a UE may be able to prove to other UEs of a ranging constellation that it is part of the same ranging constellation if it can provide a proof of possession of the group/domain credentials or authorization token (e.g. by transmitting a correct response to an authentication/authorization request, or transmitting a correctly signed token/message). The shared group/domain credentials may be used to protect (e.g. encrypt and/or integrity protect) message exchanges between the UEs that are part of the ranging constellation. This may include protection of multicast/groupcast messages. Groupcast/multicast may be used to communicate between the UEs in a ranging constellation, whereby the group identifier could be a ranging constellation identifier. Also broadcast type communication could be used. These types of communication improve the communication efficiency. UEs that don't possess the group/domain credentials cannot decrypt those messages. In this manner, the UEs don't directly need to know which other UEs are part of a constellation or that may join a constellation. Alternatively or additionally, a UE of a ranging constellation may be provided with separate credentials for each other UE in the ranging constellation.

The device UE 10 corresponds to a wireless device that requires ranging and/or positioning services, also known as the Target UE. It is noted that in this embodiment and the following description of embodiments, the term “device UE” and “UE” are used interchangeably and are intended to mean the same device. Also, the terms position and location are used interchangeably and can be relative (e.g. a coordinate in a reference plane) as well as absolute (e.g. a geographical coordinate).

Each anchor UE 14 corresponds to a wireless device that offers ranging and/or positioning signals to the UE 10. Additionally, the anchor UEs 14 may offer ranging/positioning services to UEs and other anchor UEs.

It is noted that the device UE 10 and the anchor UEs 14 may be a mobile phone or any type of connected device and can support Uu and PC5 3GPP interfaces. These devices may be capable of supporting multiple radio access technologies including but not limited to 2G/3G/4G/5G networks as described by 3GPP, non-3GPP wireless technologies operating in an unlicensed wireless spectrum such as the Wi-Fi spectrum, the Bluetooth spectrum, and ISM bands. The mobility of the device UE 10 and the anchor UE 14 does not affect the capability of a device UE 10 to become an anchor UE 14 or vice versa. Depending on the application, the anchor UE 14 can also be a fixed device (e.g., smart television) and a mobile device UE 10 (e.g., mobile phone) may even be authorized to become an anchor UE 14 either when it is moving or when it becomes and remains fixed in one location. Typically, an anchor UE 14 knows its own location or is able to obtain its own location from a location service, or is able to provide/determine a reference plane and reference direction for distance/angle measurement using ranging procedures with a device UE 10, and should also be able to do so when out-of-coverage of the network. The position of an anchor UE may need to be relatively stable, e.g. not move or shake too much, or at least be stable compared to device UE 10 (e.g. if both moving in the same direction, e.g. both UEs in the same vehicle, the absolute velocity of ranging UE 14 is less important than the relative velocity). Preferably, an anchor UE is in coverage of the network so that it can access location services offered by a core network, can obtain its position, can remain synchronized with the network, can obtain authorization of the ranging procedure, etc).

Both the device UE 10 and the anchor UE 14 may have a receiver unit for receiving ranging reference signals and/or other wireless signals used for distance/angle measurement and which may be able to determine the timing of these signals, and may have a computational unit for calculating/determining distance/angle/positioning measurements (e.g., reference signal time difference (RSTD), reference signal received power (RSRP), Rx-Tx time differences between a device UE 10 and an anchor UE 14 and/or a device UE 10 and a wireless access device (e.g., base station or gNB) 20). The computational unit (or another computational unit at device UE 10 or anchor UE 14) may also be able to calculate a distance, angle, or (relative) position based on these distance/angle/positioning measurements (possibly augmented with data from other sensors, such as barometric pressure sensors) and/or distance/angle/positioning measurements (possibly augmented with data from other sensors, such as magnetic sensor) received from other device. In addition, the device UE 10 and the anchor UE 14 may have a transmitter unit for transmitting signals used for distance/angle measurements (e.g., position reference signals or sounding reference signals) and which may be able to determine the timing of these signals. An anchor UE may have a known/fixed position, and hence may be a Position Reference Unit as described in 3GPP document R2-2109489 and, in addition, may transmit this information to device UEs 10 and/or other anchor UEs 14. The device UE 10 and anchor UE 14 may support transmission of signals and receiving signals to enable communication with a wireless access device (e.g., as defined in 3GPP specification TS 38.300) and may be able to communicate with a (cellular) core network and its services (e.g., as defined in 3GPP specification TS 23.501), such as a location service (e.g., as defined in 3GPP specification TS 23.273) using protocols such as LTE Positioning Protocol (LPP) as defined in 3GPP specification TS 36.355 or NR Positioning Protocol A (NRPPa) as defined in 3GPP specification TS 38.455. Furthermore, the device UE 10 and anchor UE 14 may support discovery and communication over PC5/sidelink (e.g., as defined in 3GPP specifications TS 38.300, TS 23.287, TS 23.304 and TR 37.985) with another device UE and/or anchor UE.

The device UE 10, the anchor UE(s) 14 and the wireless access device 20 may together form a positioning constellation (PC) 60.

Ranging or sidelink-based positioning might be done between the device UE 10 and one or more anchor UEs 14 depending on the application and accuracy needs. For instance, a simple application such as rough ranging may be used by a single anchor UE 14 to provide an indication of a rough range/area. Other applications may require three or more anchor UEs 14 tightly clock-synchronized with the device UE 10.

The ranging constellation 50 comprises a set of UEs, e.g., the device UE 10 and at least one anchor UE 14 that performs ranging and that can support each other in determining a geographical location and/or in the provisioning of relative positioning services (e.g. determining a location in a reference coordinate system). In the ranging constellation 50, one of the anchor UEs 14 may be the head or lead anchor UE in charge of managing the remaining set of anchor UEs 14 (e.g. act as synchronization source for the other anchor UEs). Additionally, an anchor UE may be configured to support a managing entity e.g. to select, configure, reconfigure etc. other anchor UEs 14.

At least one wireless access device 20 (e.g., base station or gNB) is configured to handle the connectivity of UEs to a core network (CN) 30. It may also support a number of positioning techniques either in an isolated manner or in combination with other wireless access devices 20. The wireless access device 20 is responsible for among others, radio resource allocation and scheduling, clock time synchronization and power control of connected devices.

The wireless access device 20 may also provide positioning signals and may provide (access to) positioning services for the devices in the ranging constellation 50. A positioning constellation 60 comprises a set of at least one wireless access device 20 (possibly in conjunction with a positioning service in the core network such as LMF) that provides positioning services to at least one device UE 10 or anchor UE 14. The device UE 10 or anchor UE 14 might not always be connected to the wireless access device 20, i.e., they might be out of coverage, but a device UE 10 or an anchor UE 14 might have connected before to a positioning service related to positioning constellation 60 to get its position; it might have also received the position from a managing entity (e.g. an installer UE). Later, when the anchor UE is not in coverage, it can still send ranging signals and/or information about its position while not being connected to the wireless access device 20.

Furthermore, a core network (CN) 30 provides networking functions that control the access network and manage the UE devices 10 and anchor UEs 14 subscribed to core network services and served by means of the access network. It may be, e.g., a 5G core network. The core network 30 can include a number of network functions including an access and mobility management function (AMF) 32 configured to manage access and mobility of subscribed UEs, a location management function (LMF) 34 configured to manage positioning services offered to UEs 10 and anchor UEs 14, a ranging management function (RMF) 36 configured to manage ranging services between (ranging) UEs 10 and anchor UEs 14, and a network exposure function (NEF) 38 that allows an application function (AF) 40 to connect to the core network 30.

It is noted that a network controller device may perform the role of the core network 30 in the described embodiments. It is also noted that an LMF 34 or RMF 36 may comprise or connect to a set of services/functions (e.g. Gateway Mobile Location Centre, (GMLC)) that may together be responsible/capable of determining, verifying, providing and/or storing a set of locations, distances, angles, coordinates, and other relevant information for location and/or ranging services, and/or managing/configuring/operating a set of location and/or ranging services, and/or combining distances, angles, location information with distance, angles, location information from other sources or resulting from various location/ranging mechanisms. The term LMF or RMF denotes any such service/function or combination thereof. The LMF and RMF are also considered to be a position service, ranging service or a combined position-ranging service. The application function 40 may be a third-party application that may be interested in leveraging the services provided by the core network 30 and the wireless connectivity offered to UEs 10 and/or anchor UEs 14.

According to various embodiments, a managing entity is provided that configures one or more UEs as anchor UEs 14 to form the ranging constellation 50 and support ranging services, location services and/or ranging-based positioning services (i.e., a combination of ranging and location service functionality). In addition to improving localization and ranging accuracy, the ranging constellation 50 also helps to reduce power consumption at least for the involved UEs 10 by combining ranging and location services.

More specifically, location accuracy can be improved with simple ranging measurements between the devices, initiated and/or coordinated either locally or centrally. In examples, this can be realized by using ProSe discovery messages and/or carrier phase based ranging/positioning techniques and/or ranging/positioning signals transmitted combining FR1 (e.g., low/mid bands, typically up to 7.125 GHz) and FR2 frequency ranges (e.g., mmWave bands, typically above 24 GHz).

The core network 30 (e.g., network controller device), together with the wireless access device 20 (e.g., base station or gNB), may support ranging and/or positioning services needed by one or more device UEs 10 and offered by one or more anchor UEs 14 via the managing entity. A managing entity can typically support one or more of the following:
provide a user interface through which a user can select and (re-)configure a set of UEs to form a ranging constellation, and/or through which it can manage ranging and/or location procedures and/or ranging services and/or location services, such as configuring the requirements and parameters of the ranging procedures/service and/or location procedures/service including but not limited to:
   which ranging/positioning method to use (e.g. RTT based, TDOA based, AoA/AoD based),
   which Radio Access Technologies to use (e.g. 3GPP LTE, 3GPP 5G NR, Wi-Fi, Bluetooth, UWB, . . . ),
   which frequency bands to use (incl. whether unlicensed/licensed spectrum is to be used),
   which bandwidth to use,
   minimum/maximum/default measurement duration and/or timing of ranging reference signals/measurements,
   minimum/maximum/default transmit power to use,
   desired/minimum accuracy of ranging,
   constellation size (e.g. number of devices, identities of the involved devices, area information, maximum distance),
   constellation configuration (e.g. known positions and/or initial position estimation of one or more devices constituting the constellation and/or estimated distance/angles),
   area map,
   coordinate system to be used (incl. which device or anchor point is used as the primary reference point/center),
   sampling frequency of ranging and positioning measurements,
   credentials (e.g. security keys, identities) to be used during discovery and/or ranging procedures;
provide intermediary/proxy configuration functionality through which a network entity (e.g. a location/ranging management function), an access device (e.g. a base station) or an application function (e.g. through a network exposure function) can select and (re-)configure a set of UEs to form a ranging constellation, and/or through which it can remotely manage ranging and/or location procedures and/or ranging services and/or location services (such as configuring the requirements and parameters of the ranging procedures/service and/or location procedures/service, as described in the previous bullet). The configuration by a network entity may be done directly (e.g. through a set of messages as part of a configuration protocol) or indirectly (e.g. through a set of policies/rules that the managing entity can use to decide e.g. how to determine/select anchor UEs or e.g. how to configure parameters to perform ranging).
collect information relevant for ranging (e.g. device identities, ranging capabilities, configuration parameters used for ranging) from UEs of a ranging constellation and send it to a ranging or location service, and/or store it in a non-volatile storage.
collect ranging results (e.g. distances, angles, relative or absolute coordinates) and/or ranging measurements (e.g. round-trip times) from UEs of a ranging constellation and send it to a ranging or location service, and/or store it in a non-volatile storage.
collect information about ranging devices as discovered by UEs of a ranging constellation (e.g. discovered device identities, discovered ranging capabilities) and/or ranging results (e.g. distances, angles, relative or absolute coordinates) and/or ranging measurements (e.g. round-trip times) from a set of UEs and determine if a set of UEs form a valid ranging constellation.
   A managing entity may be:
a function offered by a UE (e.g. an anchor UE 14 or an installer UE) through which a user can manually manage and/or through which a network entity (e.g. location service to which the anchor UE is communicatively coupled) can remotely manage the ranging constellation, the ranging and/or location procedures and/or ranging/location services (such as configuring the requirements and parameters of the ranging procedures/service and/or location procedures/service as mentioned above)
a user or an application communicatively coupled to the core network 30 (e.g., network controller device) via e.g. the network exposure function 38, and/or the location management function 34, and/or the ranging management function 36 and/or other core network function through which the ranging constellation and/or the ranging and/or location procedures/services can be managed (such as configuring the requirements and parameters of the ranging procedures/service and/or location procedures/service as mentioned above);
a selected one of the wireless access device 20 and/or the core network 30 (e.g., network controller device or a visiting core network) that can (automatically) manage the ranging constellation and/or the ranging and/or location procedures of a set of UEs connected to it and/or the ranging and location services it offers to a set of UEs connected to it or that is offered by a set of UEs connected to it, e.g., after being configured by the location management function 34, and/or the ranging management function 36 (e.g. operated by the home core network); or
a location management function 34 and/or a ranging management function 36 inside or outside of the core network 30, which may manage the ranging and/or location procedures/service (such as configuring the requirements and parameters of the ranging procedures/service and/or location procedures/service and/or configuring a ranging constellation) based on operator managed default operation settings, policies, location databases, historical measurement data, Artificial Intelligence model, possibly in cooperation with core network functions, such as Network Data And Analytics Function (NWDAF, e.g. to determine density of devices, how many devices are typically registered at a certain time of day etc.), or User Data Management (UDM, e.g. for subscription related data), and/or Policy Control Function (PCF, e.g. for policy related data).

The location management function 34 and/or ranging management function 36 or other managing entity may configure the (managing entity of) one or more device UEs 10 and/or one or more anchor UEs 14 and/or wireless access devices 20 based on the requirements and parameters of the ranging and/or location service (e.g., that have been provided through the network exposure function). The configuration may be done by sending a secure message via the PCF or AMF or directly from a location management function or ranging management function to the respective device UEs 10 and/or anchor UEs 14 and/or access devices 20 upon connection establishment with an access device or core network function (e.g. AMF or location/ranging management function), upon receiving a configuration update request and/or upon receiving a request to initiate ranging and/or position estimation by one of the involved devices. To this end, the device UEs 10 and/or anchor UEs 14 may need to support a protocol for configuration of the ranging procedures/service (e.g. an extension to the LTE Positioning Protocol (LPP) as defined in 3GPP specification TS 36.355). In case one or more of the UEs in a ranging constellation are out-of-coverage or are not directly connected to or directly managed by a ranging/location management function, the configuration may be provided or forwarded to these UEs by a UE in coverage (i.e. in partial coverage situations, in which case at least one of the UEs in a ranging constellation is in coverage), or provided/forwarded by a managing entity (e.g. that may be supported by a (head) anchor UE and that may operate out-of-coverage).

In an example, an LMF is used for the configuration of ranging capable UEs receive for static and/or dynamic configuration information. For configuration aspects that are unlikely to change for each procedure or possibly even during a procedure, i.e. static configuration aspects, such as default coordinate system to use or other default values to take when device gets out of coverage and/or dynamic configuration is not available, or a policy determining the conditions (e.g. whether the device's position is stable) when to take a certain role, or which device identity and/or security credentials to use during discovery and/or ranging procedures, provisioning may also be performed by other core network functions such as PCF or DDNMF.

Possible dynamically configurable parameters of a ranging-capable UE to consider are:
which ranging/positioning method to use (e.g. RTT, TDOA, . . . ),
which bands and which bandwidth to use,
sampling frequency of ranging and positioning measurements,
timing/period/duration of ranging and position signals and measurements,
minimum/maximum transmit power to use,
role of a device (e.g. Anchor UE, Target UE),
ranging constellation information or ranging session related information (e.g. identities of Anchor UEs working together to provide ranging/sidelink position service),
coordinate system to be used,
which device or location/ranging service or location/ranging service proxy will collect the measurements and calculate a distance, angle or position.
   The above mentioned dynamic parameters may change for each ranging session/procedure or may even change during a procedure. The parameters may also change and/or be configured per tracking area or per network (e.g. Visiting-PLMN versus Home-PLMN). These dynamic parameters may be exchanged as part of a negotiation procedure (e.g. during capability exchange or during connection setup over sidelink or initiating a ranging session/procedure) between device UE 10 and one or more anchor UEs 14, whereby one UE may inform the other about its preferred values for one or more of these configurable parameters or a set of possible values (e.g. based on its capabilities), after which the other UE (typically one of the anchor UEs, a head anchor UE, with/without cooperating/requesting the LMF, possibly taking into account the preferences and/or capabilities of the one UE) may determine which values to use for the configurable parameters and send a message to the one UE including the selected values. This could be done for example by extending the Direct Communication Request and the related Direct Communication Response message with additional fields for this. Also, for some configuration parameters that may change during a ranging session/procedure, such as the role of a device, a change to one or more of the configuration parameters may be provided through a message exchange with the other UE (e.g. by extending the Direct Link Modification Request/Accept messages with additional fields), upon which the session/procedure may be adjusted or aborted and/or a new negotiation procedure may be started. Similarly, when a device UE 10 or anchor UE 14 may take part in a negotiation procedure with the LMF (e.g. during capability exchange or during connection setup with the LMF), whereby the UE may inform the LMF about its preferred and/or possible values for one or more of these configurable parameters, after which the LMF may determine which values to use for the configurable parameters and send a message to the UE which includes the selected values. Additionally or alternatively, a device UE 10 or anchor UE 14 may not directly provide a list of capabilities or preferred values for configuration parameters to another UE or LMF, but instead an identifier is provided by which the another UE or LMF can retrieve a list of capabilities and/or preferred values for configuration parameters of the device UE 10 or anchor UE 14, by a message exchange with a core network function or database that stores such list of capabilities and/or preferred values for configuration parameters for ranging capable UEs, which may be linked to one or more identifiers of a ranging capable UE. An identifier of the device UE 10 or anchor UE 14 provided during a message exchange can be used to retrieve the respective list of capabilities and/or preferred values for configuration parameters.

The configuration of the requirements and parameters may be done in the form of a set of policy rules (e.g. provided through RRC, or through a PCF policy container), which may define a set of conditions based on which a device can determine which configuration/method/parameters/values to apply, e.g., a condition defining a minimum measured signal strength above which a ranging measurement in a certain frequency may take place.

In another example, the UEs of the ranging constellation may be provided with the (group/domain) credentials and/or authorization tokens upon configuration by the LMF or other managing entity, e.g. after the LMF has received information about a ranging constellation (e.g. from an external application (e.g. through NEF), LCS Client or other core network functions, which may provide the (group/domain) credentials to be used) or has dynamically established that a set of UEs form a ranging constellation (upon which the LMF, possibly in cooperation with other core network functions, may determine which (group/domain) credentials are to be used). The LMF or other managing entity may use e.g. the LPP protocol to provide the (group/domain) credentials to be used for a ranging constellation to a Target UE or Anchor UE. Alternatively or additionally, the PCF may provide the (group/domain) credentials to be used for a ranging constellation as part of the UE configuration data, e.g. during initial network configuration or using the UE Configuration Update procedure as specified in 3GPP TS 23.502). Alternatively or additionally, the (group/domain) credentials to be used for a ranging constellation may be stored in the USIM (e.g. during initial provisioning or (e)SIM profile downloading).

Furthermore, a (new/different) Target UE or Anchor UE may join a ranging constellation (e.g. a target UE may temporarily get associated with a ranging constellation in order to determine the target UE's location, possibly automatically when the LMF or other managing entity determines the Target UE is in vicinity of one or more Anchor UEs of the constellation (e.g. based on tracking area or cell-ID information provided during attach/registration to the network, or based on sidelink discovery information received from/by a Target UE or Anchor UE, or based on a last known position of the Target UE) and/or when the LMF or other managing entity determines the Target UE to be part of the same trusted group/domain as other UEs in a constellation (e.g. part of a set of identities provided by an application (e.g. through NEF), and/or belonging to a same Closed Access Group, Non-Public Network, (private) Network slice), and/or upon request of the Target UE or an Anchor UE to perform location estimation of the Target UE, and/or upon a request (e.g. by the Target UE or an application (e.g. through NEF)) for a Target UE to be added to the ranging constellation, after which the LMF or other managing entity (e.g. PCF during initial network configuration) may provide the (group/domain) credentials to be used for a ranging constellation to a Target UE or Anchor UE. Note that every time a UE joins or leaves a constellation, a new set of group/domain credentials may need to be determined and provided to all remaining UEs of the ranging constellation.

Providing the (group/domain) credentials to be used for a ranging constellation may be done e.g. upon the Target UE or Anchor UE successfully attaching/registering to a given Closed Access Group, Non-Public Network, Network slice, or trusted group/domain, the result of which may be provided to the LMF (or other managing entity) by the involved core network functions (e.g. AMF, AUSF or UDM), and/or the LMF (or other managing entity) may issue a request to the UDM (or other core network function) to verify for a given Target UE's identity or Anchor UE's identity if a Target UE or Anchor UE has access to the given Closed Access Group, Non-Public Network, Network slice and/or trusted group/domain, and/or by the LMF or other managing entity verifying that the Target UE's identity or Anchor UE's identity belongs to a set of UE identities that may also join the ranging constellation (provided as part of the ranging constellation configuration information). To this end, the LMF (or other managing entity) may provide a protected message or protected container containing information about the (group/domain) credentials to the AMF and/or gNB to transmit to the respective UE. This may be separate procedure or the AMF and/or gNB may include this protected message/container as part of its responses to the respective UE. Alternatively or additionally, this may be part of an authorization procedure to perform ranging (as described in other embodiments). In case of partial coverage or out-of-coverage situations, the protected message or protected container containing information about the (group/domain) credentials may be provided by the Anchor UE (on behalf of the LMF (e.g. issued and protected by its own local subset of LMF functionality) or as a relayed message from the LMF) to the Target UE.

In a further example related to the configuration of devices to enable ranging, the configuration of the device UE 10 by the managing entity may be achieved by assigning security keying materials and ProSe discovery information as described in 3GPP specifications TS 33.303 and TS 33.305. In particular, a set of discovery user confidentiality keys (DUCK), discovery user integrity keys (DUIK) and/or discovery user scrambling keys (DUSK) can be assigned to enable integrity protection, scrambling protection, and/or confidentiality protection. The device UE 10 may also be provided with, e.g., an identifier identifying the ranging application. These parameters may be used in combination with discovery messages to allow devices allowed to perform ranging with each other to discover each other. The configuration/parameters related to a ranging constellation 50 may not be static and may change over time. In an example, the wireless access device 20 (possibly in combination with the ranging and location services), may be communicatively coupled to the device UE 10 and/or an anchor UE 14. The device UE 10 may report its device capabilities and application requirements to the RMF 36 and/or the LMF 34 or other managing entity (e.g. via the wireless access device 20 or via another/head anchor UE which may be connected to the wireless access 20). The anchor UE 14 may report its current configuration and may report information about the current status/evolution of the members of the ranging constellation 50 (such as number of devices, their identities, their capabilities, their estimated positions, their estimated speed/mobility, information about their battery levels/capabilities, information about their resource capacity, or information about which devices are in coverage and which are out-of-coverage) to the RMF 36 and/or the LMF 34 or other managing entity either directly (e.g. via the wireless access device 20), or via a another/head anchor UE which may operate a managing entity or which may be connected to the RMF 36 and/or the LMF 34 or other managing entity (e.g. via to the wireless access device 20). The RMF 36 and/or the LMF 34 or other managing entity might configure the device UE 10 and/or anchor UE 14 with a policy determining the parameters to perform ranging, ranging services and/or location services, the parameters of which may be based on the (latest) information received about the ranging constellation. For example, if the information about the current status/evolution of the constellation show that the number of available anchor UEs of the constellation has reduced since the ranging constellation 50 was established/determined, e.g. because a number of anchor UEs have been switched off or moved too far away from the other anchor UEs in the constellation, the parameters for the ranging procedures or ranging/location services may be adapted, in order to reflect the new situation, and may be reconfigured/updated on the respective devices involved in the ranging constellation 50 and/or device UEs 10 that may make use of the ranging constellation 50. If it is discovered by an anchor UE 14 or a device UE 10 or a managing entity that an insufficient number of anchor UEs of the constellation is available (e.g. in a particular area previously identified to be covered by a ranging constellation), then the constellation may be discarded and information about the constellation and/or the configuration parameters regarding the constellation may be removed from the device UE 10 and/or anchor UEs 14, and may also be removed from the managing entity.

### Details on Establishing a Ranging Constellation

In an embodiment, an anchor UE 14 or managing entity of the ranging constellation 50 may be configured to determine whether or not the ranging constellation 50 is fully formed, e.g., by monitoring the integrity of the ranging constellation 50 to establish and/or verify an operational area of the ranging constellation 50. This may be achieved e.g. by performing mutual ranging measurements between the anchor UE and other anchor UEs in a target area e.g. regularly at a configurable time interval, determining if ranging measurements are integral to the operational area of the ranging constellation 50 (e.g., based on the regular ranging measurements between anchor UEs and/or the changes in its own location estimates either from a ranging service or from a location service), or triggering a mutual ranging measurement between all neighbouring device UEs of the ranging constellation 50 within a configurable time interval between ranging measurements.

In general, the integrity of the ranging constellation depends on measurable changes in the properties of the ranging constellation 50, such as mobility of the devices, total number of devices and/or changes in the device capabilities such as the battery capacity and/or signal coverage. These aspects may be monitored (e.g., measured/determined at regular time intervals) and information on these aspects may be collected by a managing entity to determine the integrity and hence the operational area of the constellation.

The operational area of the ranging constellation 50 may be any space with any shape where the ranging constellation should operate. It may be defined as a range/radius around some center point. It may also be defined as a rectangle or complex shape resulting from the added coverage areas of the anchors, etc.

The coverage area of an anchor UE (e.g., as determined by a managing entity or (head) anchor UE) for the purpose of ranging may be based on an estimate of the signal dissipation/attenuation, which may be based on signal strength/quality measurements over sidelink (e.g., measured on received sidelink discovery message), and/or on signal strength/quality measurements between the anchor UE and a base station, and/or the capabilities of the device (e.g., number of antenna, battery level) and/or the ranging method supported/used. To this end, these measurements and capabilities and configuration parameters of the anchor UEs may be transmitted to the managing entity of a constellation for further processing and determination of the operational area.

An anchor UE may be informed by the managing entity with the (latest) (geographical) position coordinates of other anchor UEs, e.g. to provide a better estimation on signal dissipation/attenuation by using the measure ranging reference signal quality or signal quality of other sidelink messages, and comparing this with the distance between the anchor UE and another anchor UE. An anchor UE may also use distance measurements based on ranging for this. An anchor UE may be configured to adapt its transmit power (e.g. of the ranging reference signals) to increase the coverage of the anchor UE and/or to improve the signal quality within the operational area. Such configuration changes may depend on the results of integrity monitoring of the constellation.

In an example, if the ranging measurements within the target area are complete within the configured time interval, while within that time interval the integrity of the measurements did not change beyond a configured threshold of the ranging constellation 50, the anchor UE 14 determines that the ranging constellation 50 is fully formed and communicates this information to the ranging service at a base station (e.g., gNB) 20 and/or the core network 30.

In another example, either the anchor UE 14 or the ranging service may decide how often the constellation formation process and/or integrity of the constellation is checked based on the mobility (e.g. speed) or available resources (e.g., battery capacity, signal coverage, mobility) of the anchor devices 14 of the ranging constellation 50 and/or configured by a user/application via the NEF 38.

In a further embodiment that can be combined with any other embodiment or implemented independently, the mobile device UE 10 in combination with a ranging and/or location service may trigger the formation of a particular ranging constellation 50. This may be achieved by configuring the device UE 10 to obtain a list of ranging capable UEs in the vicinity e.g. via a sidelink channel and determine UE(s) that is/are in a position to act as an anchor UE 14 to form a ranging constellation 50. A preliminary configuration of that particular ranging constellation 50 may then be prepared by the device UE 10 and (securely) forwarded to the managing entity to assist in the formation of the ranging constellation 50.

In still further examples, the base station device (e.g., gNB) 20 in combination with the ranging and location service or the ranging or location service itself may be adapted to configure one or more mobile device UEs 10 as one or more anchor UEs 14 of a particular ranging constellation 50.

A particular ranging constellation 50 may be formed by the managing entity by identifying and selecting a list of ranging capable UEs based on device parameters such as location information, identity information, and device capabilities, either manually by an installer or automatically by a base station and/or a network controller. The ranging constellation 50 may be provided with a unique identity. This identity may be used for, among others, managing the ranging constellation 50, tracking a membership of particular UEs in the ranging constellation 50, and/or tracking a movement of the ranging constellation 50 as an entity.

Note that the unique identity of the ranging constellation 50 may be generated by the managing entity and the unique identity may be shared between multiple wireless networks that offer ranging and location services. The unique identity may also be used during discovery of ranging capable devices and/or during connection setup between ranging capable devices and/or exchanging messages to initiate a ranging session.

In a still further example, a selected UE may (securely) receive a configuration message from the base station device (e.g., gNB) 20 to act as an anchor UE 14 for a particular ranging constellation 50, wherein the configuration message may contain the information about that ranging constellation 50 such as its unique identity (ID), size, maximum and minimum number of devices (e.g., anchor UEs 14) in the ranging constellation 50.

The configuration message may also include (temporary) identity information on how the anchor UE 14 can be identified during discovery, ranging, positioning and/or communicating to a location service/database or ranging service, and may also include credentials for use during discovery, ranging, positioning and/or communicating to a location service/database or ranging service.

Alternatively, the configuration message may be received from the managing entity, the location management function (LMF) 34 or the ranging management function (RMF) 36 or any other network function may decide and instruct a selected UE to become an anchor UE 14, e.g., during connection setup and/or a ranging session initiation event and/or a ranging authorization procedure and/or policy/configuration updates, based on same or similar policies/criteria as the criteria by which a UE can decide to become an anchor UE 14 (as described in other embodiments), and respective information received from or known about the UE. The managing entity, the location management function 34 or the ranging management function 36 or other network function may verify if the subscription of the UE allows it to function as an anchor UE 14 (e.g., using a subscription profile information stored e.g. in a unified data management (UDM) entity or other subscriber or subscription-related database). In an example, a managing entity may determine that a UE can/should become an anchor UE 14 based on a set of policies/criteria such as whether the UE has the capability to determine its position (e.g. through GNSS) (whereby information on this may be obtained from a location server or from the UE itself), and/or whether the position of the UE is stable (e.g., with a certain allowable deviation threshold, and/or fluctuating within a sufficiently small (geographical) area), and/or whether the UE moves at a fixed speed or a speed fluctuating between minimum and maximum deviation thresholds, and/or whether signal quality/strength measured and/or reported by the UE of positioning/ranging reference signals or signals from an access device are above a certain minimum threshold, and/or whether signal quality/strength measured and/or reported by a base station of sounding reference signals or other signals from the UE are above a certain minimum threshold, and/or whether a doppler-shift/hysteresis measured and/or reported by the UE of positioning/ranging reference signals or signals from an access device (possibly indicated as a scaling factor, expressed in dB, on top of a signal strength/quality threshold, whereby the scaling factor may be different for different (relative) speeds) are within certain thresholds, and/or whether a doppler-shift/hysteresis measured and/or reported by the access device of sounding reference signals or other signals from the UE are within certain thresholds, and/or whether the UE is in coverage of a base station or connected to a certain network (e.g. Home PLMN), and/or whether the UE has a connection with a location/ranging service, and/or whether the UE supports an accurate clock, and/or whether the UE is synchronized with a certain reference clock, and/or based on which ranging mechanisms (e.g. TDOA, Round-Trip Time) the UE supports, and/or based on which sensors (e.g., barometric pressure sensor, gyroscope) the UE supports, and/or how many antennas the UE has. The configuration of the policies/criteria may be different (e.g. different set of parameters or different values) for different anchor UE capabilities and/or different situations, e.g. whether it can act as a proxy for location services, whether it can act as a Position Reference Unit, whether it is in coverage of the network or not, whether unlicensed or licensed spectrum is available/is used, which tracking area/country the UE is in, whether it is connected to a visiting PLMN or its home PLMN. After the managing entity has determined that the UE can function as an anchor UE 14, it may configure the UE accordingly and/or report to the UE that it can become an anchor UE 14. Once the managing entity has determined that the UE can become an anchor UE or after the UE has become an anchor UE, the managing entity may add the UE as an anchor UE to a ranging constellation. It may also instruct/configure the UE to switch on/off certain ranging related capabilities based on whether one or more of the above mentioned policies/criteria is met, such as its capability to act as proxy for location services. The managing entity may update the other UEs in the ranging constellation about the newly added anchor UE (e.g. by sending a new configuration). Similarly, based on the same criteria as mentioned above (but which may be configured independently through a policy with different values/thresholds and e.g. some timer information how long a UE should be within or outside the configured values/threshold before it stops being an anchor UE), the managing entity may determine that a UE does not meet the criteria for being an anchor UE anymore (or meets the independently configured policy). Once the managing entity has determined that the UE needs to stops being an anchor UE or after the UE has stopped being an anchor UE, the managing entity may remove the anchor UE from a ranging constellation. The managing entity may may configure the UE as an anchor UE (e.g. to configure the ranging reference signals, resource scheduling information, provide information about the constellation if it is capable to act as a proxy for the LMF 34 or RMF 36, etc.), and update the other UEs in the ranging constellation about the removed anchor UE (e.g. by sending a new configuration). Additionally or alternatively, the distance/angle/(relative) position between an anchor UE and other UEs in a constellation may be determined (e.g. initially or at regular intervals), and if the distance is within certain thresholds (e.g. distance to a (pre-)configured number of other anchor UEs or distance to the center of the ranging constellation) the anchor UE can be added or remain in a ranging constellation. If the distance deviates too much (e.g. beyond the configured thresholds), then the anchor UE may be removed from a ranging constellation or may be marked as an “outlier”.

In other words, a system and method are provided whereby the system comprises a managing entity (running on a device operating a core network function (such as LMF or RMF), or on a device UE 10, or on an anchor UE 14) and a device UE 10, and whereby based on information obtained from device UE 10 or an access device 20 and a set of policies/criteria determines whether or not device UE 10 may become an anchor UE 14, and configure the device UE 10 accordingly, and whereby the policies/criteria includes at least one of whether device UE 10 is capable of determining or retrieving its position, whether the position of device UE 10 is stable, and whether device UE is in coverage of an access device.

In a still further example, the managing entity (e.g., on a base station device 20) may designate an anchor UE 14 as a head anchor UE of a particular ranging constellation based on device characteristics such as mobility, energy capability, or visibility to other devices in the ranging constellation 50.

The head anchor UE may be adapted to exchange ranging measurements via a ranging service (e.g. operated or managed by RMF 36) instead of directly exchanging information with other anchor UEs 14 in a separate channel, such that overall power consumption of the anchor UE 14 is reduced. A specific identifier may be assigned to the head anchor UE, for example, an L2 identifier, an application/service/device identifier, or a ProSe Discovery/User Info ID, that can be used during discovery and/or connection setup to the head anchor UE or the ranging constellation 50 rather than any of the other anchor UEs 14 within the ranging constellation 50.

In a still further example, the base station device (e.g., gNB) 20 or the LMF 34 may be adapted to create and maintain a provisional (virtual) ranging constellation of anchor UEs 14 either directly or via the core network 30 (e.g., a network controller device).

In a more specific example, before self-configuration of a UE to act as an anchor UE 14 of a ranging constellation, the potential anchor UE 14 may inform a head anchor UE and/or the managing entity and obtain its authorization. The potential anchor UE 14 may take this decision based on a policy configured in the anchor UE 14 by the head anchor UE or the managing entity.

In a still further example, the ranging management function (RMF) 36 may by communicatively coupled with the location management function (LMF) 34 to securely exchange the identities of anchor UEs 14 that have used the ranging information to obtain their location coordinates. In addition to the identities, the RMF 36 may exchange, if available, metadata such as timestamps or positioning signal features to translate the ranging information to a location information.

As an additional option, the LMF 34 may occasionally receive location data reported by an anchor UE 14 at configurable time intervals, such that the provisional constellation truly represents the physical constellation in the field. E.g., the moment at which location data of an anchor UE 14 is reported to LMF 34 may either be configured by the LMF 34 or configured by the anchor UE 14 itself depending on measurable changes in the properties of the ranging constellation 50, such as mobility of the devices, total number of devices and/or changes in the device capabilities such as the battery capacity and/or signal coverage. Note that the provisional constellation and physical constellation may have the same unique identifier.

Additionally or alternatively, the network exposure function 38 may be used (e.g., by an external application) to control network level parameters and other parameters/configuration settings required for optimal performance of ranging and location service for the intended mobile devices. These parameters may be combined with configuration parameters received from the involved device UEs 10 and/or anchor UEs 14 and/or (other) managing entities. In case of overlapping configuration parameters with different values a priority scheme may be applied whereby configuration parameters received from a device UE 10 and/or anchor UE 14 and/or (other) managing entity may have precedence over a configuration parameter received via the network exposure function, or vice versa. Upon detection of an overlapping configuration parameter with different value, the location management function 34, and/or the ranging management function 36 and/or other location/ranging service or proxy thereof may discard the measurements and/or measurement results and/or calculated distance/angle and/or may send an error message and/or may send a message to the respective device UEs 10 and/or anchor UEs 14 involved to update the configuration parameter.

Similarly, if a device UE 10 and/or anchor UE 14 receives a configuration parameter or a desired parameter value to be used that conflicts with a configuration parameter (e.g., range of valid values, or maximum/minimum values) received from a managing entity with a higher priority, it may discard the ranging request, discard a measurement/measurement result, discard a calculated distance/angle, generate an error message, request an update of the configuration parameters or request an exception from the higher priority managing entity. In case of multiple managing entities, the core network may configure a policy with priority rules for different managing entities. The conflict resolution may also be done on a first come first serve basis, or e.g. use the configuration received from the closest anchor UE.

### Ranging Based Positioning

In the following, specific ranging-based positioning embodiments are described in more detail with reference to the network architecture of FIG. 5.

In an embodiment, the ranging or positioning may be executed between the device UE 10 and an anchor UE 14, according to the configured parameters of a managing entity in the anchor UE 14 or a managing entity which may provide the configured parameters (for example directly (e.g. over Uu or PC5 interface) or via the anchor UE 14 or via a relay device (e.g. ProSe UE-to-Network relay). To this end, the anchor UE 14 or the managing entity may expose one or more of the configured parameters and/or the values that the anchor UE or managing entity selected and/or decided to use for the parameters to perform a ranging procedure (e.g. the ranging method used, bandwidth/frequency used, number of antennas used) for a ranging or location service to one or more device UEs 10 and/or one or more other anchor UEs 14, e.g., through ProSe discovery messages and/or by transmitting the configured parameters after establishing a sidelink/PC5 connection with the one or more device UEs 10 and/or the one or more other anchor UEs (e.g., through a PC5 signaling message or RRC message or Direct Communication Request/Accept message or through a LPP/NRPPa protocol message, whereby these messages may be new ones or existing ones with additional/different fields specified for the purpose of ranging). In a specific example, the LPP/NRPPa payload is encapsulated in a PC5 signalling message instead of an IP packet, e.g. by introducing a new PC5 signalling message “PC5-PP” which includes a field of variable length which can be given a value starting with a LPP/NRPPa message type field followed by the respective Information Elements as specified for the respective LPP/NRPPa message type. In this manner, no new protocol needs to be defined for LPP/NRPPa, but still the overhead of setting up an IP connection first can be avoided, which will reduce the overall connection setup time and reduce the overhead. In another embodiment, the ranging service or positioning service may be executed by the wireless access device 20 or by the core network 30 (e.g., network controller device) or by proxy through an anchor UE 14. The devices UEs 10 and/or anchor UEs 14 that are involved in the ranging/positioning may send the configuration parameters that they selected and/or used to perform ranging (e.g., the ranging method used, bandwidth/frequency used, number of antennas used) (additionally or separately from the respective distance/angle measurements) to the ranging service (or proxy thereof) or location service (or proxy thereof) or a managing entity (which may collect the information from multiple UEs involved and send it to the ranging or location service). The ranging service or location service can use this information to determine how to calculate a position/distance/angle estimation and/or determine an accuracy estimation of the measurements, a threshold for accepting measurements, a value for measurement/calculation error compensation and/or to determine a change to the configuration of one or more UEs involved.

In an embodiment, in order to initiate ranging, the device UE 10 may send a signal to an anchor UE 14, or an anchor UE 14 may send a signal to a device UE 10, or in case of a ranging constellation consisting of more than two UEs, a device UE 10 or anchor UE 14 may send a signal to another device UE 10 and/or another anchor UE of the ranging constellation to request the start of a ranging session. This may be a separate signal or message, or may e.g. be indicated by setting an attribute during connection setup between the two UEs (e.g., a boolean ‘rangingrequest’ attribute as part of a Direct Communication Request message or an RRCSetupRequest). This is typically done during or after a discovery phase through which it may find out the configured parameters (as described above) and/or possibly other properties of the ranging service or location service provided by the other device (e.g. supported ranging capabilities, whether or not it acts as an anchor UE, which (preferred) ranging method to use, location information, device identifier, ranging constellation identity/identifier, list of anchor UE identities (of a ranging constellation), position information of one or more anchor UEs (of a ranging constellation), key identifier, credentials (e.g. public keys), nonces, position information (e.g., its geographical/GPS coordinates), (supported) signal type(s), frequency/band information, which PLMN it supports or it can connect to, which location service or location service capabilities it supports or it can connect to, which ranging service or ranging service capabilities it supports or can connect to, synchronization/clock/timing information, whether or not it is in or out of coverage of an access device, and if in coverage which access device and its properties, whether or not it support ProSe relay or other ProSe or V2X or sidelink/D2D services, antenna information/configuration). Note that the above mentioned parameters may also be transferred during a (pre-)configuration phase (e.g. received as part of policy information from the PCF when the UE was in coverage), or (e.g., through a PC5-signalling or RRC message) after discovery, e.g. after a PC5/sidelink connection has been set up. Note also that if a request to initiate a ranging session is received by one of multiple anchor UEs in a ranging constellation, the anchor UE that receives the request may forward the request or issue a request to other anchor UEs in the ranging constellation, or may forward the request or issue a request to a ranging service or location service (which in turn may forward or issue a request to other anchor UEs in the ranging constellation.

In an example, multiple Anchor UEs 14 can work together to perform sidelink positioning of a Target UE 10 in various coverage scenarios. A Target UE may connect to multiple Anchor UEs to perform the ranging procedure. By collecting the information from the various ranging measurements the sidelink position can be calculated more accurately than when only a single Anchor UE would be used. These multiple Anchor UEs may form a so-called ranging “constellation” whereby these anchor UEs may have a fixed position and together can cover a certain area, such as a room or building. A Target UE may discover multiple Anchor UEs or may discover a constellation of anchor UEs (which could have an identity of its own) in its vicinity, and invite them all to participate in the same ranging session/procedure. Alternatively, the Target UE may discover one Anchor UE (of a ranging “constellation), after which the anchor UE or LMF (or other managing entity) will invite other Anchor UEs to join the ranging session/procedure. To this end, information about a session identifier or constellation identifier may be exchanged amongst the Target UE and Anchor UE(s) involved. Additionally or alternatively, a Target UE (or Anchor UE) may discover an Anchor UE (A1), which may in its discovery response message (or in a PC5 groupcast/multicast/broadcast message or via a PC5 unicast link between the Target UE (or Anchor UE) and the Anchor UE (A1), e.g. using an extended encapsulated LPP assistance or similar command) provide to the Target UE a list of identities (e.g. L2 identities for discovery or Direct Communication Request, or L2 groupcast/multicast/broadcast identifiers) of other Anchor UEs in vicinity (e.g. as discovered by the Anchor UE (A1)) and possibly other information about other Anchor UEs in the vicinity (e.g. as part of Metadata field in a discovery message from that Anchor UE (A1) to the Target UE), whereby the list may be subsetted to only include Anchor UEs of a ranging constellation, so that the Target UE (or Anchor UE) perform targeted discovery (e.g. by including the identifier of the Anchor UE to be discovered in its discovery solicitation messages) and/or can directly issue a DCR message to connect to these Anchor UEs, without having to discover them first. Additionally or alternatively, the LMF (or other managing entity) may request one or more Anchor UE(s) 14 to perform discovery of a Target UE 10, after which they may establish a ranging connection with each other and may join the ranging session/procedure.

In an example, the LMF (or other managing entity) instructs each invited Anchor UE to use the same session identifier or constellation identifier by including such identifier when setting up a connection or send a message to initiate ranging with the Target UE 10. In another example, the Target UE 10 uses information received about a constellation to derive a single session identifier or the constellation identifier itself, and includes this identifier when setting up a connection or send a message to initiate ranging to each Anchor UE that it has discovered that matches an identity of an Anchor UE of the constellation or that has provided through its discovery announcement or discovery response a constellation identifier that matches the constellation identifier. An Anchor UE 14 may provide a session identifier (e.g. provided by the LMF or other managing entity as part of its invitation to join a ranging session procedure or as part of the Anchor UE's configuration information) through its discovery announcement or discovery response that a Target UE 10 may compare with its known session identifiers. If the session identifier matches a known session identifier, the Target UE 10 may identify the discovered Anchor UEs 14 as an additional Anchor UE that may be part of a constellation, and hence set up a connection with that Anchor UE to join the ranging session with that session identifier or send a message to initiate ranging with that session identifier.

In another example, Anchor UEs of a ranging constellation are configured/invited to participate in the ranging and/or location estimation of a Target UE but don't need to actively set up a ranging session with the Target UE. This may be done by the LMF 34 or RMF 36 (or other managing entity) providing configuration information to a respective Anchor UE of the ranging constellation which may include information about PRS/SRS or other ranging reference signals (e.g. signal characteristics/type, resource schedule, frequency bands/bandwidth used, etc.) that a Target UE or other Anchor UE will use. This information can be used to monitor the relevant signals and perform measurements on these if it receives a relevant signal (e.g. determine its arrival time at the respective Anchor UE) and report these measurements (or a calculated ranging result such as a distance or angle) to the LMF 34 or RMF 36 or proxy thereof. The configuration information provided to the respective Anchor UE may include an identifier of a target UE or other Anchor UE or identifier related to a ranging reference signal configuration or configuration item therein (e.g. a particular resource schedule), that the Anchor UE may use in its reporting of the measurement/ranging results to the LMF 34 or RMF 36 or proxy thereof by associating a particular reception of a relevant signal to this identifier. The timing of the measurements or signal characteristics or frequency being used may be sufficient information for the Anchor UE to determine to which ranging procedure or for which other UE the measurement applies, based on this configuration information, so that it can determine which identifier it may use in its reporting. The configuration information may also include information about PRS/SRS or other ranging reference signals (e.g. signal characteristics/type, resource schedule, frequency bands/bandwidth used, etc.) that the respective Anchor UE should use to transmit those ranging reference signals. The Target UE may be configured by the LMF 34 or RMF 36 or other managing entity with similar configuration to receive those signals, but may not be configured with information about which Anchor UE will actually send those signals. Instead, the Target UE may configured with an identifier related to a ranging reference signal configuration or a configuration item therein (e.g. a particular resource schedule), that the Target UE may use in its reporting of the measurement/ranging results to the LMF 34 or RMF 36 or proxy thereof by associating a particular reception of a relevant signal to this identifier. The timing of the measurements or signal characteristics or frequency being used may be sufficient information for the Target UE to determine to which ranging procedure or for which other UE the measurement applies, based on this configuration information, so that it can determine which identifier it may use in its reporting. The configuration information may also include relevant security credentials to be able to decrypt or encrypt the payload of certain signals. Since the Target UE may not even need to know that another Anchor UE is involved in ranging and/or location estimation of the Target UE, the LMF 34 or RMF 36 or proxy thereof has to ensure that the Anchor UE is authorized to be involved in the ranging of the Target UE and/or that that Target UE has provided consent for this. As mentioned in other embodiments the Target UE may provide consent for individual Anchor UEs to be involved in the ranging of the Target UE or to all Anchor UEs of a constellation at once. The LMF 34 or RMF 36 or proxy thereof has to verify the consent given for a Anchor UE and make sure the Anchor UE is properly authenticated and/or authorized providing configuration information to a respective Anchor UE that includes information about PRS/SRS or other ranging reference signals that a Target UE or other Anchor UE will use.

In yet another example, the Target UE discovers multiple Anchor UEs, sets up a connection, and initiates a ranging session with each Anchor UE individually using a separate session identifier. the Target UE (directly if in coverage or if out-of-coverage via an Anchor UE that may forward the message or issue a corresponding message) may report these session identifiers and/or a set of identifiers of the Anchor UEs that it has performed ranging with and/or the ranging measurements or results to the LMF 34 or RMF 36 or proxy thereof. Based on the identifiers of the Anchor UEs, the LMF 34 or RMF 36 or proxy thereof determines for each identifier if the identifier corresponds to an Anchor UE identifier in one or more ranging constellations. In this way, the LMF 34 or RMF 36 or proxy thereof can determine if all Anchor UEs of a ranging constellation have been discovered by the Target UE and/or that the Target UE has performed ranging with. If not, the LMF 34 or RMF 36 or proxy thereof may instruct the Target UE to discover and/or connect to the remaining Anchor UEs of a constellation and/or may configure and/or invite the remaining Anchor UEs to discover the target UE and/or perform ranging with the target UE.

In another embodiment that may be combined with any other embodiment or implemented independently, before the ranging session begins (e.g. during discovery) or during the ranging session, the Target UE 10 receives an identity of each Anchor UE 40. If the identity matches one of the Anchor UE identities in one or more ranging constellations in the ranging constellation information that the Target UE may have received (e.g. from the managing entity during (pre-)configuration), the Target UE may check if it has discovered all the Anchor UEs of the respective constellation and/or has connected to all the Anchor UEs of the respective constellation to perform ranging. If it has not, the Target UE may initiate discovery or connection setup with the remaining Anchor UEs of the respective constellation which the Target UE has not yet discovered or performed ranging with. If a remaining Anchor UE cannot be discovered or cannot be connected to, the Anchor UE may be out of range of the Target UE (i.e. too far away from the Target UE). This information (i.e. that an Anchor UE is out of range) together with area information of the constellation and/or position information of that Anchor UE can be used in the calculations to determine the Target UE's position since it will rule out that a Target UE is close to that Anchor UE and must be somewhere else, for example by excluding a circular or elliptic or hyperbolic shaped area/volume around that Anchor UE with radius, respectively a semi-minor axis, respectively a focus distance minus semi-major axis being equal or less than the (expected/calculated) wireless signal range of a target UE for sidelink communication (on a given frequency) length, or for example by excluding the area behind a “virtual” line (or a further parallel line) between two other Anchor UEs with which the Target UE was able to calculate its distance with, or for example by excluding a set of circular areas with the Target UE as the center and radius being the wireless signal range for sidelink that includes that Anchor UE (e.g. as a point on the circle), but that does not contain one or more of the other Anchor UEs that the Target UE has discovered and was able to calculate its distance with, or for example by excluding those parts of the area as indicated for a ranging constellation that are not close to the Anchor UEs that the Target UE were able to discover and perform ranging with. Additionally or alternatively, the Target UE (directly if in coverage or if out-of-coverage via an Anchor UE that may forward the message or issue a corresponding message) may report the Anchor UE identities that it has discovered and/or has performed ranging with to the LMF (or other managing entity). The LMF can determine based on the received identifiers the constellation(s) to which the discovered Anchor UEs belong. If the Target UE has not reported that it has discovered or was able to discover or perform ranging with one or more other Anchor UEs of such constellation(s), the LMF can use this information in the calculations to determine the Target UE's position since it will rule out that a Target UE is close to those Anchor UEs and must be somewhere else. Additionally or alternatively, an Anchor UE may report to the LMF (or other managing entity) that it has discovered a Target UE or that a Target UE is trying to discover the Anchor UE or that a connection is being or has been established between the Target UE and the Anchor UE (e.g. to perform ranging) or that it has not discovered a Target UE or that the Target UE has not tried to discover or establish a connection with the Target UE. The LMF can this information in the calculations to determine the Target UE's position since it may rule out that a Target UE is close to those Anchor UEs and must be somewhere else if a Target UE has not been discovered or has tried to discover the respective Anchor UE.

As mentioned above, sidelink positioning should work in various coverage scenarios. If the Target UE as well as the Anchor UEs are in coverage of the NG-RAN, the Target UE may connect to the LMF and indicate a preference to collect the measurements and calculate the Target UE's position at the Target UE or indicate a preference to let the LMF to calculate the Target UE's position. In the first case, the Anchor UEs will provide their measurements and information about their position (or reference plane/angle information) to the Target UE. The Target UE needs to be authorized to receive the location of Anchor UE(s). In the latter case, the Anchor UEs provide their measurements and information about their position to the LMF. The Target UE also needs to send its measurements to the LMF in that case. The LMF may configure the Target UE and the Anchor UE(s) accordingly.

Similarly, in case of partial coverage, if the Target UE is out-of-coverage and the Anchor UE(s) (at least one of them) is in coverage of NG-RAN, the Target UE may connect to one or more Anchor UE(s) and indicate a preference to collect the measurements and calculate the Target UE's position at the Target UE, or indicate a preference to let the LMF to calculate the Target UE's position. In the first case, the Anchor UEs will provide their measurements and information about their position (or reference plane/angle information) to the Target UE. The Target UE needs to be authorized to receive the location of Anchor UE(s). In the latter case, the Anchor UEs provide their measurements and information about their position to the LMF. The Target UE would also need to send its measurements to the LMF, but since it is out of coverage, the Anchor UE needs to forward the measurements, for example by using ProSe UE-to-Network relay functionality.

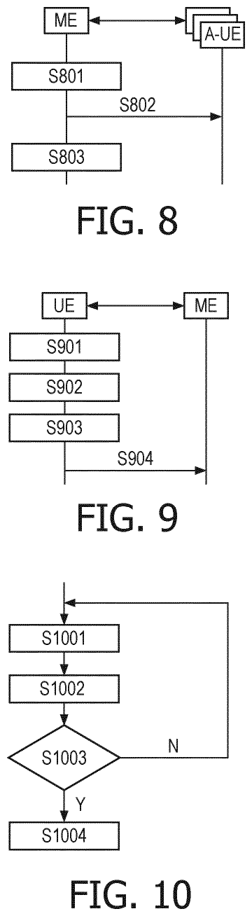

Alternatively, in case of partial coverage and also for out-of-coverage situations an Anchor UE may support a subset of the LMF's functionality to collect the ranging measurements and calculate a position of the Target UE (as depicted in FIG. 8). An Anchor UE should be able to indicate this capability to a Target UE, e.g. during discovery, or as a response to a request/preference of the Target UE to let the LMF calculate the Target UE's position. If the Target UE agrees, the Target UE can send its measurements to the respective Anchor UE. If multiple Anchor UEs are involved in the sidelink positioning, then one of the Anchor UEs is selected and the other Anchor UEs need to send their measurements and positions to the selected Anchor UE. An Anchor UE needs to be authorized to receive the measurements of a Target UE and the measurements and location of other Anchor UEs, and calculate a position of the Target UE.

After or when receiving a signal to initiate a ranging session, the UEs involved may verify if the request comes from an authorized UE. To this end, the UEs may need to exchange credentials, may perform authentication and/or authorization, either standalone or supported by the core network, e.g. may contact the core network to authenticate the UEs involved and verify their authorization. Once the authorization is successful, one or more of the UEs may start to transmit ranging reference signals (e.g., position reference signals/sounding reference signals or other signals (e.g., ProSe discovery message), possibly using radio spectrum resources for sidelink communication or sidelink discovery. This may be a repeated signal for a configured number of times (e.g., with a certain pause/quiet interval between the signals) or until a signal to stop the ranging session is received. The (required) timing of these signals (e.g. the start time of the first signal) may depend on or determine a configured timing/delay, sending/receiving of a synchronization signal, sensing of a quiet period, QoS or quality of experience (QoE) information (e.g., of the ranging/location service or e.g. of other traffic), scheduled resources (e.g., semi-persistent resources), DRX/sleep information that may be configured and/or exchanged between the devices, a timing randomization function, signal quality measurements, doppler-shift/coherence time/hysteresis of measured signals, speed of the devices, etc.). The device UE and/or anchor UE(s) 14 perform ranging measurements on the received ranging reference signals (e.g. determine the arrival time of the ranging reference signal(s), measure angle of arrival of the ranging reference signals), and may calculate a distance or angle based on the techniques described earlier or in other embodiments.

In another embodiment, the signal to initiate a ranging session may be sent by an access device or a core network function (such as the location management function 34, and/or the ranging management function 36) to one or more of the UEs involved. In an example, the access device and/or core network function may be aware that two UEs are in vicinity (e.g., because they are both connected to the same access device), so that the access device or core network function may instruct the two UEs to initiate a ranging session, without the UEs having to perform a discovery phase. The access device or core network function may provide the necessary configuration parameters so that each UE knows exactly how to perform the ranging session (e.g., which frequency band or bandwidth to use, which mechanism, which type of signal, (temporary) device or ranging/session identifiers and/or credentials to be used during ranging, etc.), and it may also indicate the exact timing at which each UE is supposed to send a signal and in which order.

Note that any embodiment that describes a device UE 10 discovering and/or performing a ranging session with an anchor device UE 14 can be equivalently replaced with two device UEs 10 discovering and/or performing a ranging session with each other.

### Self-Configuration of an Anchor UE

In a embodiment that can be combined with any other embodiment or implemented independently, the device UE 10 can configure itself as an anchor UE 14 if it detects a lack of anchor UEs 14 in its vicinity and/or if it is entitled to behave as an anchor UE by the managing entity (e.g. based on a set of pre-configured policies) and/or if it has a good coverage of location service (e.g. detecting multiple access devices with good signals strength in vicinity that may transmit position reference signals, stable connection to a core network operated location service (e.g. LMF) via one or more access devices) in its current location and/or has additional means of obtaining location coordinates (e.g., through a built-in GPS module). Upon self-configuration as an anchor UE, the device UE 10 can start advertising the ranging constellation and/or can transmit ranging reference signals. Before self-configuration as an anchor UE, the device UE might request and/or receive authorization to become an anchor UE from the lead anchor UE and/or managing entity, and/or may request/receive anchor UE related configuration information. The self-configuration by a UE to become an anchor UE may be initiated if another device UE 10 (or anchor UE 14) initiates discovery of the UE or initiates a ranging session/procedure with that UE, or when the UE initiates a discovery of another device UE 10 (or anchor UE 14) or initiates a ranging session/procedure with another device UE 10 (or anchor UE 14). If the UE meets the criteria defined by the set of pre-configured policies, it may indicates its role as an anchor UE or its preference to be an anchor UE to the another device UE 10 (or anchor UE 14) when performing discovery or establishing a ranging session.

In an example, a UE itself may determine to become an anchor UE 14, e.g. based on a set of policies, and may report this to the managing entity. To enable this, the UE may be provisioned with policies/criteria (possibly in prioritized order) based on which the UE can decide that it can act as an anchor UE 14 (e.g., is allowed to set an attribute in a discovery, connection setup or ranging session setup message to a value that indicates it is able/enabled to be an anchor UE). Such policies/criteria may include whether or not the UE has the ability to determine its position (e.g. through GNSS), and/or whether or not its position is stable (e.g., with a certain allowable deviation threshold, and/or fluctuating within a sufficiently small (geographical) area), and/or whether or not the UE moves at a fixed speed or a speed fluctuating between minimum and maximum deviation thresholds, and/or whether or not measured signal quality/strength by the UE of positioning/ranging reference signals or signals from an access device are above a minimum threshold, and/or whether or not measured doppler-shift/hysteresis by the UE of positioning/ranging reference signals or signals from an access device (possibly indicated as a scaling factor, expressed in dB, on top of a signal strength/quality threshold, whereby the scaling factor may be different for different (relative) speeds) are within certain thresholds, and/or whether or not it is in coverage of a base station or connected to a certain network (e.g. Home PLMN), and/or whether or not it has a connection with a location/ranging service, and/or whether or not it supports an accurate clock and/or whether or not it is synchronized with a certain reference clock, and/or which ranging mechanisms (e.g. TDOA, Round-Trip Time) it supports, and/or which sensors (e.g., barometric pressure sensor, gyroscope) it supports, and/or how many antennas it has/supports. The configuration of the policies/criteria may be different (e.g. different set of parameters or different values) for different anchor UE capabilities and/or different situations, e.g. whether or not it can act as a proxy for location services e.g. if the UE can support a subset of the LMF's functionality), whether or not it can act as a Position Reference Unit, whether it is in coverage of the network or not, whether unlicensed or licensed spectrum is available/is used, which tracking area/country the UE is in, whether or not it is connected to a visiting PLMN or its home PLMN. After the UE has determined that it can function as an anchor UE 14, it may report this to the managing entity, or may report its role as an anchor UE or its preference to be an anchor UE to the another device UE 10 (or anchor UE 14) when performing discovery or establishing a ranging session/procedure, or during a ranging session/procedure. It may also switch on/off certain ranging related capabilities based on whether one or more of the above mentioned policies/criteria is met, such as its capability to act as proxy for location services.

In an example, a ranging capable UE can determine and/or provide its (desired) role or at least its capability to perform a certain role (e.g. Anchor UE) already during discovery. A Device UE 10 that may not be able to become an Anchor UE 14 itself should be able to limit its discovery to only find other ranging capable UEs that are capable of being an Anchor UE. If it is not clear at time of discovery that a discovered ranging capable UE is an Anchor UE or is capable to be an Anchor UE, it would be waste of time and resources to try to set up a connection and initiate a ranging session/procedure with that discovered ranging capable UE. The desired or possible role(s) of a ranging capable UE, in particular if a ranging capable UE can be an Anchor UE and/or whether or not it is possible/capable to act as a location service proxy, is not static and may change depending on the situation. For example, even if a ranging-capable UE includes a GNSS module in order to get a position fix, it may be out of coverage of the GNSS satellite network (e.g. indoors or in a tunnel), and hence may not be able to be a Anchor UE and/or able to act as a location service proxy. Similarly if the UE is out-of-coverage of the NG-RAN it may not be able to be an Anchor UE and/or be able to act as a location service proxy. Also, the position of a UE may be too unstable to be used as Anchor UE (e.g. UE is moving too fast or shaking too much). To this end, it needs to be considered to configure and apply a policy by which a ranging capable UE can determine its possible role(s). Such policy may be configured by the LMF (or PCF or other core network function). Possible criteria/conditions to consider for a ranging capable UE to switch on/off its role as an Anchor UE and/or switch on/off its ability/feature to provide a location service proxy include:
Whether or not the UE has a position fix (e.g. through GNSS),
Whether or not the UE's position is stable (e.g. UE is stationary or moves at very slow speed or position fluctuates within a small limited area, the limits/thresholds of which may be determined by a set of criteria).
Whether or not the UE is in coverage of a base station,
Whether or not the UE is connected to an LMF.
Whether or not it receives enough positioning/ranging reference signals.
   Similarly, if the ranging capable UE is in coverage of the network and connected to the LMF (or RMF or other managing entity), the LMF (or RMF or other managing entity) may decide the role of the ranging capable UE based on similar criteria/conditions. If the situation changes during a ranging procedure, also the role of a ranging capable UE may change. The other UE(s) involved in the ranging procedure and if in coverage also the LMF (or RMF or other managing entity) need be notified of such role change.

Note that determining whether or not the position of an anchor UE is stable may be done relative to other UEs, e.g. UEs that are part of a constellation (e.g. a device UE 10 or an anchor UE 14). For example, if other UEs are moving in the same direction, e.g. UEs that are present in the same vehicle, the absolute velocity of ranging UE 14 is less important than the relative velocity. To this end, the UE may receive velocity and direction information from one or more device UEs 10 or anchor UEs 14 in vicinity or may receive such information from a location service. The UE may compare the received velocity and direction information, and then based on a (pre-configured) policy (e.g. a policy that indicates a maximum relative speed difference or maximum direction difference) determine if the UE can become an anchor UE 14. Additionally or alternatively, the UE may report its velocity and/or direction information and/or its position to a location service or managing entity (e.g. on another UE), which may determine based on velocity and/or direction information of other UEs whether or not the UE is moving within a maximum relative speed difference or maximum direction difference to a number of other UEs, and if so report to the UE that it can become an anchor UE and/or configure the UE as such. Once the UE has determined it can become an anchor UE or after the UE has become an anchor UE, a managing entity may be informed, and based on this add the UE as an anchor UE to a ranging constellation. The managing entity may configure the UE as an anchor UE (e.g. to configure the ranging reference signals, resource scheduling information, provide information about the constellation if it is capable to act as a proxy for the LMF 34 or RMF 36, etc.), and may update the other UEs in the ranging constellation about the newly added anchor UE (e.g. by sending a new configuration). A UE, e.g., an anchor UE, may indicate by means of a message, e.g., during discovery (e.g. in a message/message field in a model A/B discovery message over PC5), that its location is currently known (e.g. through GNSS), whereby it may indicate a validity time for which this location or its location is expected to remain valid and/or known. This can be useful since the anchor UE may be mobile and therefore its location may not always be stable. Additionally or alternatively, it may indicate a speed and/or direction in a message, e.g., its discovery message or subsequent message after connection setup, between a target UE and an anchor UE.

In other words, a device and method are provided whereby a device UE 10 is configured to support ranging, and is further configured to receive (e.g. from the managing entity) a set of policies/criteria to determine whether or not the device UE 10 can act as a an anchor UE, perform a set of measurements on received RF signals based on which it can determine its position or retrieve its position, and/or based on which it can determine whether or not its position is sufficiently stable according to the set of policies/criteria, and/or based on which it can determine whether or not it is in coverage of an access device, and based on this determination start functioning as an anchor UE 14 and/or initiate procedures to request becoming and/or to get configured as an anchor UE 14.

In a further embodiment that can be combined with any other embodiment or implemented independently, the device UE 10 can stop working as an anchor UE if it detects the presence of multiple anchor UEs 14 in its vicinity (e.g. by performing discovery of ranging devices over sidelink whereby the discovery messages indicate the presence of an anchor UE, e.g. through a field indicating the type of ranging device or through a field indicating a ranging constellation identifier) and/or if it measures a good coverage of location services (e.g. detecting multiple access devices with good signals strength in vicinity that may transmit position reference signals, or having stable connection to a core network operated location service (e.g. LMF) via one or more access devices) in its current location, and/or has additional means of obtaining location coordinates (e.g., through a built-in GPS module).

Thus, it is proposed a method for an apparatus configured to support ranging, the method comprising
the apparatus determining whether or not the apparatus is able to act as a an anchor device based on a set of criteria,
the apparatus performing a set of measurements on received RF signals to determine its position or retrieve its position,
the apparatus determining whether or not its position is sufficiently stable according to the set of policies/criteria, and/or whether or not it is in coverage of an access device, and
the apparatus starting to operate as an anchor device at least based on the determination of the previous step and/or initiating procedures to request becoming and/or to get configured as an anchor device.

In an option, the apparatus stops operating as an anchor device upon determining the presence of a determined number of other anchor devices in its vicinity.

In a further option, the apparatus stops operating as an anchor device upon determining that the coverage of location services is sufficient according to a location quality threshold in its current location.

In another aspect, it is proposed an apparatus configured to support ranging, comprising
a communication unit,
a processor unit coupled to a memory unit, said memory unit comprising instructions for performing the following steps:
the apparatus determining whether or not the apparatus is able to act as a an anchor device based on a set of criteria,
the apparatus performing a set of measurements on received RF signals to determine its position or retrieve its position,
the apparatus determining whether or not its position is sufficiently stable according to the set of policies/criteria, and/or whether or not it is in coverage of an access device, and
the apparatus starting to operate as an anchor device at least based on the determination of the previous step and/or initiating procedures to request becoming and/or to get configured as an anchor device.

In an example, the UE may be configured (e.g. through a set of policies received from a managing entity) to stop working as an anchor UE 14 if it detects the presence of multiple anchor UEs 14 in its vicinity and/or if it measures a good coverage of location service in its current location and/or if it determines that at least a certain number of criteria (e.g., one or some of the above criteria based on which it decided to act as an anchor UE) are not met anymore. Once the UE has determined it can stop being an anchor UE or it may change its role, e.g. as expressed during discovery in a field expressing the role of each UE for ranging/positioning, from being an anchor UE that can determine its position (e.g. Located UE) an anchor UE that cannot determine its position (e.g. Reference UE), or may indicate during discovery that its location data is not stable or that one or more of its location determination capability (e.g. GNSS) is (temporarily) not available, and/or after the UE has stopped being an anchor UE or its role has changed, a managing entity may be informed, and based on this remove the UE from a ranging constellation. The managing entity may update the other UEs in the ranging constellation about the removed UE (e.g. by sending a new configuration) or changed role of the UE.

In other words, a device and method are provided whereby an anchor UE 14 is configured to detect the presence of multiple anchor UEs 14 in its vicinity and/or determine its position by connecting to a location service and/or through other means (e.g. through a built-in GPS module), and based on the detecting of multiple anchor UEs or the determination of its position stop functioning as an anchor UE 14 and/or initiate procedures to request to stop being an anchor UE 14.

In a further embodiment that can be combined with any other embodiment or implemented independently, a UE of a ranging constellation (e.g. device UE 10 or anchor UE 14) may be configured with a policy (e.g. by the managing entity) that determines the conditions/criteria/thresholds when to leave a constellation, e.g. when a measured distance between the UE and one or more other UEs in a constellation has gone beyond a maximum distance, or when a measured distance between the UE and one or more UEs in another constellation has gone below a minimum distance, or when the UE has discovered (over sidelink) a minimum number of UEs of another constellation or when a measured signal strength/quality (e.g. on sidelink or on the Uu interface) has dropped below a certain minimum signal strength/quality threshold, or when the number of discoverable devices (e.g. over sidelink) has dropped below a minimum number, or when the battery has dropped below a certain level, etc. Once the UE determines that it meets one or more of the above mentioned criteria/thresholds as configured by a policy, the UE may notify a managing entity about leaving a constellation (whereby the UE may indicate a constellation identifier in the notification message), or may request a managing entity to leave a constellation (whereby the UE may indicate a constellation identifier in the request and/or may include information about the UE's current conditions (e.g. its current position, its current distance from one or more UEs of the constellation, number of discovered devices (possibly including their identities), which thresholds are exceeded, etc.), or may request to join another constellation (whereby the UE may indicate a discovered constellation identifier or a set of identifiers of discovered UEs over sidelink in the request), or may inform other UEs in its current ranging constellation over sidelink that it is leaving the constellation. The managing entity may send a message as a response to a request to leave the constellation or a request to join another constellation that may include a confirmation or disapproval of the UE leaving the constellation or the UE joining another constellation, and/or may configure the UE accordingly, and/or may update the other UEs in the ranging constellation about the removed UE (e.g. by sending a new configuration).

In other words, a device and method are provided whereby a device UE 10 or anchor UE of a ranging constellation is configured to receive (e.g. from the managing entity) a set of policies to determine conditions/criteria/thresholds when to leave a constellation, perform a set of ranging measurements with one or more UEs of the ranging constellation, or with one or more UEs of another ranging constellation, and/or perform discovery (over sidelink) of ranging capable devices, and/or perform measurements on one or more RF signals received over sidelink or the Uu interface, determine whether or not a measured distance is below or above a certain threshold and/or whether or not a number of discovered UEs is above or below a certain minimum value, and based on this determination leave the ranging constellation or joining another ranging constellation.

Before self-configuration, the anchor UE might inform the lead anchor UE and/or managing entity and receive its authorization. The anchor UE might take this decision to stop working as an anchor UE based on a policy configured in the anchor UE by the lead anchor UE or by the managing entity.

In a further embodiment that can be combined with any other embodiment or implemented independently, related to autoconfiguration of a UE as an anchor UE 14, a device UE 10 determines if it detects only a small number of positioning reference signals either from network access devices 20 (e.g., gNBs) or other anchor UEs 14 or the RSRP of a reference signal is under a predetermined threshold at the position of the device UE 10. If so, the device UE 10 may decide to configure itself as an anchor UE 14 and start sending positioning/ranging reference signals. It is noted that the device UE 10 may have been configured by the managing entity with a capability of being allowed of configuring itself as an anchor UE 14. This decision may be based on a policy deployed by the managing entity.

In other words, a device and method are provided whereby a device UE 10 is configured to support ranging, and is further configured to receive (e.g. from a managing entity) a set of policies/criteria based on which the device UE 10 can determine that it can act as a an anchor UE, perform a set of measurements on received RF signals based on which it can determine or retrieve its position, and based on which it can determine whether or not the number of positioning reference signals from network access devices 20 or other anchor UEs 14 or the RSRP of such reference signals is under a predetermined threshold based on the set of policies/criteria, and based on which it can determine whether or not it is in coverage of an access device, and based on this determination start functioning as an anchor UE 14 and/or initiate procedures to request becoming and/or to get configured as an anchor UE 14.

### Switch to Local Location/Ranging Service Proxy

In another embodiment that can be combined with any other embodiment or implemented independently, the device UE 10 can determine (when and how) to obtain its location coordinates from a location service or from a ranging service based on ranging measurements, wherein one or more UEs in the ranging constellation 50 can act as a proxy for the location service and/or ranging service e.g. in a given geographical area e.g. by supporting similar protocols (e.g. LPP or NRPPa) and (a subset of the) functions provided by a location service or ranging service (e.g. determine a distance/angle/position based on location/ranging measurements, providing a location/coordinate in a reference coordinate system based on a set of distances and/or angles and/or other relevant location information). The device UE 10 may automatically turn off its use of location services provided by the core network/access device (e.g. terminate its connection to an LMF 34) if it discovers that the ranging constellation 50 of ranging capable anchor UEs 14 offers location coordinates, operates a location/ranging service, and/or acts as a proxy for the location/ranging service in the vicinity, and/or if it determines a poor signal coverage of access devices in a given geographical area (which would prevent proper/efficient own use of location services), and/or if it enters a certain tracking area or gets in vicinity of a particular access device, and/or if it meets a set of conditions defined by a preconfigured policy (e.g. if it can discover a certain minimum number of anchor UEs), and/or may turn off its use of location services provided by the core network/access device if it receives an explicit signal from an anchor UE, location/ranging service or managing entity.

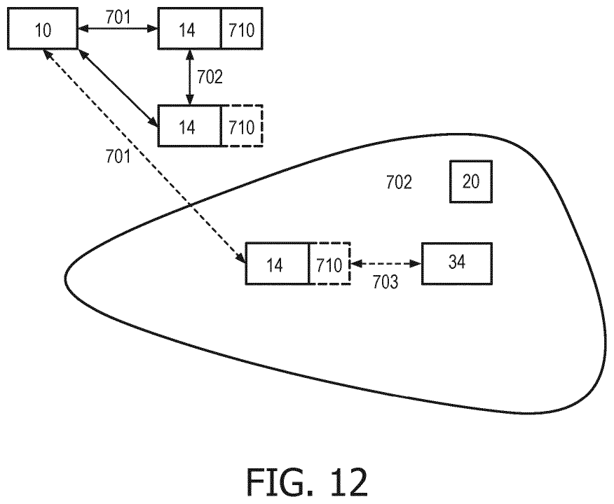

FIG. 12 shows an example conceptual architecture according to an embodiment, whereby one or more Anchor UEs may act as a proxy for a location/ranging service by support a subset of LMF functionality 710 (e.g. the ability to collect ranging/location measurements, calculate a position of a device UE 10 or Anchor UE 14, or share the position with other entities (incl. device UE 10 or Anchor UE 14)). The Anchor UE may announce/provide information about such ability to act as a proxy for a location/ranging service over sidelink/PC5 (e.g. during discovery) 701 to a Device UE 10. Also a Device UE 10 may specifically provide a request/filter in it's discovery request messages over 701 to only discover Anchor UEs that are able to act as a proxy for a location/ranging service. If multiple Anchor UEs work together, e.g. as part of a constellation, not all Anchor UEs need to support such subset of LMF functionality. The other Anchor UEs may provide their measurement reports (e.g. ranging/position measurements) or distance/angle measurements over sidelink/PC5 702 (e.g. over a direct connection) to the Anchor UE that supports a subset of LMF functionality 710. Similarly, the Device UE 10 may need to provide its measurement reports (e.g. ranging/position measurements) or distance/angle measurements to the Anchor UE that supports the subset of LMF functionality. That Anchor UE may then calculate a position of the Device UE 10 and provide it to Device UE 10 over 701. In this manner, the position of the Device UE 10 can be determined even when one or more Anchor UEs are out of coverage of an access device 20. In FIG. 8 the coverage area of access device 20 is depicted as 720. An Anchor UE that is in coverage 720 of the access device 20 may still offer a local proxy using the subset of LMF functionality 710, but may also switch off (part of) its local proxy functionality and interact with the LMF in the core network instead whereby it may forward messages/information from the out-of-coverage device UE 10 or Anchor UE(s) 14 to the LMF in the core network, and vice versa. To this end it may implement a (subset of) ProSe relay functions and/or provide a gateway function for repackaging or translating incoming LPP messages coming from the AMF or coming over TCP/IP from a managing entity onto PC5/Sidelink messages (e.g. PC5-Signalling messages with LPP payload) and vice-versa. By acting as a gateway or ProSe Relay, the Anchor UE may also provide indirect communication between the other core network functions, such as the Authentication Server Function (AUSF) or ProSe Key Management Function to enable the Device UE 10 exchange authentication and authorization information with the core network to verify if the Device UE 10 and/or Anchor UE 14 are authorized to be involved in ranging of Device UE 10, or for example to forward a Mobile Originated Location Request (MO-LR) (which may include a request and/or information related to ranging such as a discovered Anchor UE or information about a ranging constellation) from Device UE 10 to the AMF/GMLC/LMF or to forward a Mobile Terminated Location Request (MT-LR) (which may include a request and/or information related to ranging such as a information about a ranging constellation or ranging configuration information) from the AMF/GMLC/LMF to Device UE 10.

In a further embodiment that can be combined with any other embodiment or implemented independently, the device UE 10 can be self-configured or be configured by the managing entity to use ranging services within a given geographical area (e.g., inside a building) and to use location services outside the given geographical area (e.g., outside the building). The ranging measurements may be sent to the RMF 36 and/or the LMF 34 and/or another location/ranging service, or proxy thereof to translate the ranging measurements into geographical or relative location coordinates. The measurements may be sent by the device UE 10 and/or by an anchor UE 14 of the particular ranging constellation 50 and/or by a head anchor UE of the ranging constellation 50. The ranging measurements between the device UE 10 and multiple anchor UEs 14 in the vicinity may be sent separately or may be combined in a single report forwarded to the RMF 36 and/or the LMF 34 or another location and/or the ranging service, or proxy thereof. To this end, the UEs involved may send their measurements and/or estimated distances/angles between itself and one or more other UEs of the ranging constellation to the head anchor UE. If one or more anchor UEs are out of coverage, another (head) anchor UE that is in coverage may also act as a proxy for the RMF, LMF or other location service or ranging service. In this case, the in-coverage UE may send the measurements or the report. When the entire constellation including the head anchor UE is out of coverage, then the head anchor UE may act as a proxy for certain functions (e.g., a subset of functions) of the RMF and/or LMF or other location service and/or ranging service. These functions may include translation of distance and/or time and/or angle measurements to location coordinates, calibration of ranging measurements, temporary storage of measurements until a communication link with an access device is restored, etc.

Alternatively or additionally, the ranging measurements can be securely shared by the ranging service, location service, RMF 36 or LMF 34 to an application function 40 (e.g. a third-party application) via the NEF 38 to calculate the location coordinates of the device UE 10, upon authorization by the user of the device.

In an embodiment related to a switching to ranging services or ranging-based positioning services, the managing entity can track the locations at which there are a sufficient number of ranging capable devices (e.g., configured with their current location or having an active location service) that together may constitute a ranging-assisted constellation (e.g., ranging constellation 50) and that can act as a proxy for a location service in a given geographical area. The managing entity may use this information to declare a set of ranging capable device to constitute a ranging constellation 50 and/or configure the devices (e.g. anchor UEs 14) accordingly with the necessary parameters (as described in other embodiments). The managing entity may also configure a set of devices UE 10 with information about the ranging constellation 50 (e.g. constellation identity, number of anchor UEs, area information, frequency/resources to use, etc.). This may also include information (e.g. in the form of a policy) that associates the use of ranging services with location/geographical area information/tracking area/registration area/cell ID/Synchronization Signal Block (SSB) index. A device UE 10, upon entering this geographical area, may configure itself or be configured by the managing entity to use a ranging service within a given geographical area (e.g., based on (discovered/configured) information about one or more ranging constellations within the area). To this end, the device UE 10 may use policy information (e.g., received from the managing entity) that associates the use of ranging services with location/geographical area information/tracking area/registration area/cell ID/Synchronization Signal Block (SSB) index). The device UE 10 may use tracking area information/cell ID/SSB information received from an access device, relay device or a discovered ranging capable device and correlate this with the policy information to determine whether ranging should be enabled or not and/or which constellation and/or which anchor UEs 14 to use. In an example, the managing entity might advertise the presence and the type of ranging or ranging-based location services in a given geographic area by requesting wireless access devices to include ranging information in a SIB, e.g., SIB1 broadcasted by a wireless access device located in that geographic area. The wireless access devices broadcast the existence of ranging or ranging-based location services in its area by broadcasting such SIB. Upon reception of the SIB, a device UE 10 is aware of the presence of ranging services and might proceed to activate sidelink to access to or to provide the ranging ranging-based location services.

In an embodiment, the device UE 10 may be configured with a list of approved constellation identifiers and/or anchor UEs 14 it can select for ranging and/or connect to in order to initiate ranging, and possibly credential information to allow secure communication setup with the devices of the constellation respectively the anchor UEs 14. This list may be prioritized. Alternatively or additionally, the device UE 10 may be configured with policies that specify a minimum number of anchor UEs 14 and/or requirements on the capabilities and/or characteristics of the anchor UEs 14 (such as their (relative) movement being below/within certain threshold values, minimum/maximum distance from device UE 10, signal strength thresholds, geographical area information, tracking area or cell information, PLMN information) within a constellation and/or that can be discovered in the vicinity of device UE 10, to determine whether or not the device UE 10 should switch on ranging or initiate a ranging session or to determine which constellation/set of anchor UEs to select/connect to for ranging. The device UE 10 may also use its estimated position based on other means (e.g., GPS, Wi-Fi, or dead reckoning based trajectory interpolation based on e.g. built-in accelerometer) to determine if ranging services should be used.

Once the device UE 10 has determined to use ranging services, it may switch on discovery of other ranging capable UEs in its vicinity and/or may connect (directly via Uu or via a relay device) to a ranging service or location service provided by the network (e.g. provided or managed by LMF 34 or RMF 36) which may further instruct/configure the device UE 10. Alternatively, discovery of other ranging capable UEs is always switched on, and the determination to use ranging can be based on discovered information from the other ranging capable UEs (e.g., whether or not the discovered UEs are anchor UEs or based on (discovered/configured) information about one or more ranging constellations within the area, e.g., based on a constellation identity discovered via one of the ranging capable UEs, or discovering the presence of one or more UEs that constitute a ranging/positioning constellation).

The UE 10 may still use other existing positioning services.

Similarly, the anchor UEs 14 may be configured by the managing entity or may configure themselves to switch on ranging/ranging services (e.g., start transmitting and/or receiving discovery messages and/or initiate a ranging session) upon entering a geographical area or upon a device UE 10 entering the area. Note that each time a device UE 10 or anchor UE 14 enters a new area or comes in vicinity of a new ranging constellation, it may need to request or may have to receive a new/fresh authorization and/or obtain a new/fresh set of credentials from the core network/access device/RMF/LMF/(head) anchor UE through a Uu direct connection or PC5 direct/indirect connection before or upon establishing a new ranging session or joining the new ranging constellation.

In a related embodiment, the managing entity may be configured to automatically reconfigure the device UE 10 to connect to location services for obtaining location coordinates when the device UE 10 is leaving the given geographical area. The device UE 10 might also reconfigure itself (e.g., based on a policy that associates the use of positioning services based on location/geographical area information/tracking area/registration area/cell ID/Synchronization Signal Block (SSB) index).

Alternatively, the managing entity may automatically turn on or off the ranging and location services depending on the latest known location of the device UE 10.

The device UE 10 may automatically turn off the location service (e.g. terminate its connection to an LMF 34) by itself upon discovering a constellation (e.g., ranging constellation 50) of ranging capable UEs in the vicinity that can offer location coordinates as a result of ranging measurements either directly or by translating the ranging measurements to location coordinates via a location service known to the constellation of ranging capable UEs.

In another/independent embodiment related to the switching to ranging services or ranging-based positioning services, the device UE 10, upon temporarily disconnecting from the LMF 34 or other location service offered by the core network, e.g., when out of range, can automatically turn on the ranging services and search for nearby ranging-capable anchor UEs 14 and/or a constellation (e.g., ranging constellation 50). To this end, the device UE 10 may be configured with a policy determining the conditions to do so, e.g. minimum/maximum signal strength (e.g., RSRP) or other signal quality parameters (e.g., RSRQ, number of failed connection attempts) for signals received from nearby access devices, below/above which to switch on or switch off its usage of ranging and/or positioning service.

### Discovery and Requesting the Use of a Ranging Constellation

In an embodiment, an anchor UE that offers a ranging service and/or location service (e.g., a ranging based positioning service or proxy thereof) may offer a ProSe/V2X/D2D service to access such ranging and/or location service over sidelink, e.g. to be able to acquire/provide position information or to initiate ranging. Such ProSe service may be announced through sidelink discovery through a specific ProSe/V2X/D2D service identifier or application code, after which other UEs may set up a connection over sidelink to such service and use such service. The LMF 34, RMF 36 or other ranging service and/or location service or other managing entity may provide credentials that allow and/or that can be used for protecting the discovery and/or message exchange between the ranging capable device UE 10 and the anchor UE(s) 40.

In a further embodiment, the device UE 10 may be configured to obtain or request its location coordinates based on ranging measurements from one or more of the anchor UEs 14 of the ranging constellation 50. An anchor UE 14 may advertise ranging reference signals (which may be detected by a device UE 10 in vicinity, e.g., based on their frequency, timing, signal characteristics/type, waveform, bandwidth, configured resources), or advertise ranging-based positioning (combining ranging and location service functionality) as a proximity service or advertise support for ranging/location services and/or other ranging/position capabilities and/or provide information about its (last known) location, or transmit discovery messages in a configurable time interval known to a ranging service and/or configured on the UEs involved (e.g., by a managing entity) for the particular ranging constellation 50 with which the anchor UE 14 is affiliated. Thereby, the device UE 10 may identify and may check the integrity of the advertisement/discovery messages, may determine the arrival time of the advertisement/discovery message, and may extract, e.g., timing information (e.g. time of transmission of the advertisement/discovery message included in the message, processing time of a message for which this message is a response (e.g. t3−t2 in case of FTM), time between reception of a message for which this message is a response, clock synchronization information) from the messages to calculate the distance between the device UE 10 and one or more of the anchor UE(s) 14 of the ranging constellation. Furthermore, the device UE 10 may calculate a confined area which approximates its location coordinates, based on e.g. one or more distance(s) obtained from round-trip-time measurement(s) and/or time-of-flight estimation(s) between the device UE 10 and the one or more anchor UE(s) 14. Moreover, the device UE 10 may receive a list of authorized anchor UEs 14 in its vicinity via the RMF 36 or LMF 34 or managing entity and, upon approaching an authorized anchor UE 14 within its ranging distance, e.g. after it discovers such authorized anchor UE, connects to it and/or requests the use of a ranging/location service or service proxy offered by such anchor UE, the device UE 10 may obtain location coordinates (e.g., calculated coordinates of device UE 10, location coordinates of the anchor UE 14 and/or the location coordinates of one or more access devices or Position Reference Units) and/or an estimated relative position/distance/angle between one or more devices of the constellation from the anchor UE 14 without using RMF 36 or LMF 34 or any other location service of the core network 30 (e.g., network controller device). In this case, the anchor UE 14 might measure the distance and/or angle between itself and the device UE 10 using the ranging procedure/service and translate the distance into location coordinates based on its current location coordinates, locally on the device. Alternatively, the device UE 10 may measure the distance and/or angle using the ranging procedure/service and forward it to the anchor UE 14 to request for translating the measured distance into geographical coordinates.

In another embodiment, the anchor UE 14 may provide its geographical coordinates to device UE 10, which the device UE 10 can use after measuring the distance and/or angle between itself and the anchor UE 14. Transmitting the geographical coordinates of anchor UE 14 should be done in a secure manner in terms of integrity and/or confidentiality, hence the anchor UE may only provide its coordinates after a secure communication channel between device UE 10 and anchor UE 14 has been established and/or sends the geographical coordinates protected by a key that only allows device UE 10 or a set of authorized devices UE 10 to decrypt this information and/or that allows device UE 10 or a set of authorized devices UE 10 to verify the integrity (by means of a message integrity code or a digital signature) of the information.

In an embodiment, instead of transmitting information about the location (e.g. geographical coordinates) of an anchor UE 14 to device UE 10 or to another anchor UE, the anchor UE 14 may transmit an identifier (e.g., a location identifier, which may e.g. be preconfigured/allocated by a location service/database to the anchor UE or self-allocated) to the device UE 10 or the other anchor UE (e.g., in a discovery message, connection setup message, PC5 signalling message, or user plane message (e.g. message over IP layer)), possibly together with an identifier or address of a location service/database, which can be used by the device UE 10 or the other anchor UE that receives this identifier to retrieve the location coordinates of the anchor UE through a secure connection with a location service/database (e.g., as identified by the optionally provided location/database identifier or address, or a default location service/database known to the UE or the Core Network to which the UE connects). To enable this, the anchor UE (e.g. as configured/authorized by its user or a managing entity) or the anchor UE on behalf of the managing entity or the managing entity on behalf of the anchor UE may grant permission to retrieve the location of the anchor UE by doing one (or more) of the following:
by providing authorization credentials (e.g., an authorization token) to the device UE 10 or the other anchor UE that can be used to authenticate/verify the authorization (i.e., provided by the connected anchor UE 14) is authentic, e.g. by performing an authentication procedure with the respective anchor UE 14, or by verifying if the credentials match or can be securely correlated to previously stored credentials of anchor UE 14 in device UE 10, the other anchor UE or the LMF 34, RMF 36 or other location and/or ranging service or a proxy thereof or other managing entity, or a core network function (e.g., UDM/AUSF) that device UE 10 or the other anchor UE can connect to. The anchor UE may register the given consent to a particular device UE 10 or the other anchor UE or provide a copy of the authorization credentials (e.g. authorization token) given to device UE 10 or the other anchor UE to the LMF 34, RMF 36 or other location and/or ranging service or a proxy thereof or other managing entity, or other core network function (e.g., UDM/AUSF). The device UE 10 or the other anchor UE can include the provided authorization credentials/token in a message request to the LMF 34, RMF 36 or other location and/or ranging service or a proxy thereof or other managing entity or anchor UE 14, after which the receiving entity may verify the authorization credentials/token to be genuine, and if so provide the location of the anchor UE 14 to device UE 10 or the other anchor UE.
by providing authorization message/credentials to the respective LMF 34, RMF 36 or other location service or ranging service or proxy thereof, or other managing entity, or location database, whereby the message/credentials can be verified to originate from the respective anchor UE (e.g., performing an authentication procedure with the respective anchor UE 14), or by verifying if the credentials match or can be securely correlated to previously stored/credentials of the anchor UE 14 in the LMF 34, RMF 36 or other location and/or ranging service or proxy thereof, or other managing entity, or a core network function (e.g., UDM/AUSF). Such authorization message may include some fields/payload containing information about the given consent, e.g. the validity period, to which UEs (e.g. set of identities) the consent is given, information about credentials or token that would have to be provided by a given UE before it can be given the anchor UE's location). The authorization message may be sent by the Anchor UE 10 upon registration to the network, or upon receiving a ranging request (e.g. a device UE 10 connecting to the anchor UE 14 and requesting use of the ranging service), or e.g. first time it connects to the LMF 34, RMF 36 or other location and/or ranging service or proxy thereof, or other managing entity, or may be sent in response to the LMF 34, RMF 36 or other location service or ranging service or proxy thereof, or other managing entity, that has sent a message requesting permission to the anchor UE to share its location with device UE 10. In case group/domain credentials or authorization tokens or a closed access group or NPN or (private) network slice are/is associated with a ranging constellation that are used to protect the communication between UEs of a ranging constellation and/or to restrict the communication only between UEs belonging to that group/domain/closed access group/NPN/slice, the anchor UE may only need to provide consent once for all UEs of a ranging constellation (e.g. by including the ranging constellation id and/or group/domain credentials and/or closed access group or NPN or (private) network slice information with which the consent will be associated in a message that the anchor UE sends to the LMF 34, RMF 36 or other location and/or ranging service or proxy thereof, or other managing entity). For example, this may be done during a message exchange when the Anchor UE joins the ranging constellation. The consent may also be provided by an application that manages (through the NEF) the ranging constellation and/or the UEs involved, e.g. by providing this implicitly or explicitly in the ranging constellation configuration information that it may send to the LMF or other managing entity. The consent may also be stored in the UDM or GMLC (typically in the home network of the Target UE), which may be verified e.g. by the AMF or other core network function.
by granting permission for this by providing consent in its subscription (e.g., UDM), or through providing consent through the Network Exposure Function (NEF) (e.g. by an application that manages the respective anchor UE). Note that the consent provided in the subscription or provided through the NEF may be configured per ranging constellation or per group/domain/closed access group/NPN/(private) network slice that may be associated with a ranging constellation.

In a further embodiment, the device UE 10 may calculate its location coordinates based on ranging reference signals obtained from one or more anchor UEs 14 via a sidelink channel (e.g., through sidelink discovery messages or other signals transmitted using sidelink resources), and position information of the one or more anchor UEs 14. To this end, the device UE 10 and the one or more anchor UEs 14 may exchange messages to initiate a ranging session. One or more of these messages may include a ranging session ID (which may be used by all UEs involved in joining the ranging session) and/or may include a ranging constellation identity and/or may include ranging reference signals. The ranging reference signals may include (encoded) information about the type of reference signal, identity information of a UE, ranging session ID, ranging constellation identity, identity information of the constellation, credential information, nonces, timing information, and/or distance/angle/position information.

In a further embodiment, if a device UE 10 wants to initiate ranging with two or more anchor UEs it may indicate the number of anchor UEs and/or a set of anchor UE identifiers and/or a constellation identifier as part of the messages to initiate a ranging session (e.g. a Direct Communication Request with a field indicating a request for ranging service (using e.g. an application or service identifier defined for this)). These messages may be sent as multicast/broadcast messages to all anchor UEs involved upon which the anchor UEs initiate ranging with device UE 10, and/or send device UE 10 the respective configuration parameters for ranging., or may be sent via unicast message to one of the anchor UEs (e.g., the head anchor UE), upon which the anchor UE that receives this unicast message will send respective messages to other anchor UEs within the constellation or in vicinity to invite them become part of the ranging session and/or to initiate ranging with device UE 10, and/or to send them the respective configuration parameters for ranging.

In a further embodiment, the location coordinates of the anchor UEs 14 may be exchanged with the device UE 10 via the sidelink channel and the calculation of the position may be done after the device UE 10 has (simultaneously) achieved a clock time synchronization with those anchor UEs 14 and/or after being connected to one or more anchor UEs 14. By using Time Difference of Arrival, Round Trip Time and/or Time of Flight measurements based on the ranging reference signals, the distances between the device UE 10 and the one or more anchor UEs 14 can be calculated and may be exchanged between the device UE 10 and the one or more anchor UEs 14 (e.g. over the established connection between device UE 10 and the one or more anchor UEs 14). Also, the angle may be determined if the device UE 10 or anchor UE 14 has multiple antennas. Assuming the device UE 10 and the one or more anchor UEs 14 are in the same horizontal plane (i.e., are at similar altitude) and that the distance and/or angle between the anchor UEs 14 is known or can be calculated (e.g., based on the geographical coordinates of the anchor UEs 14 and/or distance/angle measurements performed between two or more anchor UEs 14, the results of which may be shared with the device UE 10 and/or a ranging/location service), the position of the device UE 10 can be estimated based on trilateration and/or triangulation by using the distance measurements between the device UE 10 and at least two anchor UEs 14 (and the information about the known or calculated distance and/or angle between the anchor UEs, and/or the location coordinates of anchor UEs 14) or the distance and angle measurement between the device UE 10 and at least one anchor UE 14 (and the information about known or calculated distance and/or angle between the anchor UEs, and/or the location coordinates of anchor UEs 14).

In order to deal with possible altitude differences between UEs in the ranging constellation, the device UE 10 may require a distance and/or angle measurement with an additional anchor UE as additional reference.

### Using Non-RF Sensors

According to an embodiment that can be combined with any other embodiment or implemented independently, the device UE 10 may have other means to determine a relative altitude (i.e. as difference to a known reference altitude) or absolute (i.e. as difference to sea level) altitude such as a barometric pressure sensor. If an anchor UE 14 knows its altitude (e.g. above sea level or a certain horizontal plane) for example as determined by a barometric pressure sensor or by a GNSS, the anchor UE 14 may transmit information about its altitude (e.g. in the form of a z-axis coordinate (e.g. 3D coordinate or z-axis value), meters above sea level or a certain horizontal reference plane, or as barometric pressure value) to the device UE 10, which may use this in calculating possible difference in altitude between the device UE 10 and the respective anchor UE 14. Alternatively, the device UE 10 may share information about its altitude to the anchor UE 14 and/or ranging/location service for calculating the altitude difference. Once the altitude difference is calculated/estimated, this value may be used in subsequent (3D) location coordinate calculations to estimate the location of the device UE 10 including its altitude, taking into account the determined altitude difference(s) between the device UE and one or more anchor UE(s) 14. Similarly, calculating positions may also involve using other sensing information gathered by the target mobile device (or anchor device), e.g. a magnetic sensor (e.g. magnetometer) that gives information about the angle of the target mobile device (e.g., a UAV) or a sonar sensor that gives information about the altitude of the target UE (e.g., a UAV) in reference to the ground, or a non-RF sensor to provide additional means to measure the distance (e.g. using ultrasound). In other words, the apparatus (e.g. anchor UE 14 offering a ranging/location service, or the RMF 36 or LMF 34) to calculate the position of a target mobile device (e.g. device 10) may be adapted to calculate location coordinates of the target mobile device based on ranging reference signals obtained from one or more anchor devices of the ranging constellation via a sidelink channel and sensing information gathered by the target mobile device or anchor UEs and provided as input to the apparatus for calculating the positioning of the target mobile device. Additionally or independently, if the device UE 10 or anchor UE have a means to determine an x-axis coordinate value or y-axis coordinate value (e.g. in relation to a pre-configured reference plane and/or coordinate system), it may transmit such value to the apparatus to calculate the position of the target mobile device.

In an embodiment, a device UE 10 requiring ranging over sidelink/PC5 as well as a supporting anchor UE 14 may be configured to operate ranging by means of non-RF sensors (e.g. ultrasound sensors) and/or may be configured to exchange capabilities/configuration related to the ranging capabilities enabled by means of non-RF ranging sensors, e.g., ultrasound sensors. In particular, a device UE 10 or anchor UE 14 may be capable to act as an ultrasound source, e.g., using a speaker, or as an ultrasound receiver, e.g., using a microphone.

In an embodiment related to the previous one, the device UE 10 requiring ranging over sidelink/PC5 interface as well as the anchor UEs 14 supporting the ranging operation may rely on “non-sidelink ranging reference signals” that are not exchanged over sidelink/PC5 interface, but whose parameters are configured or announced over sidelink/PC5 interface. In particular, the “non-sidelink ranging reference signals” may refer to an ultrasound signal generated by, e.g., the device UE 10 or an anchor UE 14 and received by the anchor UE 14 or device UE 10, respectively. In particular, parameters of an ultrasound signal may include the frequency of the ultrasound signal, e.g., 40 Khz, the timing (starting time) of the ultrasound signal, or an identifier, e.g., a modulation of the ultrasound signal.

In a related embodiment, a device UE 10 may act as an announcing UE and send discovery messages (e.g., sporadically or in a regular manner) that are received by anchor UEs 14 acting as monitoring UEs. The discovery messages sent by the device UE 10 may include a timing or identifier of the “non-sidelink ranging reference signals”, e.g., a given delay with regard to the transmitted discovery message. The discovery message may also include a temperature/humidity a measured by the device UE 10, since those are some factors affecting the speed of sound in the air. At least one anchor UE 14 (monitoring) in a ranging constellation 50 may receive the discovery message and may learn the parameters of the “non-sidelink ranging reference signals” and may measure afterwards the “non-sidelink ranging reference signals” obtaining a ranging measurement with the device UE 10.

The usage of such “non-sidelink ranging reference signals”, e.g., ultrasound signals, can have multiple advantages including accurate ranging measurements because of the lower speed of sound through the air compared with the very fast propagation of messages through sidelink/PC5. For instance, in above embodiment, assuming the device UE 10 and the anchor UE 14 are 10 m away from each other, the transmission of the discovery message has a delay of ⅓ *10\hat{ }(−7)s. Assuming a clock synchronization error of ⅓*10\hat{ }(−6) and both the device UE 10 and the anchor UE 14 use a speed of sound of 340 m/s when the actual one is 339 m/s, then the ranging measurement result is 9,97 m.

### Licensed/Unlicensed Spectrum

In an embodiment that can be combined with any other embodiment or implemented independently, a device UE 10 or anchor UE 14 may also have policies to determine if for a particular location/geographical area information/tracking area/registration area/cell ID/Synchronization Signal Block (SSB) index licensed or unlicensed spectrum can be used or needs to be used (and may also include information about preferred frequencies/bands, bandwidth, etc.). An additional criterium of whether licensed or unlicensed spectrum can/needs to be used, and that may also be part of the policy information, is whether the device UE 10 and/or anchor UE 14 are in coverage of an access device or out of coverage. If both UEs are in coverage, then usually it will be allowed to use licensed and unlicensed spectrum, and if both UEs are out-of-coverage, then it is usually only allowed to use unlicensed spectrum, given that the mobile network operator would like to control the use of its licensed spectrum. A particular situation is when one UE involved in a ranging session (e.g., the device UE 10) is out of coverage, and another UE involved in the ranging session (e.g., the anchor UE 14) is in coverage. Also, this situation may change as the UEs may be moving. Hence, it is important that the UEs involved in ranging can inform each other beforehand (e.g., via a core network function) and/or during discovery, connection setup, initiating a ranging session and/or whilst performing the ranging procedure of their coverage status. A UE may determine whether or not it is out of coverage based on some (pre-configured) thresholds on signal quality/signal strength. If the signal quality/strength is below a certain threshold the UE is considered to be out of coverage. A UE (UE 1) may expose its coverage status (e.g., whether it is in coverage or not) as a field within a transmitted discovery message or a synchronization signal such as Sidelink Synchronization Signal (e.g., with a boolean value to indicate if it is in network coverage or not, or through exposing some signal quality/strength values/levels measured by UE1 (e.g. related to a set of access devices 20), or through exposing or not exposing cell-ID information received from nearby access devices 20), or by sending a discovery response message or synchronization signal on a different (e.g. unlicensed) frequency band than a discovery request message or a synchronization signal transmitted by another UE (UE 2). If the receiving UE (UE 2) receives a discovery message or synchronization signal indicating that the other UE (UE 1) is out-of-coverage it may be configured/required/instructed to use unlicensed radio spectrum resources instead of licensed resources to set up a subsequent connection to initiate a ranging session or to perform ranging using ranging reference signals. The UE receiving the discovery message or synchronization signal may be preconfigured (e.g., through a policy) whether or not it can make an exception to connect with licensed resources instead, if the UE receiving the discovery message or synchronization signal itself is within coverage of the network. Such pre-configuration/policy may also define a distance or area information that may indicate a maximum allowed displacement between the UE receiving the discovery messages or synchronization signal and the UE transmitting the discovery message or synchronization signal to occur within which it is allowed to use licensed spectrum, and outside of which unlicensed spectrum needs to be used. The UE receiving the discovery message or synchronization signal may be configured/required to limit its transmit power for subsequent signals that it transmits on licensed spectrum in order to prevent the signals to travel beyond the maximum allowed distance. If the receiving UE can determine its own position within the preconfigured area information, it may be configured/required to limit its transmit power for subsequent signals that it transmits on licensed spectrum in order to prevent the signals to travel beyond the allowed area. Similarly, during subsequent message exchanges for connection setup, initiating a ranging session or to perform ranging using ranging reference signals, each UE may transmit information about its coverage status using an attribute within one of those messages, or as a separate message (e.g., a MAC Control Element that may be concatenated to one of those messages). If a change occurs in the coverage status during these procedures, the UEs involved need to switch their use of frequency/bands used. For example, if the UEs were initially communicating over licensed bands, they may be configured/required/instructed to switch to use unlicensed bands instead. To this end a configuration change procedure may need to be performed in which at least one of the UEs informs the other UE(s) to switch to another band to continue the procedures by indicating a new frequency and/or an updated coverage status in a message transmitted to the other UE(s). Instead of having a message exchange to determine a new frequency to be used, the UEs involved may also be configured with a default/fall-back frequency on which to continue the procedures if the UE receives an update to the coverage status of the other UE. Alternatively, the UEs involved may be configured with a time interval during which they may be exempted from switching frequency bands, e.g. for a certain amount of seconds or until (a part of, e.g. a certain burst of ranging reference signals) the ranging procedure is finished. The UEs may also be configured with a maximum distance within which it is allowed to continue licensed spectrum and outside of which unlicensed spectrum needs to be used. The UEs may use the ranging results obtained thus far to determine that the distance is within the limits to continue to use licensed spectrum or determine that it is outside the limits and hence need to switch to unlicensed spectrum. In a related example, a device UE 10 is out of coverage and an anchor UE 14 is within coverage and may know its position or provides a location/ranging service proxy or has access to a location/ranging service. The device UE 10 may perform ranging in unlicensed spectrum to determine the distance and/or angle (using one of the previously described methods) between itself and the anchor UE and/or may receive a signal (e.g., discovery message or other ranging reference signal) from anchor UE 14 (which may send such signal once in a while on a set of preconfigured licensed/unlicensed radio spectrum resources) through which device UE can determine the distance and/or angle (using one of the previously described methods). By using the measured distance and/or angle the device UE 10 may determine a position estimate (either by itself after receiving some information about the anchor UE's location, or by making use of the location/ranging service proxy, or by accessing a location/ranging service (e.g., through relay connection and/or by using a last known position of device UE 10 or anchor UE 14)), and based on this position estimate determine that it is located within a certain geographical area for which it is configured/allowed to use licensed spectrum (for a certain PLMN) for using sidelink resources (e.g., for communication/ranging purposes). In a related example, assume a first device (FD) out of coverage and a second device (SD) in coverage. In this case, the FD may send sidelink sync signals (SSS) in unlicensed spectrum and listen to SSS in both licensed and unlicenced. The SD may receive the SSS (indicating out of coverage) of the FD, and may inform the SD of its presence. It can do this by using unlicensed spectrum and it might perform ranging in this spectrum, or the SD receiving these SSS from the FD can inform the FD and then decide, based on a policy, to transmit SSS in licensed spectrum to allow the FD to connect and use ranging in licensed spectrum.

### Velocity Estimation

In an embodiment, upon discovering a ranging capable device within the ranging distance, the device UE 10 can measure the distance and angle with the ranging capable device (e.g., an anchor UE 14) and continuously keep track of these measurements and their timing for every distance moved by the device UE with respect to the first measurement made by the device UE 10 with the discovered ranging capable device. The device UE 10 may periodically attempt to regain the connection to the LMF 34, RMF 36 or other location services offered by the core network or anchor UEs or obtain new location coordinates from the ranging capable device, while keeping track of the distance and angle measurements obtained from the ranging capable devices along its movement trajectory. This allows the device UE 10 to estimate its relative velocity and/or movement pattern/trajectory. If information about absolute/geographic location and/or the velocity and/or movement pattern/trajectory of the respective anchor UE(s) 14 and/or whether the respective anchor UE 14 is stationary or not, is transferred to the device UE 10 (or vice versa), then also the absolute velocity and/or movement pattern/trajectory of the device UE 10 within a fixed/absolute/geographical coordinate system may be calculated.

In an example, inertial sensors (e.g., accelerometers and/or gyroscope or the like) provided at the device UE 10 can be used in assisting the ranging service for determining and tracking the movement trajectory.

The data from such an inertial sensor can be locally processed on the device UE 10 to calculate the distance and the direction travelled by the device UE 10 from the moment at which the device UE 10 lost its connection to the location and/or the ranging service. The device UE 10 may locally compute the movement trajectory based on the distance and direction travelled and combine this information with the last known location coordinate to determine the current coordinates of the device UE 10. Alternatively, the device UE 10 may append the distance and direction information calculated based on the inertial sensor(s) in the discovery message or other message (e.g. Direct Communication Request message or PC5-RRC message) sent via a PC5 interface. An anchor UE 14 that receives such message (and that may operate a ranging and/or location service) or the RMF 36 and/or LMF 34 (to which the distance/direction information based on the inertial sensor(s) may be forwarded) can then calculate the current coordinates based on the inertial sensor measurements from the device UE 10. Distance and direction calculated from the inertial sensor measurements might also be used optionally and/or in addition to the ranging measurements, depending on the error rate of the ranging measurements at a given environment and other factors such as user preference and/or device capability.

Upon re-establishing the connection with the LMF 34 or other location services offered by the core network or anchor UEs and obtaining the current location coordinates, a device UE 10 may automatically re-calculate the location coordinates based on the last known location coordinates and distance and angle measurements made while the connection to the LMF or other location service was broken. Alternatively, upon re-establishing connection with the LMF 34 or other location service offered by the core network or anchor UE, the device UE 10 may transmit the distance and angle measurements made (e.g., to nearby anchor UEs 14 or other ranging capable UEs) while the connection to the LMF 34 or other location service was broken and may also transmit the last known location coordinates. This allows the LMF 34 or other location service to quickly determine the current location of device UE 10.

It is noted that an anchor UE 14 in the ranging constellation 50 while performing a ranging operation with the device UE 10 can report the identity/ranging measurement of the device UE 10 to its ranging service or location service or to the LMF 34, RMF 36 or other location/ranging services offered by the core network, or proxy thereof offered by anchor UE 14 so that location coordinates corresponding to the current location of the device UE 10 can be updated in a location registry.

### Using FR1/FR2 to Determine Line of Sight

In another embodiment that can be combined with any other embodiment or implemented independently, the device UE 10 and anchor UEs might transmit and/or exchange positioning signals and/or messages in different frequency bands, e.g., FR1 and FR2, frequency bands. In a possibility, this might be done by using carrier aggregation (i.e., simultaneous transmission on two different bands of a ranging reference signal that may be duplicated or split across the bands) or by using the different bands intermittently. The term “positioning signals” as used herein and in the subsequent embodiments can be used in the context of location services using access devices (e.g., access device 20 using an infrastructure connection/Uu interface) as well as for ranging reference signals for determining the distance and/or angle between two devices (e.g., using sidelink/PC5 interface).

For instance, in a first step, the device UE 10 might receive or send a message requesting/offering ranging services in the FR1 frequency band; in a second step, the device UE 10 might receive or transmit positioning signals in both the FR1 and FR2 frequency band; the device UE 10 may use the signal quality or the result of the distance measurement of the message (e.g., ranging reference signals) sent in the FR1 frequency band to determine that the device UE 10 is sufficiently close and/or has line of sight (LoS) with another ranging capable UE, in order to determine whether or not to send a signal in FR2. The decision may also be based on the device capabilities or instructions received from the other ranging capable device that allows the device to determine that the other ranging capable UEs supports the FR2. To this end, the supported and/or preferred frequencies/bands of the ranging capable UEs may be exposed/exchanged e.g. during discovery or connection setup between the two ranging capable UEs. Similarly, also support for carrier aggregation and/or supported bands for carrier aggregation may be exposed/exchanged. In a third step, the device UE 10 or anchor UE 14 might gather measurements of those positioning signals, and optionally, send them to a managing entity or a ranging/location service for evaluation; in a fourth step, the device UE 10 or the anchor UE 14 or the managing entity or a ranging/location service might determine the LoS features of the communication link based on gathered measurements. The positioning signals or messages might assist e.g. in the computation of the round-trip time. When the measurement is performed when exchanging positioning signals or messages in the FR1 band, the measurement is likely to succeed even if it there is no direct LoS, e.g., when devices are separated by a wall in a house; however, when the measurement is performed when exchanging positioning signals or messages in the FR2 band, the measurement will not be reliable due to the bad propagation of wireless messages in the FR2 band. Not all steps are always required and steps might be done in a different order.

Hence, based on these measurement results (in particular, if measurements in FR1 were successful whereas in FR2 the measurements were not successful), it can be decided that the device UE 10 and an anchor UE 14 are or are not within each other's line of sight. Based on whether device UE 10 and anchor UE 14 are within line of sight, the UEs may decide to use only FR1 (or lower) frequencies for ranging or communication, may select a particular subset of FR1 frequencies for ranging or communication, may change the ranging method used, may decide to stop/start ranging, or may decide whether or not to set up a connection and/or ranging session.

Alternatively, the measurements done in the FR1 and FR2 bands might be analyzed, e.g., by the managing entity, to show whether the received power varies as expected if LoS is available.

The transmitting UE may change the transmit power of the signal in the different frequency bands in such manner that a receiver would be expected to measure similar and/or specific values for signal strength/quality (according to calibration information) and may include transmit power information as part of the positioning signal and/or a message that was exchanged beforehand (e.g., as part of the ranging session setup).

An alternative to determine whether two UEs are in LoS range is to exchange a positioning signal including subcarriers at both FR1 and FR2 frequencies. The measured signal strength of the positioning signal subcarriers at FR1 and FR2 frequencies is then used to determine the LoS features of the communication link. If the anchor UE and the UE are in LoS, then the positioning signal transmitted in the FR2 frequency will be received properly, but if there is an obstacle (e.g., a wall) in between, the received positioning signal will be received with lower power (e.g., RSRP) or lower signal quality (e.g. RSRQ) or not at all in comparison with the received positioning signal transmitted at a lower FR1 frequency. To this end, the transmitting UE may change the transmit power of the signal in the different subcarriers in such manner that a receiver would be expected to measure similar values for signal strength/quality (according to calibration information) and may include transmit power information as part of the positioning signal and/or a message that was exchanged beforehand (e.g., as part of the ranging session setup).

### Centralized Localization

In an embodiment related to centralized localization based on ranging measurements with the anchor UE nodes 14, the device UE 10 may approach an anchor UE 14 of the ranging constellation 50 to perform a ranging measurement. Upon receiving a ranging request from the device UE 10, the anchor UE 14 may notify the device UE 10 about the ranging constellation 50 via the LMF 34, RMF 36 or other location or ranging service or via another communication channel. The device UE 10 can store the constellation information and as long as it is in the vicinity of the ranging constellation 50, it can decide if it wants to receive location coordinates from one or more of the anchor UEs 14 or other UEs part of ranging constellation 50 (which may offer ranging services and/or can function as a proxy for a location service) based on the ranging measurements. The device UE 10 and the other device UEs 10 and anchor UEs 14 may be part of a positioning constellation 60, whereby a location service may (centrally) determine the location of device UE 10. The device UE 10 may connect to the LMF 34, RMF 36 or other location or ranging service offered by the network and/or receive information from the LMF 34, RMF 36 or other location or ranging service either directly through Uu interface or via a relay connection between the device UE 10, another UE and an access device 20 providing access to the LMF 34, RMF 36 or other location or ranging service (e.g., through a secure connection or e.g. exposed via a discovery message of the relay device). An anchor UE 14 or a ranging capable device UE 10 may act as such relay device (e.g., using ProSe relay services) for other UEs, e.g., other UEs as part of the positioning constellation. The UEs that are part of the ranging or positioning constellation may be configured with a specific identity and parameters, e.g., a Relay Service Code and/or discovery credentials that allows other UEs that are part of the constellation and/or that are in the vicinity and/or that are capable of ranging and/or location services to access the LMF 34, RMF 36 or other location service and/or ranging service via a ProSe relay connection based on that specific Relay Service Code. The LMF 34, RMF 36 or other ranging service and/or location service or other managing entity may provide credentials that allow and/or that can be used for protecting the discovery and/or message exchange between the ranging capable device UE 10 acting as a remote UE, the respective UE acting as relay device and the ranging/location service.

When the device UE 10 needs to obtain its location (e.g., geographical) coordinates, it can initiate a ranging request via a ranging service with any anchor UE 14 of the ranging constellation 50 and indicate its need for location coordinates. Upon receiving the request for location coordinates, (at least) one anchor UE 14 of the ranging constellation 50 may perform a ranging measurement and share its ranging measurements, e.g., with the RMF 36 and/or the LMF 34, to obtain the geographical coordinates of the device UE 10 based on the ranging measurements between the device UE 10 and the anchor UE 14 of the ranging constellation 50. If more than one anchor UE 14 perform ranging measurements, then the ranging measurements may be combined in a single report (e.g. by the head anchor UE collecting the ranging measurements from the various anchor UEs and transmitting the combined ranging measurements to the LMF 34 or RMF 36). Note that the device UE 10 may create such a report since it may perform ranging with each and every anchor UE 14, if these anchor UEs 14 are explicitly involved in the ranging of device UE 10 (e.g. by participating in the same ranging session). The report may be sent directly to, e.g., the RMF 36 and/or the LMF 34, or indirectly via the (head) anchor UE 14. As mentioned earlier, anchor UEs may also be implicitly involved without the device UE 10 being aware of this or without having joined the same ranging session, e.g. by receiving information (e.g. reference signal characteristics/type, timing or resource information) from the LMF or other managing entity that allows the Anchor UEs to monitor ranging reference signals being transmitted by device UE 10.

It is noted that the LMF 34 and/or RMF 36 may request the anchor UE 14 to provide, if known, its own known location coordinate information and/or the antenna orientation information to the LMF 34 and/or RMF 36. The antenna orientation information may then be used by the LMF 34 and/or RMF 36 to improve ranging methods for e.g. customized beamforming to improve an angle-of-arrival calculation between the anchor UE 14 and the device UE 10 for the given antenna orientation. Additionally, the LMF 34 and/or RMF 36 may request a 5GS infrastructure to assess the location and orientation of anchor UEs 14. This may require the anchor UEs 14 to, e.g., measure PRS signals (transmitted by one or more access devices 20) and send these measurements to the LMF 34 and/or RMF 36 for location estimation. These measurements can also be used to determine the orientation of the anchor UE. For instance, if the anchor UE 14 returns its beamforming settings (e.g., transmission power, direction) when performing measurements of e.g. reference signal time difference (RSTD) and/or reference signal received power (RSRP) with one or more different wireless access devices 20 (e.g., gNBs), the 5GS infrastructure may determine the orientation of the anchor UE 14. In this case, the wireless access devices 20 (e.g., gNBs) may carry out a beam sweeping during the initial access or the broadcast of the SSBs or beam determination in idle mode (e.g., as described in section 6.1.6.1 of 3GPP TS 38.802 “Study on New Radio Access Technology”, V14.2.0). This allows the gNBs to determine the location of the anchor UE 14. Similarly, the anchor UE 14 might transmit, e.g., a synchronization signal (SS), in multiple directions. The wireless access devices might measure the received power of different synchronization signals and combine the measurements to compute the orientation of the anchor UE 14 depending on the signal/response received by the wireless access devices 20 (e.g., gNBs) from the anchor UE 14 in different beam directions.

In another embodiment related to centralized localization, as illustrated in FIG. 10, the LMF 34 (or RMF 36 or other managing entity) may be instructed/configured (e.g. by the GMLC 37 via the AMF 32 or by the AMF 32 directly) to monitor the location of a set of anchor UEs (e.g. for a given set of anchor UEs 14 in a ranging constellation 50 or for anchor UEs in a certain area (e.g. based on area information such as (a set of) tracking areas, (a set of) gNB/cell identifiers, (a set of coordinates) associated with a ranging constellation 50)) for a period of time, based on a Periodic Mobile Terminated Location Request (MT-LR) 1001, e.g. issued by the GMLC 37, for the respective set of anchor UEs. The LMF will 1002 configure the set of Anchor UEs and/or AMF (and/or NG-RAN (not shown)) to 1003 regularly provide the LMF with updated location information and/or perform measurements and send ranging/location measurements to the LMF to enable the LMF to determine a fresh location of the anchor UEs. The LMF may 1004 store the up to date location of all these anchor UEs in its own storage or requests another core network function (e.g. GMLC 37 or Unified Data Repository (UDR) 39) to store the location information of these UEs. The location information of the anchor UE may be further updated everytime the anchor UE issues a Mobile Originated Location Request (MO-LR) to the network, upon which the LMF will retrieve or determine the location of the anchor UE and store the updated location information in the respective storage.

In order to determine the position of a target UE 10 using ranging/sidelink positioning, the target UE may 1005 issue a MO-LR to the network (e.g. via Uu connection if the Target UE is in coverage or indirectly (e.g. via ProSe UE-to-Network relay or gateway functionality e.g. offered by an anchor UE, or by the anchor UE itself reporting a MO-LR on behalf of the target UE (e.g. after PC5 discovery or PC5 connection setup)), or the GMLC 37 (or other LCS client) may 1006 issue a MT-LR to the network. These Location Requests are typically sent to the AMF 32, which will then 1007 select an LMF 34 (or RMF 36 or other managing entity) to handle this request. In case of ranging, it is important that the LMF selected to handle the location request for a target UE is the same LMF that is selected to handle the location requests and/or location determination for the anchor UEs (e.g. of the ranging constellation 50) with which the target UE will perform ranging. Otherwise, this poses issues for ranging and/or sidelink positioning procedures, since ranging measurements/results may end up in different LMFs if the Target UE and an Anchor UE would be served by different LMFs. Also the ranging configuration and resource allocation (e.g. the timing when to send which ranging reference signal and in which frequency) may not be aligned. To enable this, the AMF 32 may select an LMF that serves a particular area which overlaps/corresponds to area information that it may have received (e.g. from the NG-RAN or the Target UE itself, e.g. as part of the location request or registration request or a separate message) related a Target UE, such as Tracking Area Identifier (TAI) or gNB/Cell-Id, since the Target UE and the anchor UEs will communicate over PC5/sidelink and hence, the anchor UEs and Target UE are likely to reside in the same area served by the LMF. The AMF may retrieve information about the area that the LMF serves (e.g. set of Tracking Areas, set of gNB/Cell-ids, set of coordinates to denote the area that it covers) from the LMF itself, or e.g. from GMLC 37, UDR 39 in which this information may be stored). Alternatively, the AMF 32 may select an LMF that serves a majority of other UEs in the area that overlaps/corresponds to area information that it may receive (e.g. from the NG-RAN or the Target UE itself) related a Target UE, such as Tracking Area Identifier (TAI) or gNB/Cell-Id, to increase the chance that it selects the same LMF. In case the AMF has information about both the Target UE as well as one or more anchor UEs that will be involved in ranging/sidelink positioning with the Target UE (e.g. based on discovery information from the Target UE about which Anchor UE(s) it has discovered via PC5/sidelink, that the Target UE may have provided to the AMF (e.g. as part of a MO-LR or in a separate message) or e.g. by an Anchor UE providing discovery information or connection setup information related to the Target UE to the AMF, or e.g. by an Anchor UE having information about a ranging constellation 50, or e.g. by receiving a Location Request including not only information about the Target UE, but also information e.g. identities of one or more anchor UEs to be used for ranging/sidelink positioning of the Target UE, or e.g. by receiving information e.g. from NG-RAN or Target UE or Anchor UE that an Anchor UE is used for relaying a message from the Target UE (e.g. by acting as a ProSe UE-to-Network relay or gateway, for example when the Target UE is out-of-coverage)), the AMF may check if it already serves one or more of the anchor UEs, and if so use information about the LMF that serves or has been selected for the one or more of the anchor UEs to select the same LMF for the Target UE. If the AMF does not currently serve one or more of these anchor UEs, it may request the UDM (not shown) to provide information about which AMF is the serving AMF of the UE not served by the current AMF. The current AMF 32 can ask the serving AMF 32 (2) of that UE which LMF it has selected for that UE, and then select the same LMF. Alternatively, the GMLC or UDR may store information about serving LMF per UE. The AMF (or LMF) may retrieve this information from the GMLC or UDR, or request the GMLC or UDR to provide this information, when a Target UE or Anchor UE registers to it and/or issues a location request, so that the AMF can select the same LMF (or for the LMF to provide or request the UE context of one or more anchor UEs to/from the serving LMF).

In the case that the AMF(s) did select a different LMF for one or more anchor UEs than for the Target UE, then if an LMF discovers that it does not have UE context information of both Target UE and the one or more anchor UEs that need to be involved (e.g. based on the ranging constellation information), then the LMF 34 may 1008 request other LMFs 34 (2) if they have UE context information of the one or more UEs for which the UE context information is “missing” (e.g. using the NL7 reference point (as specified in TS 23.273 and which may need to be extended for this purpose), and if so request them to perform a UE context transfer of the “missing” UE context information to this LMF (or vice versa), for example using steps 5-10 of the LMF Change Procedure in clause 6.4 of TS 23.273. If none of the LMFs have UE context information available for the “missing” UE, then the LMF may issue a request 1009 to the AMF to assign the “missing” UE to the same LMF. If the AMF does not yet serve the “missing UE”, it may 1010 verify (e.g. by requesting the UDM) if another AMF is serving that UE, and if not, issue a network triggered service request to that UE. Otherwise, it may align with the serving AMF of that “missing” UE to select the same LMF. Additionally or alternatively, the different LMFs selected for two or more UEs involved in ranging may 1011 coordinate with each other before or during the ranging procedures, e.g. by exchanging ranging configuration parameters, synchronize their clocks, exchanging schedule/resource information, exchanging security credentials, etc. This may be done by extending the NL7 reference point. The LMFs may even be located in different core networks, e.g. to enable an Inter-PLMN ranging, whereby two or more UEs performing ranging may be served by different core networks, and hence are served by different AMF and LMF. The AMF, LMF or other core network function may determine that such situation occurs based on the identity (e.g. SUCI, User Info ID, PRUK ID) of an anchor UE or target UE discovered over PC5/sidelink, or PLMN ID, NID, CAG or NCGI information that may have been provided during discovery over PC5/sidelink or during/after PC5 connection setup, that may have been provided by the Target UE or Anchor UE to its AMF, LMF or other core network function. To this end, an LMF may set up connection to an LMF in another core network, e.g. via a Service Based Interface if the two networks are in close cooperation, or e.g. via a tunneled, relayed or proxied connection via its GMLC communicating with the GMLC of the other core network, or setting up such connection via the NEF of the other core network). In case of roaming of a target UE or anchor UE, the respective UE is typically served by the AMF and LMF of the serving (i.e. visiting) network, and hence the AMF can select the same LMF in the same manner as mentioned earlier.

Once the same LMF is selected for the target UE and the anchor UEs to be involved, or the LMFs have coordinated their configuration, the LMF(s) can then 1012 configure the Target UE and the Anchor UEs to enable ranging to be performed between the Target UE and one or more Anchor UEs (and possibly also between the Anchor UEs themselves). The configuration information may include a session or ranging constellation identifier e.g. to initiate a joint ranging session or for reporting the respective ranging measurements or ranging results to the LMF, but the ranging may also be performed “session-less”, in which case the timing of the measurements or signal characteristics or frequency being used may be sufficient information for the Target UE or Anchor UE to determine to which ranging procedure or for which other UE the measurement applies. To this end, the configuration information provided to the respective Target UE or Anchor UE may include an identifier of a target UE or other Anchor UE, or an identifier related to a ranging reference signal configuration or configuration item therein (e.g. a particular resource schedule), as described in other embodiments.

Note that in case a ranging constellation is associated with a set of group/domain credentials or authorization tokens, the Target UE and/or the Anchor UEs of the ranging constellation may need to provide a proof of possession of the group/domain credentials or authorization token (e.g. by transmitting a correct response to an authentication/authorization request, or transmitting a correctly signed token/message)) upon registration of the Target UE and/or Anchor UEs to the core network (typically with the AMF), preferably before the AMF selects the LMF, for example to do this as part of the primary authentication procedure or as a separate procedure with the AMF and/or AUSF/UDM. If the AMF does not have this information, the AMF may request the LMF or GMLC or UDR or UDM that may have stored this information as part of the ranging constellation information to provide this information, or alternatively the LMF may perform such request or ask the AMF or AUSF/UDM to perform such check. Similarly, if the ranging constellation information includes information on Closed Access Group identifier indicating a Closed Access Group (e.g. operated by a Non-Public Network) or Non-Public Network identifier or (private) Network Slice identifier to which the Anchor UEs or Target UE need to subscribed with or have access to in order to (temporarily) join the ranging constellation (e.g. to take part in the ranging of a Target UE), then the AMF (e.g. upon the Target UE or Anchor UE registering to that AMF) needs to check that the Target UE or Anchor UE has access to that Closed Access Group, NPN or Network slice, preferably before it selects the LMF. Also, similarly, if the AMF does not have this information, the AMF may request the LMF or GMLC or UDR or UDM that may have stored this information as part of the ranging constellation information to provide this information, or alternatively the LMF may perform such request or ask the AMF or AUSF/UDM to perform such check. Alternatively or additionally, the AMF may provide the LMF with the necessary information (e.g. CAG ID, NPN ID, Network Slice ID for the respective UE) so that the LMF can perform this check. Similarly, if the ranging constellation information includes information about a set of target UEs that may be served by the ranging constellation and that hence may e.g. (temporarily) join the ranging constellation, e.g. indicated by a set of target UE identities and/or by a set of network identities (e.g. PLMN IDs) that indicate which home network that a Target UE needs to be subscribed with/belong to in order to be allowed to be served by that ranging constellation (i.e. whether the ranging using Anchor UEs of a ranging constellation can be performed for a visiting/roaming Target UE that is subscribed/belongs to a different PLMN than the serving network of one or more Anchor UEs of the ranging constellation), then the AMF (e.g. upon the Target UE registering to that AMF) needs to check that the Target UE identity is indeed in the list of target UE identities and/or that the network identity to which the Target UE belongs/is subscribed to (e.g. HPLMN ID) is in the list of indicated network identities, preferably before it selects an LMF for that UE. If the AMF does not have this information, the AMF may request the LMF or GMLC or UDR or UDM that may have stored this information about a set of target UE identities and/or set of network identities as part of the ranging constellation information to provide this information, or alternatively the LMF may perform such request or ask the AMF or AUSF/UDM to perform such check. Alternatively or additionally, the AMF may provide the LMF with the necessary information (e.g. identity, e.g. SUPI, and/or the home network identity (e.g. HPLMN ID) for the respective UE) so that the LMF can perform this check. Similarly, if the ranging constellation information may include a set of network identities (e.g. PLMN IDs) that indicate which home network that an Anchor UE needs to be subscribed with/belong to in order to be allowed to operate in a ranging constellation in a visiting network (i.e. if the Anchor UE is roaming/visiting a different network than its home network), then the AMF needs to check (e.g. upon the Anchor UE registering to that AMF) that the network identity to which the Anchor UE belongs/is subscribed to (e.g. HPLMN ID) is in the list of indicated network identities, preferably before it selects an LMF for that UE. If the AMF does not have this information, the AMF may request the LMF or GMLC or UDR or UDM that may have stored this information about a set of network identities as part of the ranging constellation information to provide this information, or alternatively the LMF may perform such request or ask the AMF or AUSF/UDM to perform such check. Alternatively or additionally, the AMF may provide the LMF with the necessary information (e.g. identity, e.g. SUPI, and/or the home network identity (e.g. HPLMN ID) for the respective UE) so that the LMF can perform this check.

### Detailed Architecture and Procedures for Decentralized Localization

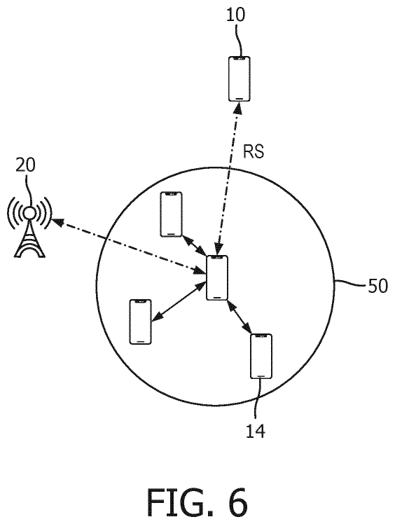

FIG. 6 schematically shows a network architecture where a mobile terminal (e.g., device UE) 10 approaches a ranging constellation 50 of mobile terminals (e.g., anchor UEs) 14 to get assisted by ranging services (RS) for location coordinates obtained from a location service (LS), according to various embodiments.

In an embodiment related to decentralized localization based on ranging measurements with the anchor UEs 14, one of the anchor UEs 14 may receive a request for location (e.g. geographical) coordinates from the device UE 10 either directly or via another device UE close to the ranging constellation 50 and may acknowledge the request. The ranging measurements corresponding to device UE 10 and the ranging constellation 50, i.e. ranging measurements performed on the ranging reference signals between device UE 10 and one ore more anchor UEs of a ranging constellation, may be used by an anchor UE 14 to locally calculate the location coordinates of the device UE 10 (using any of the concepts described in the present disclosure) based on its own location information obtained from a location service or an additional location module provided on the anchor UE 14 and the ranging measurements with the device UE 10.

It is noted that the anchor UE 14 could also inform the device UE 10 about the local coordinate system used by the ranging constellation 50 and the expected level of accuracy for a given ranging measurement performed between the device UE 10 and the anchor UE 14. If the ranging constellation 50 supports multiple coordinate systems, then the anchor UE 14 may inform the device UE 10 about the different types of coordinate systems supported by the ranging constellation 50. The device UE 10 may select one of the supported coordinate systems or let the anchor UE 14 decide about a default coordinate system for the given device UE 10 depending on its device characteristics. Note that a local coordinate using such coordinate system can be translated to geographical coordinates either by an anchor UE 14 or other device UE 10 that can act as a proxy for the location service or by the location service of the wireless access device 20 or the LMF 34, RMF 36 or other location or ranging service offered/accessible by the core network upon request by the device UE 10. To this end, a ranging capable UE may transmit a message to a LMF 34, RMF 36 or other location and/or ranging service in the core network or offered by an access device or a proxy of the LMF 34, RMF 36 or other location and/or ranging service offered by another ranging capable UE (e.g. anchor UE 14) over a secure interface, the message containing a distance and/or angle measurement (e.g. based on ranging reference signal) and optionally including other information such as ID and/or timing information, or a distance and/or an angle calculation result (e.g. based on a ranging measurement), and optionally a location coordinate system to use, and optionally including altitude and/or velocity/accelerometer information, whereby upon receiving the message by the LMF 34, RMF 36 or other location/ranging service or location/ranging service proxy a response message is returned which includes the resulting calculated location coordinate using the indicated optional location coordinate system or a default (e.g. geographical) coordinate system.

In order to allow the LMF 34, RMF 36 or other location and/or ranging service or a proxy thereof to calculate the position or distance/angle the device UE 10 may grant permission by providing authorization credentials to the LMF 34, RMF 36 or other location and/or ranging service or a proxy thereof as part of the same message or subsequent message, that can be used to authenticate/verify the authorization is authentic (i.e., provided by device UE 10), e.g. by performing a respective authentication procedure with device UE 10, or by verifying if the credentials match or can be securely correlated to previously stored credentials of device UE 10 in the LMF 34, RMF 36 or other location and/or ranging service or a proxy thereof, or a core network function (e.g., UDM/AUSF), and/or by granting permission for this by providing consent in its subscription (e.g., by UDM), or through providing consent through the Network Exposure Function (NEF). The message that may be sent by device UE 10 to grant consent for this may include some fields/payload containing information about the given consent, e.g. the validity period, to which entities (e.g. location service proxy (provided by a particular UE for which the identity may be included)) the consent is given, information about credentials or token that would have to be provided by a given entity before it is allowed to be involved in calculating the position or distance/angle of device UE 10). In case group/domain credentials or authorization tokens or a closed access group or NPN or (private) network slice are/is associated with a ranging constellation that are used to protect the communication between UEs of a ranging constellation and/or to restrict the communication only between UEs belonging to that group/domain/closed access group/NPN/slice, the device UE 10 may only need to provide consent once for all UEs of a ranging constellation to be involved in the calculation of the position or distance/angle of device UE 10 (e.g. by including in a message the ranging constellation id and/or group/domain credentials and/or closed access group or NPN or (private) network slice information with which the consent will be associated that the device UE 10 sends to the LMF 34, RMF 36 or other location and/or ranging service or proxy thereof, or other managing entity). For example, this may be done during a message exchange when the Target UE joins the ranging constellation (e.g. when issuing a request for ranging or location estimation to the LMF or proxy thereof). The consent may also be stored in the UDM or GMLC (typically in the home network of the Target UE), which may be verified e.g. by the AMF or other core network function. The consent may also be provided by an application that manages (through the NEF) the ranging constellation and/or the UEs involved, e.g. by providing this implicitly or explicitly in the ranging constellation configuration information that it may send to the LMF or other managing entity.

Similarly, with a similar message that may include also position information or an identifier of a device or reference point, a ranging capable UE may request a location and/or ranging service (or a proxy thereof) to provide/calculate/return a distance and/or angle between the ranging capable UE and the indicated device or reference point, after which the LMF 34, RMF 36 or other location and/or ranging service (or a proxy thereof) will return the resulting calculated distance and/or angle.

In another (alternative) embodiment related to decentralized localization based on ranging measurements with the anchor UEs 14, the ranging constellation 50 may be configured and deployed in an indoor environment or a known target area such that it can have its own local coordinate system relative to a reference geographical coordinate system. A device UE 10 approaching the ranging constellation 50 and authorized to use the ranging constellation 50 may request a location coordinate from an anchor UE 14 of the ranging constellation 50. Upon receiving the request, the anchor UE 14 itself or the head device of the ranging constellation 50 on its behalf may select at least one of the anchor UEs 14 (typically 2 or 3) of the ranging constellation 50 to perform ranging measurements with the device UE 10, such that the selected device(s) are within a required ranging distance of the device UE 10 and can perform ranging with the device UE 10 in order to calculate the position of device UE 10 according to the local coordinate system of the ranging constellation 50. The selected anchor UEs 14 of the ranging constellation 50 may initiate the ranging measurements with the device UE 10, e.g., in a synchronous or coordinated manner, to obtain ranging measurements. The ranging measurements may be used either by the head device of the ranging constellation 50 or by the ranging service in combination with the location service (or proxy thereof), to position the device UE 10 in a local coordinate system of the ranging constellation 50. The coordinated manner may be to perform sequenced ranging measurements in time to avoid all measurements initiated at the same time thereby causing mutual interference. It could also mean to perform the ranging measurements relatively closely together in time in order to get an accurate result for cases where the device UE 10 is moving.

It is noted that to protect the privacy of the ranging procedure, specific ranging parameters (e.g., constellation identifiers, anchor UE identifiers, information about the ranging reference signal used at a given instant of time by a first UE), and/or information embedded/added/multiplexed into a ranging reference signal (e.g. an identifier), and/or ranging measurements/results may only be communicated to a second UE once the second UE has been authorized to use the ranging reference signal of the first UE. To prevent tracking of a UE based on ranging reference signals and/or positioning messages broadcasted by the UE, an identity and/or resources (timing/frequency) of the ranging reference signals and/or positioning messages may be randomly allocated. For instance, instead of following a well-known or deterministic pattern (e.g., a periodic pattern of signals/messages transmitted at periodic/specific time/frequency), the signals/messages might follow a random looking pattern only known to authorized devices. Additionally, after each ranging session, the UEs may need to request or may have to receive a new/fresh authorization and/or obtain a new/fresh set of credentials from the core network/access device/RMF/LMF/(head) anchor UE through a Uu direct connection or PC5 direct/indirect connection, before or upon establishing a new ranging session.

In an example, a device UE 10 might approach an area and may be provided with ProSe discovery parameters (e.g. ProSe service/application identifier for a ranging/localization service or discovery keys for discovering an anchor UE and/or a ranging/localization service) if authorized for a ProSe-based ranging/localization service. Based on these ProSe discovery parameters, the device UE 10 can discover other ranging capable UEs (e.g., anchor UEs 14) that are in the area, which may use one of the ProSe discovery procedures. Once discovery is performed and using a PC5 secure connection, or directly in the discovery messages themselves (e.g., as part of a metadata field), the anchor UEs 14 may provide the ranging/localization services requested by the device UE 10 with specific parameters (e.g., a positioning signal ID or a timing/frequency of the positioning signal) required for ranging/positioning. It is noted that, as indicated in the initial section above, ranging can be performed in multiple ways. For instance, a device UE 10 may be equipped with beam forming capabilities, such that a ranging measurement can be directed to a certain anchor UE 14 and this “angular” information may be used for determining its position.

In a further (alternative) embodiment related to decentralized localization based on ranging measurements with the anchor UEs 14, the device UE 10 may receive an updated list of anchor UEs 14 located in its vicinity, e.g., from the LMF 34 or the RMF 36 or other managing entity. Note that the LMF 34 and/or the RMF 36 or other managing entity may create and keep updating this list of anchor UEs 14 resulting in a constantly updated constellation of ranging capable UEs whose locations are known a priori to the LMF 34 and/or the RMF 36 or other managing entity. Optionally, to provide control for the network operator, the device UE 10 may be required to report the measurements (e.g. as performed on the ranging reference signals received from one or more anchor UEs) to the LMF 34 and/or the LMF 36 or other managing entity together with an indication of the position of the device UE 10.

It is noted that if a PC5 interface is required, then device UEs 10 and anchor UEs 14 need to discover each other. Thus, the LMF 34 or RMF 36 or other managing entity may need to interface with a network function in the 5G CN (e.g., the direct discovery name management function (DDNMF) or policy control function (PCF)) capable of authorizing the device UE 10 to discover anchor UEs 14 by means of (PC5) discovery messages.

The device UE 10 upon approaching and entering a ranging distance of one of the anchors UEs 14 of the ranging constellation 50, may be assisted to obtain its location coordinates through ranging measurements without actually being positioned by the network access devices 20 and/or the LMF 34.

In a still further embodiment related to decentralized localization based on ranging measurements with the anchor UEs 14, which can be used as an alternative to or in combination with the above corresponding embodiments, an out-of-coverage device UE 10 may request its current location information from a communicatively coupled anchor UE 14, that is calibrated for ranging measurements with device UE 10, e.g., by sending a message with a measurement result related to a ranging reference signal (whereby such measurement result may include e.g. ID of the device or ID of the ranging reference signal and/or timing information) and/or estimated distance/angle to the anchor UE 14, optionally including information about a coordinate system to use, and optionally including altitude and/or velocity/accelerometer information. The message type (e.g., PC5_Location_Request or RRCLocationRequest) may indicate to the anchor UE 14 that the device UE 10 requests position information based on the provided information, which it may return (after calculation) in a response message to device UE 10.

Similarly, with a similar message that may include also position information or an identifier of a device or reference point, device UE 10 may request anchor UE 14 to provide/calculate/return a distance and/or angle between device UE 10 and the anchor UE 14 and/or the indicated device or reference point, after which the anchor UE 14 will return the resulting calculated distance and/or angle. The anchor UE 14 may know its own location or can request the LMF 34 or RMF 36 or other location service of the core network 30 (e.g., network controller device) for its own location coordinates based on positioning measurements with the network access devices 20 (e.g., gNBs) and translate the ranging measurement of the device UE 10 to a local location coordinate of the device UE 10.

Alternatively, the anchor UE 14 may report the ranging measurement of the device UE 10 along with its device ID to the LMF 34 or RMF 36 for obtaining the location coordinates of the device UE 10, which are then calculated by the LMF or RMF.

Alternatively, the location coordinates of the anchor UE 14 may be shared with the device UE 10 which can use its ranging measurement and the location coordinate of the anchor UE 14 to calculate its own location coordinates.

In a still further (alternative) embodiment related to decentralized localization based on ranging measurements with the anchor UEs 14, the anchor UEs present in the ranging constellation 50 may be configured to advertise the (ranging-based) positioning service (or proxy thereof) as a proximity service. Note that this may require some of the anchor UEs 14 to be assigned to a ranging proximity service. This may require the LMF 34 or RMF 36 or other managing entity to interact with a direct discovery name management function (DDNMF) or policy control function (PCF) in charge of assigning discovery parameters to UEs. Upon connection to, subscription to and/or authorization for the proximity service for ranging-based positioning, the device UE 10 may receive discovery keys/parameters for accessing the ranging/positioning service (or proxy thereof) (e.g., via a PC5 sidelink channel). Then, the device UE 10 may securely send (or receive) discovery messages for the ranging-based positioning service (or proxy thereof) of the anchor UEs 14 of the ranging constellation 50 (e.g. via PC5 sidelink discovery messages).

The managing entity, PCF, AUSF, LMF 34 or RMF 36 may provide the credentials (e.g. during initial provisioning of the ranging/location service on device UE 10, or during authorization/connection setup procedure between a device UE 10 and anchor UE 14, that may involve a message exchange between the anchor UE and the respective network function after which the anchor UE 14 may forward the data to device UE 10 and/or message exchange between device UE 10 and the respective network function via a relayed connection via the anchor UE 14) to device UE 10, which device UE 10 should use to securely connect to the ranging/location service (or proxy thereof) and/or use to protect the data that device UE 10 sends to the ranging/location service (or proxy thereof). Alternatively device UE 10 together with a managing entity, PCF, AUSF, LMF 34 or RMF 36 may derive credentials (e.g. keys) to use to securely connect to the ranging/location service (or proxy thereof) and/or use to protect the data that device UE 10 sends to the ranging/location service (or proxy thereof), based on a set of pre-configured credentials (e.g. root credential in the SIM, or e.g. a session key such as Kamf or Kausf).

Upon receiving (or sending) the discovery messages, an anchor UE 14 of the ranging constellation 50 may reply with (or include) the location and/or ranging measurements or calculated ranging results according to its device capabilities. This may be achieved by means of discovery messages or by configuring lower protocol layers (e.g., the physical (PHY) layer) to start transmitting positioning signals, communicating the timing and/or frequency and/or identity of the positioning signals to the device UE 10 (e.g., through the PC5 interface) and gathering the UE measurements of the received positioning signals or calculated ranging results based on the measurements over the PC5 interface.

The anchor UE 14 may provide the device UE 10 with a set of ranging parameters (e.g., the timing and identities of the positioning signals assigned to the anchor UE 14 or other configuration parameters or desired ranging parameters) through direct device to device communication or discovery (e.g., using sidelink/PC5), e.g., upon successful discovery as described in the above embodiment. This approach is useful for a device UE 10 that is out of coverage since the device UE 10 can then only receive those parameters from other ranging capable UEs through direct device to device communication or discovery (e.g., using sidelink/PC5). Alternatively, the device UE 10 may receive the ranging parameters of anchor UEs 14 when joining a ranging service and/or location service and/or ranging-based positioning service, e.g., after authentication and authorization.

In an embodiment, if there are several ranging capable UEs, e.g., anchor UEs 14 that had responded to the device UE 10 with a ranging signal (e.g. a discovery message) or had voluntarily transmitted a ranging signal (e.g. a discovery message), then the device UE 10 can estimate the distance and/or angle based on timing measurements on the respective ranging reference signals (e.g. discovery messages), and use the estimated distances and/or angles to estimate the location by means of e.g. triangulation/trilateration. To this end, the UEs transmitting ranging reference signals (e.g. discovery messages) (e.g., anchor UE 14) may transmit synchronization signals and/or timing information to the receiving device (e.g., device UE 10). Alternatively, or additionally the timing of the scheduled resources for discovery (e.g., the sidelink discovery pool) or a ranging/ranging signal pool can be used to determine the originating time of transmitting a ranging signal (e.g. a discovery message). The ranging signal (e.g. the discovery message) may include timestamp information about when it was transmitted or time difference information (e.g., t4−t1 and/or t3−t2 in case of an FTM based technique). The ranging signal (e.g. the discovery message) may include Angle of Departure information. Device UE 10 may do the same in its ranging reference signals (e.g. discovery messages) to another ranging capable UE (e.g., an anchor UE 14). Alternatively, when only a few, e.g., 1, UEs 14 responded to the device UE 10 and/or if the ranging signal (e.g. the discovery message) includes location and the time of departure (TOD) information while the clocks of the device UE 10 and anchor UE 14 are synchronized, then the device UE 10 may calculate the distance based on the ranging signal (e.g. discovery message) only and if sufficient information is available (e.g., if it can also measure the angle and/or if information about the altitude is provided to/from the other UE) it can estimate its position. This reduces the need of the device UE 10 to send other messages (such as particular ranging/position/sounding reference signals) to anchor UEs 14 for positioning information.

In an embodiment, in order to improve the accuracy, a ranging signal (e.g. a discovery message) may be sent over multiple bands/frequencies, use a larger bandwidth, or be collocated/prepended/appended with a ranging reference signal. Some or all of the contents of the discovery message (e.g., an ID of the other ranging device) or a copy thereof may be transmitted as payload/encoded data of a ranging reference signal. Similarly, some or all of the contents of the ranging reference signal and/or e.g. ID or type or device identity related to the position/sounding signal may be transmitted as payload/encoded data of the discovery message.

### Details on Using Prose Discovery Messages for Ranging

The following embodiments describe some ranging-based positioning concepts based on discovery messages. These concepts can be adapted to the usage of positioning signals transmitted at PHY layer, e.g., as in existing positioning techniques or as described in the above embodiments.

In an embodiment related to ProSe open discovery with ToF measurement or carrier phase-based ranging that can be combined with any other embodiment, or implemented independently, discovery messages in ProSe open discovery can be enhanced to include ranging capabilities. This can be achieved by configuring the anchor UEs 14 to transmit discovery messages following a given timing schedule known to the device UEs 10, so that the devices can be synchronized. The discovery message may include an identifier, e.g., a relay service code (RSC), or service identifier or application code, indicating a ranging service or location service or a ranging-based positioning service (or proxy thereof). Furthermore, the discovery messages may be enhanced to include a (fixed) identity (e.g., L2 identity) of the anchor UEs 14 (so that the device UE 10 can identify the anchor UE 14), the position of the anchor UE 14, and/or a positioning information (e.g., the location of the anchor UE or a carrier phase-based positioning signal used to transport the discovery message itself). These discovery messages may be integrity protected using a Discovery User Integrity Key (DUIK). Based thereon, the device UE 10 can check the integrity of the received discovery messages, identify the anchor UE 14 distributing the discovery message, identify a ranging service or location service or a ranging-based positioning service (or proxy thereof) based on the identifier, and extract distance information from the positioning information and the timing when the discovery message is received.

In an embodiment related to restricted discovery with round-trip time (RTT) measurement that can be combined with any other embodiment, or implemented independently, discovery messages in ProSe restricted discovery can be enhanced to include ranging capabilities. This can be achieved by enhancing the first message (i.e., discovery message) sent by device UE 10 to include an identifier (e.g., RSC) indicating the ranging service, location service, ranging-based positioning service and/or a ranging/position request. The device UE 10 is configured to start a timer when the discovery message is first sent out. The device UEs 10 may then receive an answer from the anchor UE 14 which may include the position Pa of the anchor UE 14 that can be verified and decrypted using discovery keys received by the device UE 10 after registering to the core network and its services (e.g. DDNMF), or after subscription. The device UE 10 measures the timer upon reception of the answer from the anchor UE 14. The value of the timer corresponds to the RTT. The distance to the anchor UE 14 can then be calculated as RTT*c/2. Since the device UE 10 may also have received the position of the anchor UE 14, it knows that its position is on the circumference of a circle with radius RTT*c/2 and center at the position Pa of the anchor UE 14.

It is noted that the anchor UE 14 may require a significant time for processing the message, i.e., to decode and validate the initial discovery message sent from the device UE 10. Thus, the RTT calculation should not include the processing time of the anchor UE 14 and/or the time anchor UE 14 waits until it sends a response to the initial discovery message (e.g. as per the scheduled resources), i.e., the time at which the packet is not in air. To eliminate this processing time and/or waiting time from the measured RTT, the reply from the anchor UE 14 might also include information of the processing time and/or waiting time at the anchor UE (e.g., time t3−t2 as in FTM or UE RX-TX as in LTE/NR based RTT measurements) to process the received discovery message and send a reply so that the device UE 10 can correct the RTT estimation accordingly. Alternatively, the device UE 10 may utilize time stamp values of the messages exchanged and/or time stamps sent separately by the anchor UE 14 in addition to the discovery messages using regular messages, if the time is measured using ranging reference signals e.g. PRS. Then, the device UE 10 may use its timer and time stamp values to deduct the processing time of the anchor UE 14. The device UE 10 can then estimate its own position with two or more of such measurements. By including the timing information as part of the discovery message, the device UE 10 and anchor UE 14 do not need to exchange additional measurement reports, and also not send separate PRS/SRS signals, since discovery messages are transmitted anyway in case of ProSe/ranging based sidelink devices.

Combining with Non-3GPP Positioning

In a still further embodiment related to decentralized localization based on ranging measurements with the anchor UEs 14, which can be used as an alternative to or in combination with the above corresponding embodiments, the anchor UE 14 may assist and/or improve the positioning accuracy and the position acquisition time for the entire ranging constellation by using non-3GPP communication channels (e.g., Wi-Fi, Bluetooth, etc.) to monitor and track beacon information (e.g. service set identifier (SSID), signal strength, beacon ID, beacon location, etc.) obtained from broadcast messages of other non-3GPP base stations (e.g., Wi-Fi access points or Bluetooth beacons) in the area. It is noted that the non-3GPP information may also be broadcasted by the device UE 10 and/or anchor UE 14 depending on the device capabilities. This beacon information may be sent to the LMF 34 and/or the RMF 36 when the anchor UE 14 observes the beacon information or if requested by the LMF 34 and/or the RMF 36.

The LMF 34 and/or the RMF 36 may be communicatively coupled with non-3GPP positioning systems (e.g., Wi-Fi positioning systems or Bluetooth positioning systems) to obtain the (geographical) location coordinates based on the beacon information. It is noted that non-3GPP positioning systems (e.g., Wi-Fi positioning systems) can be used when there is a discontinuity in the positioning information system due to non-coverage or can be used always in addition to the conventional 3GPP positioning services. The device UE 10 may use a priori knowledge of the beacon information obtained from broadcast messages (if available) of non-3GPP technologies (e.g., Wi-Fi or Bluetooth) to assist the ranging service in determining and tracking of the trajectory information as described in one of the above embodiments. Moreover, the beacon information observed by the device UE 10 may be sent to the LMF 34 and/or RMF 36 via the anchor UE 14 of the ranging constellation 50. If a device UE 10 and the anchor UE 14 are time-synchronized, the timing information of the 3GPP RAT can be combined with the beacon information obtained from non-3GPP RAT to estimate the location of the device UE 10 at a particular point in time and assist in tracking of the trajectory. Alternatively, the non-3GPP beacon information may also be linked to the timing of the entire ranging constellation 50 or a particular anchor UE 14 even when the device UE 10 is not time-synchronized with any anchor UEs. Depending on the application, either the device UE 10 or the anchor UE 14 may calculate the clock time offset after the device UE 10 becomes time-synchronized with the anchor UE 14 and/or the ranging constellation 50.

Alternatively, two ranging capable devices may be able to support 3GPP as well as non-3GPP based ranging methods and/or may use licensed bands and unlicensed bands for performing the ranging measurements. For example, a device may support Time Difference of Arrival over PC5/sidelink as a 3GPP supported method and Wi-Fi Fine Timing Measurement or Bluetooth beacon, RTT, carrier-phase distance measurements or AoA/AoD measurements. A ranging capable device may express support for these non-3GPP ranging methods in the discovery messages (e.g., PC5 ProSe discovery messages) and/or by sending a message to the other ranging device upon/after establishing a connection between the two ranging capable devices. The ranging capable devices may indicate an order of preference amongst all supported 3GPP and non-3GPP ranging methods and/or the devices may select a preferred set of ranging methods based on a configured policy or environment/context information and/or application requirements and/or accuracy requirements. The ranging capable devices may use multiple ranging methods simultaneously and/or in sequence.

In another embodiment, a device UE 10 might require a positioning service from the positioning constellation and an anchor UE 14 might be in its surroundings. The device UE 10 might be a smart watch and the anchor UE 14 might be a smart phone. The exact location of the anchor UE 14 might be known to the managing entity by means of standard positioning signals transmitted by the access devices, e.g., gNBs. The managing entity might then determine the rough location of the device UE 10 given the fact that the device UE 10 is in range with the anchor UE 14 and the known location of the anchor UE 14.

### Randomized Ranging Reference Signals

In an embodiment related to positioning signals from anchor UEs 14 that can be combined with any other embodiment or implemented independently, a configuration entity (e.g. the managing entity) may assign a random looking assignment of positioning signals, e.g., a transmission time/schedule and/or a positioning signal ID and/or a timing/frequency pattern, which may not be regular, to the anchor UEs 14. At a time t0 a positioning signal p0 is used, at a time t1 a positioning signal p1 is used, at a time t2 a positioning signal p2 is used, . . . , at a time ti a positioning signal pi is used, . . . , at a time tj a positioning signal pj is used. The positioning signals pi and pj may be chosen at random or in a random looking fashion from an available set of positioning signals, which may be identified by a positioning signal ID and for which the characteristics may be pre-configured by a configuration entity. Also, the resources used for transmitting the positioning signals may be chosen at random or in a random looking fashion from an available set of resources in an area. Furthermore, the time interval (ti+1−ti) between successive signal transmissions may not be a fixed value. Thereby, it is difficult to track a UE transmitting positioning signals over a sidelink channel and a UE can only use those positioning signals if it is informed about the timing and identities over time. The positioning signal identities may have a one-to-one or many-to-one relation with an anchor UE identity at a given time, or many-to-many relation with a set of identities of the anchor UE at a given time. Both the transmitter UE and receiver UE involved in ranging using the respective random looking positioning signals would need to be configured with the information about the timing and the positioning signal identities and/or UE identities over time. The above positioning signals p1, p2, . . . , pi might be as standard ones (e.g., defined in TS 36.211) or may differ e.g. in waveform, bandwidth, preamble, carrier, guard band and/or may include a pattern indicative of a positioning signal ID or anchor UE identity and may correspond to a different positioning signal ID or anchor UE identity at times t1, t2, . . . , ti. This positioning signal ID or anchor UE identity is the one that determines, e.g., the pseudo-random sequence (e.g., associated with the positioning signal ID or anchor UE identity at a given instant of time) or an encrypted/scrambled positioning signal ID or anchor UE identity that is transmitted as part of, encapsulated by, or over the positioning signal, or may determine a frequency shift of the positioning signal. The anchor UE identities and/or positioning signal IDs may also be used to determine/select the radio resources to use for transmitting/receiving the positioning signals. To this end, an access device or managing entity may define the resources per position signal ID or per anchor UE identity and provide the resource allocation information to the UEs involved (e.g., all UEs part of a constellation). The managing entity may have to ensure that multiple anchor UEs in close vicinity do not interfere with each other. Thus, the managing entity may have to assign anchor UE identities and/or positioning signal IDs at times t1, t2, . . . , ti to each anchor UE in an area in a way that they do not collide (e.g., to make sure that they do not use the same radio resource elements at the same time), and may use a secure connection or encrypted message (that only the intended recipient(s) can decrypt) to inform the UEs involved (e.g., all UEs of the ranging constellation) of the respective identities. Alternatively, the positioning signal IDs or anchor UE identities may be self-selected by the respective anchor UE 14 (or a device UE 10) e.g. according to a preconfigured randomization function (e.g., based on UTC time/System Frame Number (SFN)), that may be shared securely with UEs of the constellation and may use a secure connection or encrypted message (that only the intended recipient(s) can decrypt) to inform the UEs involved (e.g., all UEs of the ranging constellation) of the respective identities. Alternatively, the positioning signal IDs or anchor UE identities may be self-selected by the respective anchor UE 14 (or a device UE 10) according to a preconfigured pseudo-randomization function (e.g., based on UTC time/System Frame Number (SFN)), whereby the configuration of the pseudo-randomization function may be shared securely with UEs of the ranging constellation, and which the respective UEs can use to derive the same identities.

In a further embodiment related to the previous one, the managing entity makes use of random looking assignment of positioning signals for service authorization and revocation. A managing entity might only distribute, i.e., disclose, the random looking assignment of positioning signals, which are assigned to an anchor UE 14, to a device UE 10 that is authorized to use the service, e.g., authorized during an initial configuration phase. A given positioning signal pi out of the random looking positioning signals p1, p2, . . . pi, . . . pj, might have a limited lifetime, for instance, a few seconds, a few minutes, etc. In this case, if a UE 10 has already been configured with positioning signals pi+1, pi+2, . . . , the UE 10 might be prevented (revoked) from using the ranging service by updating the random looking assignment of positioning signals pi+1, pi+2, . . . of anchor UE 14, and any other anchor UEs the UE 10 might rely on. Alternatively, the managing entity might only disclose to a UE 10 the positioning signals, which are assigned to an anchor UE, that are valid for a very limited amount of time so that the UE 10 can automatically no longer access the service as soon as this limited amount of time elapses. The above two described alternatives provide a practical way to revoke the use of the ranging/location service, rather than having to update the credentials in all related devices to reflect a revoked authorization.

### Carrier Phase Based Ranging

In an embodiment related to carrier phase based ranging in sidelink direction that can be combined with any other embodiment or implemented independently, two or more anchor UEs 14 may transmit positioning signals featured by a very specific carrier signature over sidelink. A device UE 10 gets tightly time-synchronized with the two or more anchor UEs 14 and receives the positioning signals from the two or more anchor UEs, measures the number of carrier cycles CCi of each anchor UE positioning signal since transmission, and may derive the distance Di to each anchor UE 14 as Di=CCi*λ where λ denotes the wavelength of the positioning signals, and may estimate its position P based on the measured Di and the knowledge of the positions of the anchor UEs 14.

The measuring of the number of carrier cycles may be achieved by using a decoding of a code in the signal, and a computation and a phase measurement. The computation of the number of cycles may be based on decoding a known pseudo random code (PRC) inside the signal, and for each signal looking at which ‘point in time’ the PRC is as compared to the internal clock reference, from which a coarse number of cycles CC can be calculated. The fine part of CC (fractions of carrier cycles) can be obtained from a carrier signal phase measurement.

In an embodiment related to differential carrier phase based ranging that can be combined with any other embodiment or implemented independently, two or more anchor UEs 14 or wireless access devices 20 transmit positioning signals featured by a very specific carrier signature. An additional anchor UE (e.g., head anchor UE) is located at a well-known position (e.g., (x,y,z) coordinates) within the ranging constellation 50 and measures the positioning signals from the other two or more anchor UEs 14 or wireless access devices 20.

A device UE 10 is tightly time-synchronized with the head anchor UE and the anchor UEs 14 and receives the positioning signals from the two or more anchor UEs 14, measures the carrier of the positioning signals, and may estimate its position P based on it at time t, may receive from the lead anchor UE the current positioning signal error E_Lead that it measures itself at time t (E_Lead=P_Lead−P_REAL, where P_Lead is the position measured by the lead anchor UE based on the carrier phase and P_REAL is the real position of the lead anchor UE (e.g., pre-configured)), may obtain an enhanced differential positioning estimate by combining P and E_Lead since E_Lead is correlated with the error that the device UE 10 suffers. For instance, at time t:

$$P\_Corrected = P - E\_Lead$$

In the above description, all communication links may be based on the PC5 communication interface between two or more UEs.

In an embodiment that can be combined with any other embodiment or implemented independently related to RTT carrier phase based ranging between a device UE 10 and an anchor UE 14 (or wireless access device 20), the anchor UE 14 (e.g., a head anchor UE) (or wireless access device 20) transmits a positioning signal by using a well-defined carrier signal. The anchor UE 14 (or wireless access device 20) starts counting the number of carrier cycles CC.

The device UE starts retransmitting (a copy of) the received positioning signal or generates a (well-defined) carrier signal itself that it will transmit towards the anchor UE 14 (or wireless access device 20) as soon as it is received. The device UE 10 counts and may transmit the number CC_delay of carrier cycles that it took to start retransmitting the signal or to start transmitting its own generated carrier signal since it was first received. The anchor UE 14 (or wireless access device 20) stops its counter and reads the value of CC as soon as the signal from the device UE 10 has been received. The distance D between the device UE 10 and itself can then be obtained as

$$D = 0.5 * \{ CC - CC\_delay ) * λ$$

where λ refers to the wavelength of the carrier signal.

This embodiment can be enhanced by measuring not only the total number of wavelengths of the received carrier but also the phase of the carrier when the signal is received.

Moreover, the anchor UE 14 (or wireless access device 20) may need to wait the length of one carrier cycle to be able to correctly determine the signal returned from the device UE 10. Hence, the measured value of CC may probably be one carrier cycle too high at the time it can stop the timer, unless the signal can be recognized using a particular preamble. Therefore, a preamble may be used for recognizing the signal from device UE 10. Also, a preamble may be added to enable the device UE 10 to recognize the positioning signal for carrier-based ranging from the anchor UE 14 (or wireless access device 20).

In an embodiment that can be combined with any other embodiment or implemented independently, the device UE 10 and/or anchor UE 14 (or access device 20) may need to compensate for the length, placement and directionality of the antennas used for performing ranging measurements, in particular carrier-phase based ranging. For example in a car, an antenna may be quite long and/or placed quite far from the ranging receiving/measurement subsystem and/or ranging calculation signal subsystem and/or the subsystem creating and/or transmitting the ranging reference signal. The length of the respective antennas may need to be added to the distance D as per the above formula in case of carrier-phase based ranging or otherwise compensated for. Similarly, the distance between the transmitter unit of the ranging reference signal and the location of the antenna used for transmitting the signal and the distance between the ranging receiving/measurement subsystem and/or ranging calculation signal subsystem, may need to be added or otherwise compensated for. To this end, device UE 10 and anchor UE 14 (or access device 20) may exchange information through discovery message(s) and/or connection setup message(s) and/or ranging session initiation message(s) and/or configuration message(s) about antenna configuration, antenna ports (possibly together with information about the signals transmitted through those ports), antenna length, antenna placement/position relative to a reference coordinate, and/or orientation/angle/direction relative to a reference direction (which may be represented e.g. by vector in a coordinate system) or magnetic north. Information about the antenna port used for transmitting a signal may be encoded as part of a ranging reference signal.

In an embodiment related to carrier-sensing using multiple carriers that can be combined with any other embodiment or implemented independently, LTE vehicle-to-everything (V2X) communication can be used, which supports single-carrier frequency division multiple access (FDMA) and 10 MHz and 20 MHz channels. The channel is divided into 180 kHz resource blocks that include 12 subcarriers of 15 kHz each. In 5G R16 V2X, sidelink can operate in frequency range 1 (i.e., FR1, 410 MHz to 7.125 Ghz) and frequency range 2 (i.e. FR2, between 24.25 and 52.6 GHz). Transmissions can be done using orthogonal frequency division multiplexing (OFDM). The number of slots per subframe and the subcarrier for the OFDM waveform is flexible.

When considering carrier-phase based sensing, the usage of higher frequencies is advantageous in some situations, since the wavelength is shorter, and thus the error on the distance measurement can be lower. Furthermore, the usage of multiple carriers at different frequencies is advantageous. If multiple N carriers are used in the positioning signal transmitted at the physical layer, it is possible for the receiver to measure the received phase of each of the N carriers. Based on the N phase measurements, the receiver can transform N phase measurements at N frequencies into biased range measurements.

For instance, assuming a typical positioning reference signal (PRS), it can be observed that the PRS sequence r_{l,ns}(m) involves a transmission in certain subcarriers/symbols defined in 3GPP TTS 36.211 where ns is the slot number, and I is the OFDM symbol. At the start of each OFDM symbol a pseudo-random sequence is transmitted where the pseudo-random sequence generator is initialized based on the ns or the cell identity NCell-ID. Therefore, the PRS sequence depends on the frame/slot timing (ns,l) and the physical cell identity. It is worth noting that the cell-specific frequency shift is given by NCell-ID mod 6. Existing PRS sequences have an effective reuse factor of six. When a UE configures itself or is configured (e.g. by a managing entity) as an anchor UE and sends a PRS sequence, then it will have to choose or be given/configured with an identifier such that it does not collide with other nearby anchor UEs.

Furthermore, PRS sequences are transmitted in pre-defined positioning subframes grouped by several consecutive subframes named positioning occasions that occur periodically, e.g., every 160, 320, 640, or 1280 subframes (or milli-seconds), and the number of consecutive frames might be 1, 2, 4, or 6 (TS 36.211). Another existing parameter is the subframe offset which defines the starting subframe PRS transmission relative to SFN=0. Current positioning techniques perform positioning by identifying the whole PRS sequence.

In the following embodiment of carrier phase-based ranging, the receiver may first identify the PRS itself. This might be based on timing (in which frames and slots), frequency (in which carriers), identity (which identity is used to generate the pseudo random sequence), duration (how many frames are used to transmit a PRS), and periodicity (every how many frames is a PRS transmitted). Since anchor UEs do not have a cell identifier as base stations, the UEs might use, e.g., a randomly chosen identifier in the generation of the pseudo random sequence. The PRS used by an anchor UE might also be determined by the managing entity. The managing entity might also configure an anchor UE with a policy determining the preferred PRS parameters or PRS signal, including alternative PRS signals in case, e.g., the preferred PRS signal is used by a different nearby anchor UE. Furthermore, in the case of carrier-phase based ranging, the receiver senses the received phase of each of the carriers at each of the symbols/resource elements used in the PRS signal. For instance, at the start of a used symbol. Since not all subcarriers are received simultaneously because of the way the PRS is defined, the receiver can measure the phase of different carriers at different points of time, and derive (due to the periodicity of the subcarriers) the received phase for all the carriers as if they were received at the same time. The receiver can map those measured phases for the different subcarriers to a range measurement.

It is worth noting that since multiple carriers are used, a UE might not require all of them. For instance, it might be enough for the UE to monitor only N′ subcarriers, e.g., the first N′ subcarriers of the PRS signal to achieve a suitable accuracy. The value N′ might be configured by the managing entity. Furthermore, reducing the number of subcarriers that require tracking helps reducing the delay as well as energy consumption to obtain a ranging measurement and transmitting possible ranging related measurements.

Moreover, it is worth noting that if N′ subcarriers are enough, then an approach might be to perform a measurement every N′*symbol_time seconds to obtain a measurement if the carriers used for carrier phase-based ranging/positioning are chosen to be next to each other. For instance, if N′=6, it is possible to perform a measurement with the first six subcarriers and a second measurement with the next six subcarriers.

An alternative is to have, e.g., an alternating allocation. For instance, subcarriers i=2n with n=1, . . . , N′ are used for a measurement and subcarriers i=2n+1 with n=1, . . . , N′ are used for a second measurement. This spacing has the advantage of assigning the carriers in a more uniform manner. On the other hand, if the PRS is transmitted in a continuous manner, the ranging estimation could also be updated every time a new symbol using a new suitable carrier is received by using a window approach where the window keeps track of the last N′ received suitable subcarriers. This allows reducing the delay to a single symbol time duration.

### Other Aspects

According to an embodiment that can be combined with any other embodiment or implemented independently, an alternative to determine the angle between two UEs which might be useful, e.g., in a remote control/TV scenario, requires the anchor UE to transmit sidelink synchronization signal blocks (SSSBs) through different beams. The UE can measure the received signal strength of each of the (SSSBs) of the anchor UE. The measurement can be used to determine the angle. For instance, a TV might embed an anchor UE with an antenna featured by five beams: beam 1 perpendicular to the plane of the TV, beam 2 with a 45 upwards angle, beam 3 with a 45 downwards angle, beam 4 with a 45 angle to the left, and beam 5 with a 45 angle to the right. The UE can measure the change in the signal strength of the SSSBs of the anchor UE while the user, e.g., presses a button. The change in the received signal strength of the SSSBs is used to obtain, e.g., in which direction the user is moving the UE. Note that in this case, the button press on the UE by the user can trigger a request sent over the PC5 interface to transmit synchronization or positioning signals, in this case, SSSBs. The measurements might be sent back from the UE to the anchor UE over the PC5 interface.

In an embodiment that can be combined with any of the previous embodiments or implemented independently, the UE can request anchor UEs to temporally transmit positioning signals. The reason is that existing PRS signals transmitted by base stations follow a low frequency periodic pattern. However, many ranging scenarios might require the transmission of PRS signals at a higher frequency during a short period of time, as in the above example with the remote control (UE) and TV (anchor UE). In this case, the UE might send a resource scheduling request to an anchor UE over the PC5 interface requesting the transmission of positioning signals. The (lead) anchor UE might perform the resource allocation and coordinate the resource allocation with surrounding anchor UEs. For instance, it might choose PRS identifiers for the anchor UEs in such a way that they do not lead to interferences.

### Process for Ranging-Based Positioning Services

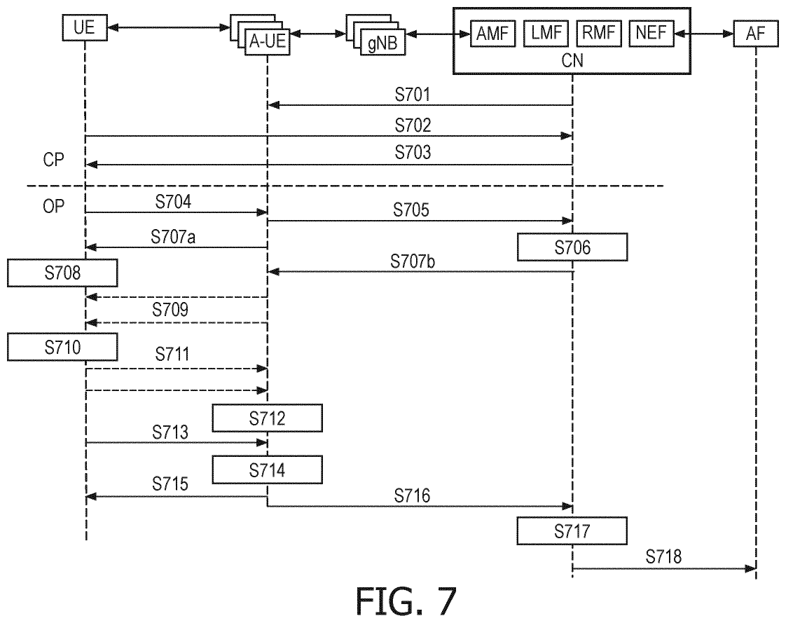

FIG. 7 schematically shows a signaling and processing diagram for ranging-based positioning services, that summarizes the multiple operation options based on the above embodiments. In this diagram, exchange of information and its direction is indicated by a corresponding arrow and processing steps are indicated by respective blocks, while the time proceeds from the top to the bottom of FIG. 7. The places where the processing steps take place or the start and end points of the information exchanges are indicated by the vertical dotted lines below the respective system component. Not all the steps might always be required and some steps might be executed multiple times for increased accuracy or continuous ranging-based positioning.

In an initial configuration step S701, the CN configures the anchor UEs (A-UE) as such, this may include forwarding control information for configuring e.g. discovery parameters, ranging constellation identifier(s), positioning signals and parameters, and/or positioning techniques. The anchor UEs might also be configured at this step with their specific location. This location might also be known (only) to the CN. Then in a subsequent step S702, the device UE sends to the CN a request to use/subscribe to a ranging-based positioning service. In response thereto, the CN checks whether the device UE is authorized to use this service, and if so, it provides the device UE in step S703 with e.g. discovery parameters, positioning signal parameters, and/or (preferred) ranging methods to use. Similarly, the CN may also check whether the anchor UEs are authorized to be involved in the ranging of the device UE. This step finishes an initial configuration phase (CP).

Now, an operational phase (OP) starts with step S704, where the device UE sends a discovery message to anchor UEs to request ranging services. This message may be a restricted discovery message (e.g., ProSe Model B Solicitation) or may be skipped in ProSe Model A, or may be a ProSe Model A Announcement where the device UE requesting ranging services plays the role of an announcing UE. Note that by the time this message is sent by the device UE, the device UE might have first received sidelink synchronization signals that allow it to become synchronized to the anchor UEs.

The anchor UEs may collect the presence of the received discovery or connection setup or ranging session initiation message(s), and/or information from these message(s) (e.g., UE identity information, ranging capabilities, timing information, signal strength information) and send it to the CN in step S705. In an example, the lead anchor UE may send a combined report on behalf of the anchor UEs. Alternatively, each anchor UE may send the received messages that are aggregated in the CN.

In step S706, the CN may estimate the location (e.g. a rough initial estimate) of the device UE based on the (combined) report(s) received in step S705 and the locations of the anchor UEs. Alternatively, the CN may perform an initial estimate of the location of the device UE based on anchor UE report message(s) received in step S705. Depending on the accuracy of the estimated position, the CN may indicate (cf. step S707b) a need for more accurate ranging measurements between anchor UE(s) and the device UE, e.g., PRS based ranging estimates in subsequent steps. In this step, the CN may also verify/obtain the authorization and/or user consent for using the ranging-based positioning service to determine the location of the device UE and/or whether the anchor UE(s) are authorized to be involved in this.

In step S707a, the anchor UEs may reply to the device UE with a response message when a ProSe restricted discovery model B has been used. This message may also indicate that the anchor UEs are configured as announcing UEs and use ProSe Announcement discovery messages (model A). The discovery messages may be used (e.g., directly) for ranging purposes by the device UE or may be used to transmit configuration data required by the device UE to perform ranging in subsequent steps (e.g., if the device UE is out of range and initially lacks positioning parameters sent by the anchor UEs) and/or perform an initial position estimate (e.g., in case some or all of the messages contain location coordinate information of the respective anchor UE).

As an option, a further step 707b can be used, by means of which the CN sends an indication about the achieved or required accuracy to the anchor UEs. Depending on this indication from CN, the anchor UE can (re-)configure the ranging procedure, e.g., the transmission of PRS signals for ranging-based location estimation. This might imply that the ranging messages in steps S704-S715 might be exchanged longer or shorter or more often and/or with different signal characteristics. This might also imply that the anchor UEs skip the ranging procedure (steps S709 to S717) if the accuracy obtained in step S706 is already sufficient. If this optional step S707b is not present, then the usual flow of ranging steps S709 to S717 is followed.

In step S708, the device UE may obtain an initial range/location estimation based on the messages received from anchor UEs in step S707a, and potentially combined with (the timing and contents of) the message sent in step S704. The messages of steps S704 and S707a might be exchanged multiple times to increase the accuracy.

It is noted that if there are multiple anchor UEs that had responded to the device UE in step 707a, and some or all of the response messages contain location coordinate information of the respective anchor UEs, then the device UE can estimate its location based on these messages received in step S707a by triangulation/trilateration.

In step S709, the anchor UEs may send one or more positioning signals that are received by the device UE. Then, in step S710, the device UE may be able to perform an estimation of its range/location based on the positioning signals received in step S709. In case an initial estimation was made in step S708, the estimate of step S710 may improve the accuracy of the initial estimate.

Alternatively or in combination with the previous step S709, the device UE may also send in step S711 positioning signals that may be received/measured by the anchor UEs. A lead anchor UE may be in charge of collecting these measurements of the anchor UEs.

It is noted that the UE might also use other (types of) signals (e.g., Sounding Reference Signals (SRS signals), or Channel State Information Reference Signals (CSI-RS)) or multiple types of positioning signals in a channel as prescribed by or requested by an anchor UE for more precise ranging measurement.

In step S712, the lead anchor UE may obtain the location/range of the device UE, locally, based on the positioning signals received by the lead anchor UE and/or one or more other anchor UE(s).

In step S713, the device UE may send measurements and/or calculated distances/angles/positions to one or more of the anchor UEs based on the exchanged discovery message(s) or positioning signals.

Then, in step S714, the lead anchor UE may obtain the location/range of the device UE, locally, based on the reported measurements and/or calculated distances/angles/positions of step S713. In case the location/range of the device UE was already locally determined in step S712, this may be an improved estimate based on the additional information provided by the reported measurements in step S713.

If the lead anchor UE computes the location/range of the device UE, the lead anchor UE may send this information in step S715 to the device UE. Similarly, if another anchor UE computes its distance to the device UE it may send this information in step S715 to the device UE as well.

Furthermore, in step S716, the lead anchor UE (or any other anchor UE or ranging capable UE or relay device) may send the received measurements to the CN which then estimates the location/range of the device UE in step S717. Typically, the lead anchor UE would send these measurements directly via an access device when it is in coverage, but it may delegate this task to another UE of the ranging constellation, or it may send these measurements indirectly via a relay device (e.g., ProSe UE-to-Network Relay UE), when out of coverage.

Finally, in step S718, the CN may export the ranging/position information to an external application function (AF) after authentication and authorization of the AF.

Ranging Constellation Management (Specific for this Patent Application)

In the following, different ranging constellation management embodiments are described with reference to FIGS. 8 to 11, and 13. Note that FIGS. 8, 9, 11, and 13 show signaling and processing diagrams (similar to FIG. 7) where exchange of information and its direction is indicated by a corresponding arrow and processing steps are indicated by respective blocks, while the time proceeds from the top to the bottom. The places where the processing steps take place or the start and end points of the information exchanges are indicated by the vertical lines below the respective system component. Not all the steps might always be required and some steps might be executed multiple times for increased accuracy or continuous ranging-based positioning.

FIG. 8 schematically shows a signaling and processing diagram for a configuration process of (an) anchor UE(s) (A-UE) triggered by a managing entity (ME) according to an embodiment.

In step S801, the managing entity (e.g., LMF 34, RMF 36, a configuring anchor UE handled by an installer, a base station device (e.g., gNB) either directly or via the core network, or a user through a third-party AF) identifies a list of anchor UEs in a target area to be configured as a ranging constellation and creates a request to form a ranging constellation. This may also be done by an end user, once subscribed. For instance, a service in which the user registers for a service of localization/ranging and uses its mobile device (e.g., UE) to determine the devices that will act as anchor devices. The configuration may then be uploaded to the base station device (e.g., gNB) or core network (e.g., network controller), for example to the RMF 36.

The identification of the anchor UEs may be based on an installation list gathered by an installer or commissioner and entered into the system at a later point of time. Alternatively, the role and identity of an UE may be predefined prior to deployment. An installer may then read that identity, e.g., from a QR code or an ID on the package or subscriber identity module (SIM) and link it to the location where the anchor UE has been installed.

Upon identification of these anchor UEs, the managing entity communicatively couples with the identified anchor devices to initiate a configuration of the identified anchor devices to participate in a ranging constellation. To achieve this, the managing entity sends in step S802 a configuration message which may include, among others, properties of the ranging constellation such as the constellation ID, size of the constellation, maximum and minimum number of devices in the constellation, sampling rate of ranging measurements within the constellation etc. Depending on the method used, each anchor UE may also be informed about its exact location, as well as its position (either absolute or relative) to each other.

As an optional measure, since the constellation information may be continuously changing due to the mobile nature of the anchor devices, it may need to be updated for any changes in the list of mobile anchor devices leaving or entering the target ranging area of the ranging constellation. To achieve this, the managing entity may identify and track the location of the constellation and its anchor devices by tracking the location of at least one of the anchor UEs in step S803.

Note that a ranging constellation may cease to exist if the total number of anchor UEs in the constellation falls below a minimum number of anchor UEs required to maintain that constellation. The ranging constellation may be respawned if the minimum number of anchor UEs needed to spawn the constellation is reached again. In this case, the identity of the constellation may be changed every time it is respawned. Alternatively, the constellation may retain its identity when the same anchor UEs or a subset thereof are used to respawn the constellation.

It is noted that in this and the following embodiments, the exchange of commands and data may be done in a secure way, i.e., offering confidentiality, authenticity, and integrity. A secure exchange of commands and data is advantageous in that information is not leaked leading to a privacy risk or that users are authorized before using a service.

FIG. 9 schematically shows a signaling and processing diagram for a configuration process of (an) anchor UE(s) triggered by a user device (e.g., UE) according to an embodiment.

In step S901, a UE can initiate the formation of a ranging constellation by first subscribing/connecting to a ranging or positioning service in the area and request to assist the managing entity (e.g., a base station or other network device or function) in the formation of a ranging constellation. The subscribing/connecting may be done by requiring the ranging or positioning service to provide indications to the UE about the distance to certain objects in the environment. In an example, the desired ranging or positioning service may be identified by the UE, e.g., as a code in a positioning signal transmitted over a PC5 interface or by means of a relay service code, service identifier or application code exchanged over the PC5 interface in a discovery message or direct communication request or other PC5-S message, or e.g. as a service request or other NAS message over Uu.

Then, in step S902, the UE identifies a total number of ranging capable anchor UEs in the vicinity and devices that are in a position to act as anchor nodes by monitoring the ranging service identifiers transmitted by different anchor UEs.

In a subsequent step S903, a preliminary configuration can be created by the UE, based on available information about the other devices in the vicinity, and forwarded in step S904 to a managing entity (ME) in order to assist in the ranging service to form a ranging constellation.

In another embodiment, an anchor UE may be designated as a head anchor device of a ranging constellation for a given target area.

Such a head anchor device of the ranging constellation may be configured to acts as a calibration node which can communicatively couple with other (anchor) UEs to perform a calibration procedure for a newly joining (anchor) device and/or recalibration of the ranging constellation when an anchor device leaves the constellation, and/or to handle the constellation configuration in coordination with the managing entity, and/or to exchange ranging measurements with the RMF through, e.g., a base station device (e.g., gNB), so that the overall energy consumption of all anchor UEs can be reduced.

Exemplary criteria for the selection of an anchor UE as head anchor UE may be that the anchor UE is relatively immobile and/or has a highest number of devices with a respective ranging measurement result (e.g., a distance between two devices or an angle formed in line of sight of two devices) and/or has the highest amount of remaining battery life.

Based on at least one of these criteria, the head anchor UE may also be reselected, e.g., every unit of time, a set of conditions is re-evaluated and the anchor UE with the highest score becomes the head anchor UE. In an example, the current head anchor UE may keep computing and storing its score. If the score falls below a certain (predefined or preconfigured) threshold score, it may trigger an overall score computation in all anchor UEs. The anchor UE with the highest score is selected as the head. The threshold may be an absolute or relative value compared with the threshold score, e.g., 90% of the score value when an anchor UE was selected as head anchor UE.

In a further example, a ranging constellation may cease to exist if the current head anchor UE loses its capacity to act as the head anchor UE of the ranging constellation, for example by failing to meet at least one of the above criteria and there are no other anchor UEs in the vicinity to maintain the ranging constellation.

FIG. 10 schematically shows a flow diagram of a configuration monitoring process according to an embodiment, which may be performed (e.g., by the head anchor UE or at least some of the anchor UEs and/or by the managing entity or a UE in the ranging constellation) to monitor integrity of a ranging constellation.

An illustrative example of such a use case may be a V2X scenario in which a vehicular ad-hoc network may include multiple vehicles, e.g., on a motorway, interested in computing their mutual ranges. In particular, a first UE (car) may want to determine the range and direction, or relative location, of other UEs (cars) around it. The set of other cars used to compute the range may be considered as a ranging constellation with the first car as head anchor UE. A UE computing its range/location with regard to other UEs may need to monitor and maintain the integrity of its ranging constellation: as traffic progresses, some cars will move out of range and others will come in range. Thus, it will be interested in monitoring and maintain the integrity of its ranging constellation. Note that this scenario illustrates a scenario in which the ranging constellation is mobile, relatively stable but liable to change over time. Other scenarios may involve a ranging constellation that is stable and not mobile.

In step S1001, measurements, e.g., mutual ranging measurements of anchor UEs with other devices within the target area of the ranging constellation are performed to mutually identify and establish or verify the operational area of the constellation.

The goal of performing the ranging measurements may be to ensure that positions and/or ranging estimates of the anchor UEs have not changed over time. This may happen if e.g. anchor UEs are attached to certain objects that could be moved (e.g., shelves in a supermarket), or move (e.g., cards), or objects are placed among them leading to an obstruction of the line of sight, and therefore, potentially influencing the (accuracy of) ranging measurements.

Alternatively, for a mobile constellation, the goal of performing the ranging measurements may be to update the relative positions of vehicles within the constellation and to note which vehicles go out of range of the constellation and to discover new vehicles that come in range of the constellation.

In step S1002, the mutual ranging measurements of the anchor UEs are compared against expected values retrieved, e.g., during configuration or previous mutual ranging measurements or iterations.

The anchor UEs/UEs may continuously repeat the mutual ranging measurements and subsequent comparisons, e.g., on a regular basis.

In an example, mutual ranging measurements between each pair of anchor UEs taken at an instant of time may be denoted as a ranging state RS(n). If there are k anchor UEs/UEs, the ranging state can be expressed as a vector including (k−1)k/2 ranging values. Thus, for k=3, 4 or 5, the ranging state vector includes 3, 6 or 10 ranging values, respectively. This ranging state should remain stable over time.

In step S1003, it is checked whether the stability of the ranging constellation is sufficient.

An exemplary criterion for stability may be expressed by the following condition:

$$‖ RS ( n ) - RS ( n + k ) ‖ < delta , \qquad ( 1 )$$

wherein “∥*∥” may mean the norm (e.g., norm 1, or norm 2) of the ranging state vector, delta is a selected (e.g., based on (pre)configuration information) threshold value and k is a selected (e.g., based on (pre)configuration information) integer value (e.g., k=1). In general, it describes a function f( ) that takes as input previous and new measurements and determines whether the ranging constellation is stable enough to provide a reliable result, e.g., by comparing it with a given threshold:

F(RS(n),RS(n+k))<delta
If the above condition (1) is not fulfilled for the ranging constellation, an alarm may be triggered (e.g., by the head anchor UE or the managing entity or the UE). This may trigger an alarm (outlier) and/or the procedure jumps back to step S1001 and the ranging measurements and comparisons are repeated.

If all the anchors UEs in the ranging target area of the ranging constellation have performed ranging measurements and stability has been confirmed in step S1003 (e.g., the above condition (1) is fulfilled), it is determined in step S1004 that the ranging constellation is fully formed and/or that the ranging constellation is stable enough to keep using it.

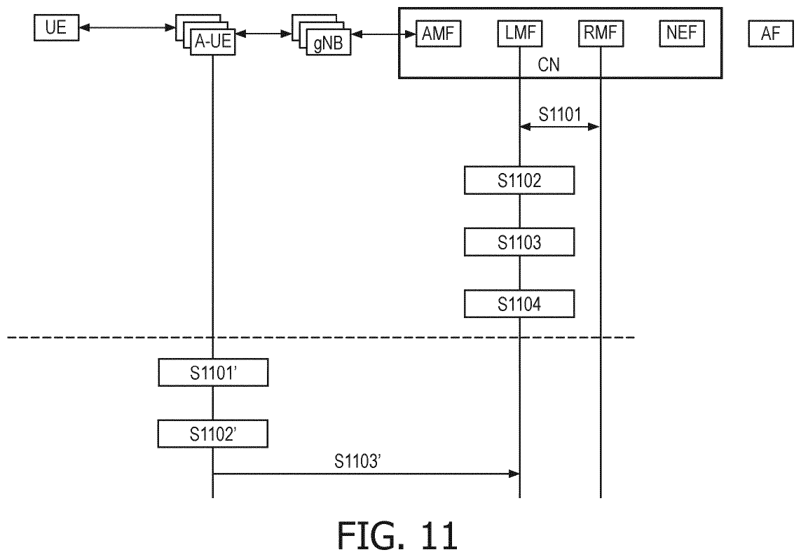

FIG. 11 schematically shows a signaling and processing diagram for a centralized configuration management process for anchor UEs (A-UE) that are capable of being used in a ranging constellation, according to alternative embodiments, the first embodiment is shown above the dotted horizontal line and the alternative second embodiment is shown below the dotted horizontal line.

In the first embodiment, the LMF of the core network (CN) communicatively couples in step S1101 with the RMF of the CN and identifies ranging capable UEs as potential anchor UEs in step S1102. Then, the LMF analyses identities of potential anchor UEs that are capable of using ranging measurements and obtains their location coordinates in step S1103. Finally, the LMF creates in step S1104 a provisional ranging constellation of potential anchor UEs. If measurements are available, metadata such as timestamps or positioning signal features (RTT, signal strength, etc.) are considered to create the provisional ranging constellation and thereby assist a ranging or location service.

In the alternative second embodiment, the anchor UEs may perform in step S1101′ ranging measurements amongst themselves to identify the proximity among known devices of the ranging constellation, and only update the location information in step S1102′ if there is a change in the devices in terms of proximity and/or the ranging distance between the anchor UEs, that is larger than a predetermined threshold which has been set or configured by the LMF. In step S1103′, the anchor UEs send a message with the updated location information to the LMF if a location change has been detected.

In an example, the anchor UEs may perform step S1103′ repeatedly to periodically update their location data to the LMF, e.g., proportional to the velocity of their movement. The number of updates in step S1103′ may be determined to ensure that the positional error does not exceed a predetermined value (e.g., x cm). Note that a UE might send a single message even if it is moving very fast if the UE knows that it is moving according to a constant speed vector. Namely, the UE only needs to transmit its current location and speed vector.

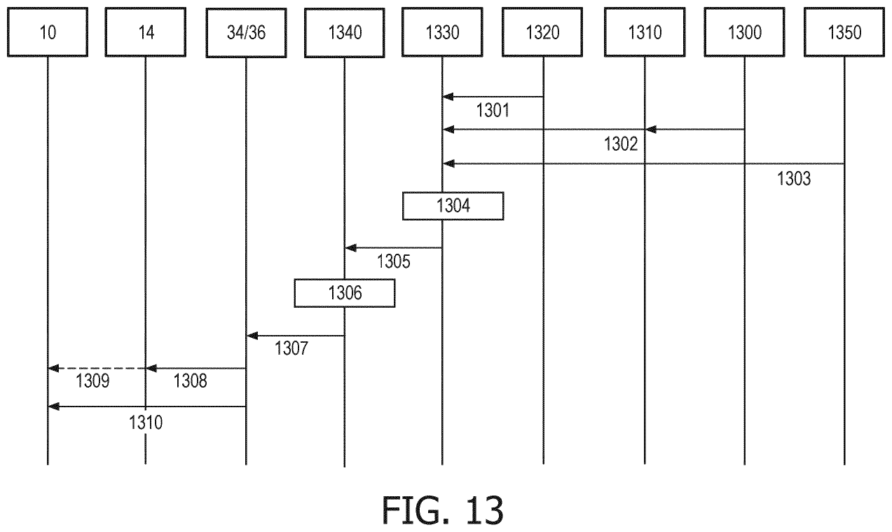

FIG. 13 schematically shows a signaling and processing diagram for a configuration process of a managing entity (ME) according to an embodiment.

In an embodiment, a managing entity (e.g. LMF 34 or RMF 36) receives information about ranging constellations in an area from an external application 1300 or an LCS client 1320 (e.g. as specified in TS 23.273) or another core network 1350. Such information would typically consist of at least one or more lists of identifiers (e.g. Generic Public Subscription Identifier (GPSI)) of Anchor UEs (also known as Reference UEs or Located UEs) whereby each list constitutes a ranging constellation. Such list of Anchor UEs may be known by the external application or LCS client, and/or may be a preferred set of Anchor UEs and/or may be part of a trusted group/domain of Anchor UEs (e.g. that share same/similar group/domain credentials that may be used to protect message exchanges between the UEs that are part of the ranging constellation or authorization token(s) through which (if needed) a UE may be able to prove to other UEs of a ranging constellation that it is part of the same ranging constellation if it can provide a proof of possession of the group/domain credentials or authorization token (e.g. by transmitting a correct response to an authentication/authorization request, or transmitting a correctly signed token/message)). To this end, the ranging constellation information may include group/domain credentials or authorization token(s), and/or may contain information on how to identify Anchor UEs (or Target UEs) that may (temporarily) join the ranging constellation (e.g. a Closed Access Group identifier indicating a Closed Access Group (e.g. operated by a Non-Public Network) or Non-Public Network identifier or (private) Network Slice identifier that an Anchor UE has access to). The ranging constellation information may also contain additional information such as (last known) location information of such UEs, capabilities of these UEs, area related information of one or more constellations (e.g. geographical area, or list of tracking area identifiers or cell ids of nearby base stations), ranging constellation identifier(s), information about serving AMFs or serving LMFs (or other MEs) or preferred ME, application layer identifiers), and may also contain information about a set of target UEs that may be served by the ranging constellation and that hence may e.g. (temporarily) join the trusted group/domain (e.g. indicated by a set of target UE identities provided by an application, and/or by a Closed Access Group identifier indicating a Closed Access Group (e.g. operated by a Non-Public Network) or Non-Public Network identifier or (private) Network Slice identifier that a target UE has access to). This information may include a set of network identities (e.g. PLMN IDs) that indicate which home network that a Target UE is subscribed with/belongs to are allowed or not allowed to be served by that ranging constellation, i.e. whether the ranging using Anchor UEs of a ranging constellation can be performed for a visiting/roaming Target UE that is subscribed/belongs to a different PLMN than the serving network of one or more Anchor UEs of the ranging constellation. Similarly, the information may include a set of network identities (e.g. PLMN IDs) that indicate which home network that an Anchor UE is subscribed with/belongs to is allowed or not allowed to operate in a ranging constellation in a visiting network, if the Anchor UE is roaming/visiting a different network than its home network. In step 1301 an LCS client may provide information about ranging constellations as part of a location request for a target UE to a Gateway Mobile Location Centre (GMLC) 1330 (e.g. as specified in TS 23.273) or as a separate message. Alternative or additional to step 1301, in step 1302 an external application/Application Function may provide information about ranging constellations to the GMLC 1330, e.g. by sending a message to the Network Exposure Function (1320). The NEF may forward the ranging constellation information to one or more GMLCs. Alternative or additional to step 1302, in step 1303 another core network may provide ranging constellation information to this core network (e.g. through its GMLC communicating via the NL3 reference point (as specified in TS 23.273 and which may need to be extended for this purpose) with the GMLC of the other network). It is important a Home Network (e.g. HPLMN that owns/operates the subscription of the respective UE) of a Target UE or Anchor UE used for ranging configures any visiting/roaming/partner Core Networks that a UE may use (e.g. VPLMNs) with ranging related configuration information, including information about ranging constellations, since for ranging/sidelink positioning typically the AMF, LMF (or RMF) and GMLC of the serving/visiting network (e.g. VPLMN). Alternatively or additionally, the AMF (in a visiting network) to which a visiting Target UE or visiting Anchor UE registers may contact the Home Network of the visiting UE to request ranging configuration information (which may include ranging constellation information) from the home network of the visiting UE (e.g. through the GMLC communicating of the visiting network communicating with the GMLC of the home network of the visiting UE), whereby such request may include identity information of a Target UE or Anchor UE or area information (e.g. a set of tracking area identities, cell-IDs). The AMF may perform such request and receive the ranging configuration information (which may include ranging constellation information) from the home network of the respective UE before it selects the LMF for that UE (e.g. to make sure that it selects the same LMF for all UEs (e.g. as part of a ranging constellation) that may be involved in ranging of a target UE), and also send the received information to the selected LMF that may use the ranging constellation information and other information to configure the UEs for ranging.

In step 1304, the GMLC selects an AMF based on the received information about the ranging constellations, for example by requesting another core network function (e.g. UDM) using an identifier of the one or more Anchor UEs to provide information about which AMF the respective UE with the given identifier is registered after which information about the respective AMF gets returned to the GMLC, or by using provided location information of one or more Anchor UEs, or area information of the constellation to select an AMF that serves the respective location(s)/area(s) or that may serve the respective location(s)/area(s). Alternatively, the GMLC selects all registered or known AMFs of the core network or of partner core networks. In step 1305, the GMLC sends the information about ranging constellations to the selected AMF(s), e.g. over the Namf interface. In step 1306, the AMF selects one or more LMFs (or other MEs) based on the received ranging constellation information, for example the AMF selects an LMF (or other MEs) that serves one or more (or most or all) of the UEs of the one or more received ranging constellations, e.g. based on whether the area or location information provided in the ranging constellation information is within the Service Area of the LMF (or other ME) or based on whether one or more of UEs is already served by the LMF (or other ME). The AMF may also select one or more other LMFs (or other MEs) for which the ranging constellation information could be relevant, such as LMFs (or other MEs) with partially overlapping service area or the LMF (or other ME) that is currently known to serve the target UE or other UEs in the area. In step 1307, the AMF provides the ranging constellation information to the selected LMF(s) 34 or RMF(s) 36 (or other MEs) e.g. over the Nlmf interface. The LMF 34 or RMF 36 (or other ME) that received the ranging constellation information, can use it to configure Anchor UEs 14 and/or target UE 10, invite Anchor UEs 14 of a constellation to take part in the ranging of a target UE, and/or perform ranging or sidelink positioning as described in other embodiments. In step 1308, the LMF 34 or RMF 36 (or other ME may provide information related to the ranging constellation(s) to one or more Anchor UEs 14 that may be part of the constellation. The Anchor UE 14 may use this information for discovery and connection setup with another Anchor UE of a constellation or Target UE, configure other Anchor UEs 14 or a Target UE 10, invite other Anchor UEs 14 of a ranging constellation and/or perform ranging or sidelink positioning as described in other embodiments (e.g. by providing a proxy of the LMF). Note that before sending the ranging constellation information to the one or more Anchor UEs 14, the LMF may determine a set of different identifiers (e.g. ranging service specific identifiers, application specific identifiers, temporary identifiers, user info IDs, or restricted prose identifiers (e.g. retrieved from a Discovery Name Management Function (DDNMF)) that may be used for discovery and/or connection setup between ranging capable UEs). In step 1309, the Anchor UE 14 provides (e.g. by forwarding or by creating a separate message) information related to the ranging constellation(s) to the Target UE 10. Similarly, in step 1310, the LMF may provide information related to the ranging constellation(s) to the Target UE 10. Note that before sending the ranging constellation information to the Target UE 10, the LMF may determine a set of different identifiers (e.g. ranging service specific identifiers, application specific identifiers, temporary identifiers, user info IDs, or restricted prose identifiers (e.g. retrieved from a Discovery Name Management Function (DDNMF)) that may be used for discovery and/or connection setup between ranging capable UEs). The Target UE 10 may use the information received in steps 1309 or 1310 for discovery and connection setup with one or more Anchor UEs of a ranging constellation to take part in the ranging of the target UE, and/or perform ranging or sidelink positioning as described in other embodiments (e.g. by calculating a position itself or by providing measurements or calculated distance/angle/location information to the LMF).

In a further embodiment, one or more anchor UEs in a ranging constellation may be configured with security keying materials that allow them to provide a source authenticity proof to (out-of-coverage) device UEs making use of the ranging or ranging-based positioning service. Such a source authenticity may ensure, e.g., that a malicious device UE that has access to the service cannot fake the configured parameters or positioning signals distributed by anchor UEs 14. In a particular example, the messages transmitted by the anchor UEs may be signed or protected as in Solution #43 in 3GPP TR 33.847.

The proposed integrity checking of the above embodiments may as well be applied to performing measurements in a pairwise manner by base station devices (e.g., gNBs), base station devices (e.g., gNBs) that rely on anchor UEs placed at fixed locations (e.g., PRUs), or performing integrity measurements on positioning signals of the base station device (e.g., gNBs).

To summarize, a wireless system and methods for managing and/or configuring ranging capable devices to form a ranging constellation to support ranging-based positioning services have been described, including multiple challenges in improving configuration and management of the ranging constellation.

While the invention has been illustrated and described in detail in the drawings and foregoing description, such illustration and description are to be considered illustrative or exemplary and not restrictive. The invention is not limited to the disclosed embodiments. The proposed enhanced ranging-based positioning services can be implemented in all types of wireless networks, e.g. it can be applied to devices communicating using cellular wireless communication standards, specifically the 3^{rd} Generation Partnership Project (3GPP) 5G and New Radio (NR) specifications. The 5G wireless communication devices can be different types of devices, e.g. mobile phones, smart watches, smart tags for location tracking and logistics, vehicles (for vehicle-to-vehicle (V2V) communication or more general vehicle-to-everything (V2X) communication), V2X devices, IoT hubs, IoT devices, including low-power medical sensors for health monitoring, medical (emergency) diagnosis and treatment devices, for hospital use or first-responder use, virtual reality (VR) headsets, etc.

Although some embodiments are described for ProSe relay and sidelink communication, the invention also applies to other types of relay devices, such as (smart) repeater devices, Integrated Access and Backhaul (IAB) nodes, or Wi-Fi Mesh APs.

Furthermore, the invention can be applied in medical applications or connected healthcare in which multiple wireless (e.g. 4G/5G) connected sensor or actuator nodes participate, in medical applications or connected healthcare in which a wireless (e.g. 4G/5G) connected equipment consumes or generates occasionally a continuous data stream of a certain average data rate, for example video, ultrasound, X-Ray, Computed Tomography (CT) imaging devices, real-time patient sensors, audio or voice or video streaming devices used by medical staff, in general IoT applications involving wireless, mobile or stationary, sensor or actuator nodes (e.g. smart city, logistics, farming, etc.), in emergency services and critical communication applications, in V2X systems, in systems for improved coverage for 5G cellular networks using high-frequency (e.g. mmWave) RF, and any other application areas of 5G communication where relaying is used.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated. Moreover, it will be understood by those skilled in the art that, in general, terms used herein, and especially in the appended claims, are generally intended as “open” terms, e.g., the term “including” should be interpreted as “including but not limited to,” the term “having” should be interpreted as “having at least,” the term “comprises” should be interpreted as “comprises but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

A single unit or device may fulfill the functions of several items recited in the claims. The mere fact that certain measures are recited in mutually different dependent claims does not indicate that a combination of these measures cannot be used to advantage.

The described operations like those indicated in FIGS. 7 to 11 can be implemented as program code means of a computer program and/or as dedicated hardware of the commissioning device or luminaire device, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A device comprising:
a processor circuit and a memory circuit, wherein the memory is arranged to store instructions for the processor circuit,
wherein the processor circuit is arranged to configure at least one ranging capable devices so as to form at least one anchor devices of a ranging constellation,
wherein the at least one anchor devices acts as a proxy for a positioning service provided in a geographical area; and
wherein the processor circuit is arranged to support the positioning service using ranging measurements with respect to a the target mobile device obtained from the ranging constellation.

2. The device app of claim 1,
wherein the processor circuit is arranged to create and maintain a provisional ranging constellation of anchor devices directly or via a core network,
wherein the processor circuit is arranged to forward the provisional ranging constellation to a managing entity so as to support formation of the ranging constellation.

3. The device of claim 1, wherein the processor circuit is arranged to communicatively couple with an identified anchor device so as to initiate a configuration of the identified anchor device so as to participate in the ranging constellation.

4. The device of claim 1, wherein the processor circuit is arranged to initiate a formation of the ranging constellation by subscribing to a ranging or positioning service in the geographical area and requesting assistance in the formation of the ranging constellation.

5. The device of claim 1,
wherein the processor circuit is arranged to configure a first anchor device as a head anchor device,
wherein the head anchor device is arranged as a calibration node that can communicatively couple with other network devices so as to perform a calibration procedure of the ranging constellation for a newly joining anchor device.

6. The device of claim 1, wherein the processor circuit is arranged to configure the at least one ranging capable devices by assigning security keying materials and discovery information.

7. The device app of claim 1,
wherein the processor circuit is arranged to to perform centralized management of the ranging constellation by analyzing identities of ranging capable devices so as to retrieve location coordinates or initiating ranging measurements among anchor devices of the ranging constellation so as to identify a proximity between the anchor devices
wherein the processor circuit is arranged to update location information of the ranging constellation if there is a change in proximity and/or the ranging distance between the anchor devices of the ranging constellation.

8. A device comprising:
a processor circuit and a memory circuit, wherein the memory is arranged to store instructions for the processor circuit,
wherein the processor circuit is arranged to determine whether or not a ranging constellation is established or is suitable for ranging/localization by monitoring an integrity of the ranging constellation,
wherein the processor circuit is arranged to provide a desired operational area of the ranging constellation based on the establishment or suitability of the ranging constellation.

9. The apparatus of claim 8,
wherein the processor circuit is arranged to identify a list of the ranging capable devices to be configured as the ranging constellation,
wherein the processor circuit is arranged to create a request to form or maintain the ranging constellation,
wherein the identification of the ranging capable devices is based on an installation list provided by a wireless network and/or a mobile device or a role and identity of a network device or a feature of the ranging capable devices or a context of the ranging capable devices.

10. The apparatus of claim 8, wherein the processor circuit is arranged to initiate or perform ranging measurements between anchor devices and/or a target mobile device of the ranging constellation in at least one of a target operational area, a configurable time interval or a set of devices in a given context.

11. The apparatus of claim 10,
wherein the processor circuit is arranged to determine if the ranging measurements are integral to the target operational area of the ranging constellation based on the ranging measurements between the anchor devices,
wherein ranging measurements are obtained from a ranging service or from a location service.

12. The apparatus of claim 10,
wherein the processor circuit is arranged to apparatus is adapted to determine that the ranging constellation is established,
wherein the processor circuit is arranged to communicate the determination to a ranging service at a mobile device and/or a base station device and/or a core network of a wireless network when the ranging measurements within the target area are completed within the configured time interval and the integrity of the ranging measurements did not change beyond a configured threshold of the ranging constellation within the configured time interval.

13. (canceled)

14. (canceled)

15. (canceled)

16. (canceled)

17. A method comprising:
configuring at least one ranging capable devices so as to form at least one anchor devices of a ranging constellation, wherein the at least one anchor devices acts as a proxy for a positioning service provided in a geographical area; and
supporting the positioning service using ranging measurements with respect to the target mobile device obtained from the ranging constellation.

18. A method comprising:
determining whether or not a ranging constellation of anchor devices is established by monitoring an integrity of the ranging constellation; and
providing a desired operational area of the ranging constellation based on the establishment or suitability of the ranging constellation.

19. A computer program stored on a non-transitory medium, wherein the computer program when executed on a processor performs the method as claimed in claim 17.

20. A computer program stored on a non-transitory medium, wherein the computer program when executed on a processor performs the method as claimed in claim 18.

21. The device of claim 1, wherein the processor circuit is arranged to initiate a formation of the ranging constellation using position information obtained from the ranging or positioning service.

22. The device of claim 1,
wherein the processor circuit is arranged to configure a first anchor device as a head anchor device,
wherein the head anchor device is arranged as a calibration node that can communicatively couple with other network devices so as to perform a recalibration procedure of the ranging constellation when a second anchor device leaves the ranging constellation.

23. The device of claim 1,
wherein the processor circuit is arranged to configure a first anchor device as a head anchor device,
wherein the head anchor device is arranged as a calibration node that can communicatively couple with other network devices so as to handle the constellation configuration in coordination with a managing entity.

24. The device of claim 1,
wherein the processor circuit is arranged to configure a first anchor device as a head anchor device,
wherein the head anchor device is arranged as a calibration node that can communicatively couple with other network devices so as to exchange ranging measurements with a core network of the wireless network.

25. The device of claim 1, wherein the processor circuit is arranged to configure the at least one ranging capable devices by assigning information related to the used positioning signals.

26. The apparatus of claim 10,
wherein the processor circuit is arranged to determine if the ranging measurements are integral to the target operational area of the ranging constellation based on changes in location estimates obtained by anchor devices,
wherein ranging measurements are obtained from a ranging service or from a location service.

27. The method of claim 17, further comprising:
creating and maintaining a provisional ranging constellation of anchor devices directly or via a core network; and
forwarding the provisional ranging constellation to a managing entity so as to support formation of the ranging constellation.

28. The method of claim 17, further comprising communicatively coupling with an identified anchor device so as to initiate a configuration of the identified anchor device so as to participate in the ranging constellation.

29. The method of claim 17, further comprising:
initiating a formation of the ranging constellation by subscribing to a ranging or positioning service in the geographical area; and
requesting assistance in the formation of the ranging constellation.

30. The method of claim 17, further comprising initiating a formation of the ranging constellation using position information obtained from the ranging or positioning service.

31. The method of claim 17, further comprising configuring a first anchor device as a head anchor device, wherein the head anchor device is arranged as a calibration node that can communicatively couple with other network devices so as to perform a calibration procedure of the ranging constellation for a newly joining anchor device.

32. The device of claim 1, method of claim 17, further comprising configuring a first anchor device as a head anchor device, wherein the head anchor device is arranged as a calibration node that can communicatively couple with other network devices so as to perform a recalibration procedure of the ranging constellation when a second anchor device leaves the ranging constellation.

33. The method of claim 17, further comprising configuring a first anchor device as a head anchor device, wherein the head anchor device is arranged as a calibration node that can communicatively couple with other network devices so as to handle the constellation configuration in coordination with a managing entity.

34. The method of claim 17, further comprising configuring a first anchor device as a head anchor device, wherein the head anchor device is arranged as a calibration node that can communicatively couple with other network devices so as to exchange ranging measurements with a core network of the wireless network.

35. The method of claim 17, further comprising configuring the at least one ranging capable devices by assigning security keying materials and discovery information.

36. The method of claim 17, further comprising performing centralized management of the ranging constellation by analyzing identities of ranging capable devices so as to retrieve location coordinates or initiating ranging measurements among anchor devices of the ranging constellation so as to identify a proximity between the anchor devices, wherein the processor circuit is arranged to update location information of the ranging constellation if there is a change in proximity and/or the ranging distance between the anchor devices of the ranging constellation.

37. The method of claim 18, further comprising:
identifying a list of the ranging capable devices to be configured as the ranging constellation; and
creating a request to form or maintain the ranging constellation,
wherein the identification of the ranging capable devices is based on an installation list provided by a wireless network and/or a mobile device or a role and identity of a network device or a feature of the ranging capable devices or a context of the ranging capable devices.

38. The method of claim 18, further comprising initiating or perform ranging measurements between anchor devices and/or a target mobile device of the ranging constellation in at least one of a target operational area, a configurable time interval or a set of devices in a given context.

39. The method of claim 38, further comprising determining if the ranging measurements are integral to the target operational area of the ranging constellation based on the ranging measurements between the anchor devices,
wherein ranging measurements are obtained from a ranging service or from a location service.

40. The method of claim 38, further comprising determining if the ranging measurements are integral to the target operational area of the ranging constellation based on changes in location estimates obtained by anchor devices, wherein ranging measurements are obtained from a ranging service or from a location service.

41. The method of claim 38, further comprising:
determining that the ranging constellation is established; and
communicating the determination to a ranging service at a mobile device and/or a base station device and/or a core network of a wireless network when the ranging measurements within the target area are completed within the configured time interval and the integrity of the ranging measurements did not change beyond a configured threshold of the ranging constellation within the configured time interval.
